(19) United States
(12) Patent Application Publication
(10) Pub. No.: US 2004/0167789 A1
(43) Pub. Date: Aug. 26, 2004

(54) Method and system for determining, analyzing, and reporting a cost reduction in a procurement

(76) Inventors: Margaret C. Roberts, Sewickley, PA (US); Mary E. Green, Pittsburgh, PA (US); Tim Roseberry, Wheeling, WV (US); Ioan Crisan, Pittsburgh, PA (US); Timothy M. McCollim JR., Aliquippa, PA (US); Robert A. Rudzki, Upper St. Clair, PA (US)

Correspondence Address: BAYER CHEMICALS CORPORATION, PATENT DEPARTMENT, 100 BAYER ROAD, PITTSBURGH, PA, 15205-9741, US

(21) Appl. No.: 10/373,312

(22) Filed: Feb. 24, 2003

(51) Int. Cl. G06F 17/60

(52) U.S. Cl. 705/1

(57) ABSTRACT

Disclosed is a computer-implemented method for determining cost reduction in a procurement transaction, including the steps of: (a) providing a baseline reference data set including at least one reference data field; (b) providing a negotiated procurement transaction data set including at least one negotiated procurement transaction data field; (c) providing an actual procurement transaction data set including at least one actual procurement transaction data field; (d) determining a cost reduction value for the procurement transaction based upon at least one baseline reference data field, at least one negotiated procurement transaction data field and at least one actual procurement transaction data field; and (e) providing the results of the determination performed in step (d). Also disclosed are various apparatus and systems capable of performing this method.

### BACKGROUND OF THE INVENTION

1. Field of the Invention

The present invention relates generally to the analysis of procurement transactions, and, in particular, to a computer-implemented automated system and method for determining cost reduction in a procurement transaction between two parties.

2. Description of the Prior Art

Systems for analyzing procurement transactions between parties for the transfer of various goods and services are important for increasing a party's economic vitality and growth potential. While price reduction (or inflation, depending upon the party) is invariably a focus of any contract negotiation between parties, overall cost reduction in the procurement transaction, as well as in the transaction process, is a goal for both parties to the transaction.

Once the transaction has been completed, methods and systems for ensuring that key performance indicators and other contractual terms and conditions are met by the parties are required. Such analytical systems are used in conjunction with contract or procurement transaction management systems. Various prior art contract performance and management systems are currently available.

U.S. patent application Ser. No. 10/044,430 (Publication No. U.S. 2002/0111897) to Davis is directed to a web-based method and system for the procurement of goods and services. The method of the Davis application allows for the management of a bid/auction process. In addition, this web-based system is specifically directed to a web-based or other electronically enabled procurement process. This system manages the bid/auction process from initiation through award.

U.S. patent application Ser. No. 09/765,341 (Publication No. U.S. 2002/0099598) to Eicher, Jr. et al. is directed to a performance-based supply chain management system and method with “metalerting” and hot spot identification. This system sends “metalerts” directed to certain monitored key performance indicators in a contractual engagement. Further, the system of the Eicher, Jr. application is an alert module for a single transaction between a buyer and a seller, which monitors specified terms and conditions and a party's conformance with these terms and conditions.

U.S. patent application Ser. No. 10/042,245 (Publication No. U.S. 2002/0095311) to Donahue is directed to a method and apparatus for negotiating a contract over a computer network. The Donahue system facilitates a structured negotiation process between two parties. This system is a web-based contract negotiation tool.

U.S. patent application Ser. No. 09/752,181 (Publication No. U.S. 2002/0087705) to Smyth is directed to a system and method for managing contracts. The system of the Smyth application provides a project control means, accessible by the contract manager, for authorizing variations in financial data for the project. In addition, this control means allows the contract manager to authorize payment to a consultant based upon this financial data. This system is a contract management tool.

U.S. patent application Ser. No. 09/220,380 (Publication No. U.S. 2001/0011222) to McLauchlin et al. is directed to an integrated procurement management system, which uses a public computer network, such as the Internet. The system of the McLauchlin application provides access to procurement data to multiple users, typically procurement specialists or professionals, through a core system. A collection of contract or procurement data is integrated into the core procurement system, allowing procurement managers to manage the data and generate required reports about a transaction.

U.S. Pat. No. 6,216,108 to LeVander is directed to a service business management system. The system includes a microprocessor, an input device for entering transactional data and an output device for generating reports, such as contract proposals. This system is a contract management tool.

U.S. Pat. No. 6,134,536 to Shepard is directed to methods and apparatus for formulating and trading risk management contracts. The method of the Shepard patent is specifically focused on risk management contracts that deal with yet unknown future events. Further, the system matches contracts and allows the contracts to be traded until they mature. Once the contracts mature, the system provides functionality for exchanging entitlement between matched parties to the contract.

U.S. Pat. No. 6,144,943 to Minder is directed to a method of managing contract housekeeping services. As the title indicates, the method of the Minder patent is specifically directed to housekeeping services. The method attempts to improve the quantity and value of the services received and allows these services to be “graded.” The grade is used to make decisions regarding the management of the services rendered. This is an application-specific contract management tool.

All of these prior art systems are focusing upon the central issues surrounding a contract: negotiation, acceptance, performance, monitoring and completion. In essence, these prior art systems analyze the various stages of a contract between parties and allow for the efficient management and implementation of the procurement transaction between two parties. However, none of the prior art methods and systems provides for a complete and dynamic cost reduction analysis using a key baseline reference data set. While contract management systems and functionality is useful in managing a contract, such systems have heretofore not provided an overall cost reduction and/or avoidance analytical tool for a procurement transaction.

### SUMMARY OF THE INVENTION

It is, therefore, an object of the present invention to provide a method and system for determining cost reduction in a procurement transaction that overcomes the deficiencies of the prior art. It is another object of the present invention to provide a method and system for determining cost reduction in a procurement transaction that analyzes a procurement transaction using specified data from a baseline reference data set. It is a still further object of the present invention to provide a method and system for determining cost reduction in a procurement transaction that allows for both contract management, as well as analytical functionality for assessing the overall cost reduction and/or cost avoidance achieved in a procurement transaction.

Accordingly, in order to overcome the deficiencies of the prior art, we have invented a method and system for determining cost reduction in a procurement transaction. According to the present invention, there is provided a method and apparatus for a computer-implemented, automated system for determining cost reduction in a procurement transaction.

A method according to the present invention includes: (a) providing a baseline reference data set including at least one reference data field; (b) providing a negotiated procurement transaction data set including at least one negotiated procurement transaction data field; (c) providing an actual procurement transaction data set including at least one actual procurement transaction data field; (d) determining a cost reduction value for the procurement transaction based upon at least one baseline reference data field, at least one negotiated procurement transaction data field and at least one actual procurement transaction data field; and (e) providing the results of the determination performed in step (d). In a preferred embodiment, the method also includes the step of providing a project management data set including at least one project management data field. In addition, in another preferred embodiment, the method also includes the step of forecasting a cost reduction value for a subsequent transaction based upon the results of the determination.

The present invention is also directed to an apparatus for determining cost reduction in a procurement transaction, including: means for providing a baseline reference data set including at least one reference data field; means for providing a negotiated procurement transaction data set including at least one negotiated procurement transaction data field; means for providing an actual procurement transaction data set including at least one actual procurement transaction data field; means for determining a cost reduction value for the procurement transaction based upon at least one baseline reference data field, at least one negotiated procurement transaction data field and at least one actual procurement transaction data field; and means for providing the results of the determination.

Further, the present invention is directed to an apparatus for determining cost reduction in a procurement transaction, including at least one storage mechanism containing: (i) a baseline reference data set including at least one reference data field; (ii) a negotiated procurement transaction data set including at least one negotiated procurement transaction data field; and (iii) an actual procurement transaction data set including at least one actual procurement transaction data field. The apparatus also includes at least one control mechanism in communication with the at least one storage mechanism and configured to determine a cost reduction value for the procurement transaction based upon at least one baseline reference data field, at least one negotiated procurement transaction data field and at least one actual procurement transaction data field. A display mechanism is in communication with the at least one control mechanism and used to visually display the results of the determination.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a flow diagram illustrating a method for determining cost reduction in a procurement transaction according to the present invention;

FIG. 2 is a schematic view of a preferred embodiment of a system and apparatus for implementing the method for determining cost reduction in a procurement transaction of FIG. 1;

FIGS. 3-136 are a series of screen shots of an actual implemented embodiment according to the method and system of the present invention; and

FIG. 137 is a chart illustrating a contracts timeline and cost reduction variation for example projects of the method and system of the present invention.

### DETAILED DESCRIPTION OF THE PREFERRED EMBODIMENTS

The present invention provides a computer-implemented and automated interface and system for determining cost reduction in a procurement transaction between one or more parties. The present invention is useful in managing a variety of procurement transactions, including the transfer or sale of goods and services between various parties. Typically, a procurement transaction occurs between a “seller” and a “buyer.” However, while the terms “seller” and “buyer” are used, these terms are envisioned to include any relationship wherein the parties engage in a procurement transaction or exchange. Therefore, a “seller” may be a corporate entity, an employer, an affiliate, a seller agent, a division, a subset of a corporate entity, etc. Similarly, a “buyer” may be a supplier, a contractor, a corporate entity, an employee, a subsidiary, a buyer agent, a user, an administrator, a division, a subset of a corporate entity, etc.

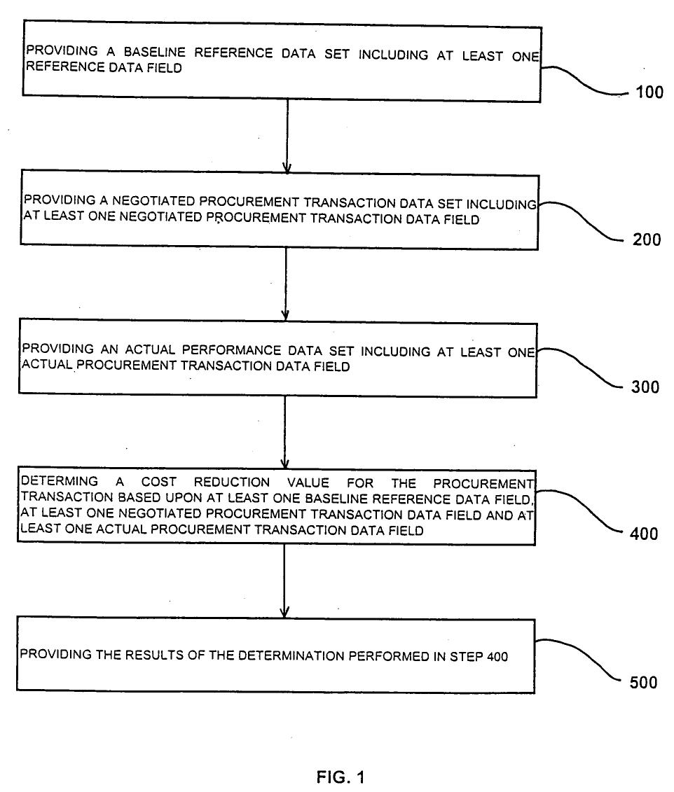

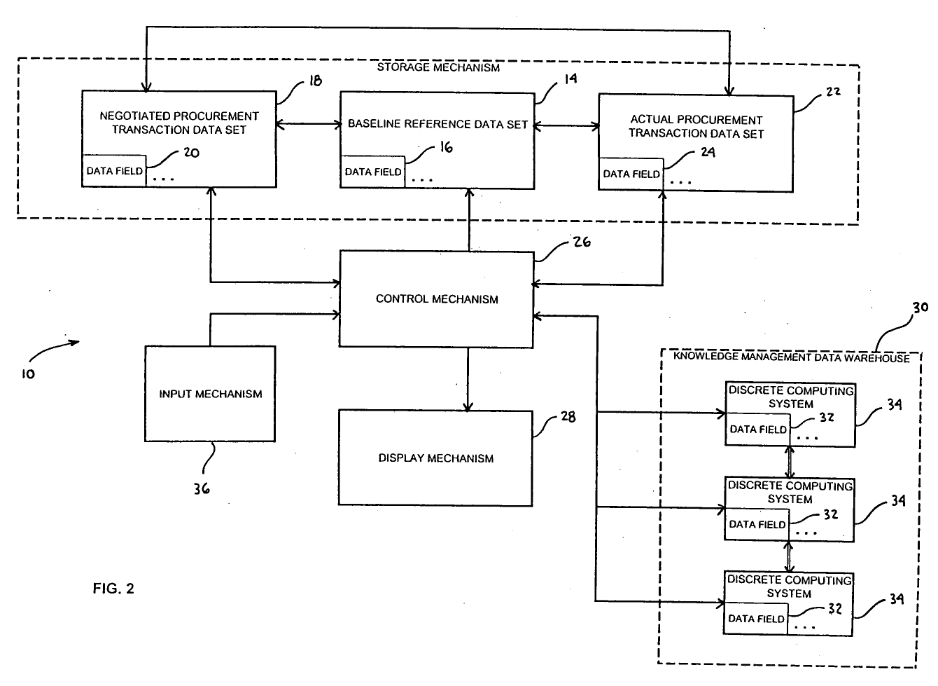

FIG. 1 is a flow diagram illustrating the method according to the present invention, and FIG. 2 is a schematic or block diagram illustrating an apparatus and system according to this method. Referring to FIG. 1, a first step 100 provides a baseline reference data set including at least one reference data field. Next, a second step 200 provides a negotiated procurement transaction data set including at least one negotiated procurement transaction data field. A third step 300 provides an actual procurement transaction data set including at least one actual procurement transaction data field. Next, a fourth step 400 determines a cost reduction value for the procurement transaction based upon at least one baseline reference data field, at least one negotiated procurement transaction data field and at least one actual procurement transaction data field. Finally, the fifth step 500 provides the results of this determination.

As discussed above, the procurement transaction takes place between the buyer and the seller, or the buyer and the supplier. The baseline reference data set, including multiple reference data fields, may have data directed to an average market price, an average online bid price, an old contract price, a supplier price, a previously-quoted price, an advertised price, a price figure, a specified volume and a reference volume. Similarly, the negotiated procurement transaction data set, including multiple negotiated procurement transaction data fields, may include data directed to an initial quote price, an initial negotiated price and a variable negotiated price. Further, the at least one, and typically multiple, negotiated procurement transaction data fields can be terms of the negotiated procurement transaction or contract.

While many contracts or procurement transactions have set terms that are not variable after final negotiation, many more sophisticated contracts require variability due to outside and/or out-of-control situations. For example, the variable negotiated price may be variable based upon a negotiated formula, a predetermined formula, a condition, an allocation, etc. While the variable negotiated price can change, it remains a set term of a negotiated procurement transaction. There are many reasons why a variable negotiated price may be required. For example, a price may vary based upon a changing market condition, e.g., crude oil price variations, a rebate, a bonus, timing data, shipping data, material cost data, service cost data, inflation, projection data, etc. As an example, many contracts, dealing with foreign commodities, must include the ability to vary a price based upon the changing prices in these commodities.

The actual procurement transaction data set, including multiple actual procurement transaction data fields, may also be directed to multiple terms or data, which reflect a party's actual performance in connection with the contract or procurement transaction. For example, the actual procurement transaction data field may be an actual price, a volume, a specified volume, an actual volume, etc.

As discussed above, any of the reference data fields, the negotiated procurement transaction data fields, and/or the actual procurement transaction data fields may be a procurement transaction data field, for example, a term, condition, clause, or other point of reference with respect to the contractual document or transactional documentation. For example, the procurement transaction data field may include data relating to risk transfer, liability, inspections, performance, response time, fill rate, quality, warranty, shipping data, supplier qualification, minority supplier information, policies, regulations, compliance, payment terms, procurement transaction price value, procurement transaction quantity value, procurement transaction time period, first party data, second party data, buyer data, seller data, a procurement transaction identifier, volume values, market identifiers, past first party performance data, past second party performance data, past buyer performance data, past seller performance data, past second party pricing, past seller pricing, past negotiated procurement transaction terms, alternative procurement transaction terms, alternative procurement transaction second party performance data, alternative procurement transaction seller performance data, alternative procurement transaction second party pricing, alternative procurement transaction seller pricing, past negotiated procurement transaction terms, current comparable procurement transaction terms, current comparable procurement transaction second party performance data, current comparable procurement transaction seller performance data, current comparable procurement transaction second party pricing, current comparable procurement transaction seller pricing, procurement strategies, negotiator information, market estimates, negotiated procurement transaction terms, reference procurement transaction terms, actual procurement transaction performance information, etc.

After the required information is provided, the method of the present invention determines a cost reduction value for the procurement transaction, based upon one or more baseline reference data fields, negotiated procurement transaction data fields and actual procurement transaction data fields. In a preferred and non-limiting embodiment, the cost reduction value is a Net Cost Reduction (NCR) value as determined by the following relationship: NCR=Initiative Cost Reduction (ICR)+Market Cost Reduction (MCR)+Delta Volume Cost Reduction (AVCR). The Initiative Cost Reduction (ICR) value is determined by the following relationship: ICR=Negotiated Volume (NV)×Negotiated Cost Reduction per Unit (NCRU). The Negotiated Cost Reduction per Unit (NCRU) value is further determined as follows: NCRU=Baseline Price per Unit (BPU)−Negotiated Price per Unit (NPU). The Negotiated Cost Reduction per Unit (NCRU) may also be expressed as a percentage reduction value or Negotiated Cost Reduction percentage (NCR %).

The Market Cost Reduction (MCR) value is determined by the following relationship: MCR=(Negotiated Price per Unit (NPU)−Actual Price per Unit (APU))×Actual Volume (AV). Further, the Delta Volume Cost Reduction (ΔVCR) value is determined as follows: ΔVCR=Negotiated Cost Reduction per Unit (NCRU)×Delta Volume (ΔV). In order to determine the Delta Volume (ΔV), the following relationship is used: ΔV=Negotiated Volume (NV)−Actual Volume (ΔV). Using these relationships and formulas, the user may develop and calculate an overall Net Cost Reduction which takes into account the projected cost reduction based upon the project initiative, the cost reduction based upon market conditions, which are variable and changing, as well as the volume cost reduction based on changing volume values.

Typically, the first party to the procurement transaction is a buyer and the second party is a supplier. The procurement transaction may be for a product and/or service, and the negotiated procurement transaction data field can be a term of this transaction. The actual procurement transaction data set is typically derived from the first party's or the second party's actual performance in connection with one or more terms of the negotiated procurement transaction. Therefore, another envisioned step to the present method is negotiating a procurement transaction between a first party and a second party, wherein the negotiated procurement transaction data set is derived from the data associated with the negotiated procurement transaction.

The present method may also include the step of providing a knowledge management data warehouse. The knowledge management data warehouse is a database that contains multiple and discrete data fields. Typically, this knowledge management data warehouse is in the form of a computer-readable database. In a preferred and non-limiting embodiment, the knowledge management data warehouse is a compilation of multiple, parsable and computer-readable documents. Each of these documents contains one or more discrete data fields associated with it. It is also envisioned that these documents are resident on the various discrete computing systems, and these computing systems are in a networked relationship with each other.

A knowledge management data warehouse is a large compilation of collected data. In addition, this data should be viewable, parsable, searchable, readable, modifiable, and recordable over a computer network. In addition, the knowledge management data warehouse can be resident on a communications network. In essence, the knowledge management data warehouse serves as the provider of all necessary information to the negotiated procurement transaction data set, the baseline reference data set and the actual procurement transaction data set. Therefore, the knowledge management data warehouse may include data, such as any data in one or more fields of the data sets.

After the “world” of documents or data is combined or tagged for inclusion in the knowledge management data warehouse, the present method may also include the step of defining a knowledge management data warehouse data subset. In defining a data subset, a user can begin to focus the method on useful, as opposed to useless or marginally useful, data or information. Once such a focus has occurred, the negotiated procurement transaction data set, the baseline reference data set and the actual procurement transaction data set will be selected from the data contained in the knowledge management data warehouse data subset. In is also envisioned that the knowledge management data warehouse subset is updated on a real-time basis or a periodic basis. This ensures that the data is current and useful in creating other data sets.

In another aspect of the present invention, the method includes the step of developing a procurement strategy for use in connection with negotiating the procurement transaction. In one preferred and non-limiting embodiment, the procurement strategy can be a cost reduction strategy, a negotiations strategy, a strategic process, an online auction, a personnel strategy, a sealed bid, a reverse auction, a multi-phase iterative process and/or a process improvement. The present method may also include the step of defining a procurement analysis project. For example, the procurement analysis project may focus in on an operating cost reduction, capital cost reduction or asset recovery. In addition, the procurement analysis project can be directed to a specified commodity area, service area, cost reduction initiative, second party, supplier, seller, and/or capital project.

In another preferred and non-limiting embodiment, prior to the determining step 400, the method may include the step of defining at least one of a specified negotiated procurement transaction data field, baseline reference data field and actual procurement transaction data field for use in determining the cost reduction value. It is envisioned that a user can perform this defining step. Similarly, the user may perform the determining step.

In another preferred and non-limiting embodiment, prior to the providing step 100, the method may also include the step of providing a project management data set. This data collection step allows for the collection of information and data prior to the negotiation process engaged in by the parties to a contract, agreement or transaction. For example, the project management data set may include a request for proposal data, bid data, cost breakdown and projection data, specification and requirement data, event and response data, evaluation data, related agreements and assumption data and other data or information that is created prior to a negotiated transaction. In addition, the project management data set may include data referring to what the parties expect to negotiate.

The results provided in step 500 are typically in the form of a report. This report may be in chart format, graphical format, textual format, visual display or other graphic depiction of organized data. In another preferred and non-limiting embodiment, after the results provided in step 500, the method may also include the step of forecasting at least one of the Initiative Cost Reduction (ICR) value, a Market Cost Reduction (MCR) value, and/or a Delta Volume Cost Reduction (ΔVCR) value for a subsequent transaction, based at least partially upon the results of the determination performed in step 400. The above forecast values may be used in connection with forecasting a Net Cost Reduction (NCR) value for a subsequent transaction. This functionality allows the user to effectively utilize the results of the novel method as input into a forecasting model or process in future transactions. Further, the results, data and/or information in this forecast can be used as part of the project management data set, the negotiated procurement transaction data set, the baseline reference data set, or the actual procurement transaction data set in connection with future transactions, contracts or agreements.

The present invention also includes an apparatus for determining cost reduction in a procurement transaction. In one preferred and non-limiting embodiment, this apparatus includes: means for providing a baseline reference data set including at least one reference data field; means for providing a negotiated procurement transaction data set including at least one negotiated procurement transaction data field; means for providing an actual procurement transaction data set including at least one actual procurement transaction data field; means for determining a cost reduction value for the procurement transaction based upon at least one baseline reference data field, at least one negotiated procurement transaction data field and at least one actual procurement transaction data field; and means for providing the results of this determination.

The present invention is also directed to an apparatus or system 10 for determining a cost reduction in a procurement transaction. This apparatus 10 includes at least one storage mechanism 12. The storage mechanism 12 contains a baseline reference data set 14, which, in turn, includes at least one and typically multiple reference data fields 16. The storage mechanism 12 also includes a negotiated procurement transaction data set 18, which includes at least one and typically multiple negotiated procurement transaction data fields 20. Finally, the storage mechanism 12 contains an actual procurement transaction data set 22, which, similarly, includes one and typically multiple actual procurement transaction data fields 24.

The apparatus 10 also includes at least one control mechanism 26, and this control mechanism 26 is in communication with the storage mechanism 12. Further, the control mechanism 26 determines a cost reduction value for the procurement transaction based upon at least one baseline reference data field 16, at least one negotiated procurement transaction data field 20 and at least one actual performance transaction data field 24. Finally, the apparatus 10 includes a display mechanism 28 in communication with the control mechanism 26. The display mechanism 28 visually displays the results of the determination performed by the control mechanism 26.

As discussed above in connection with the method of the present invention, the baseline reference data set 14, the negotiated procurement transaction data set 18, the actual procurement transaction data set 22, the reference data fields 16, the negotiated procurement transaction data fields 20 and the actual procurement transaction data fields 24 have the same functionality and variability set forth above.

The apparatus 10 may also include a knowledge management data warehouse 30. This knowledge management data warehouse 30 is a database (or collection of files and documents) containing multiple discrete data fields 32 and, in a preferred embodiment, is in the form of a computer-readable database accessible by the control mechanism 26. Further, the knowledge management data warehouse 30 is typically a compilation of multiple parsable computer-readable documents and/or files, and it is each of these multiple documents that has discrete data fields 32 associated therewith. In addition, these documents may be resident on various discrete computing systems 34, which may be in a networked relationship with each other. Importantly, the knowledge management data warehouse 30 should be viewable, parsable, searchable, readable, modifiable and recordable over a computer network. Still further, the knowledge management data warehouse 30 may be resident on a communications network.

The knowledge management data warehouse 30 is an open database. It may include documents from various applications, programs, systems, etc. Further, these documents can be found in any data format and need only be accessible by the control mechanism 26. For example, the control mechanism 26 can “earmark” or access documents, contracts, bids, proposals, spreadsheets, word processing documents, notes, snapshots, screenshots, graphic files, movie files, media files, etc. It is this ability to collect and derive the appropriate data sets (14, 18, 22) from the knowledge management data warehouse 30 that provides the global functionality of the apparatus and system 10. Further, this knowledge management data warehouse 30 can be updated on a real-time or periodic basis. The data fields 32 are current, accurate and provide the required integrity for the method and apparatus 10.

The apparatus 10 may also include an input mechanism 36. The input mechanism 36 is in communication with the control mechanism, 26 and allows a user to input a reference data field 16, a negotiated procurement transaction data field 20, an actual performance transaction data field 24 and/or otherwise interact with the apparatus 10. The input mechanism 36 can be used to designate the appropriate specific reference data field 16, negotiated procurement transaction data field 20 and/or actual procurement transaction data field 24 for use in determining a cost reduction value.

The results of the determination performed in step 400 of the method of the present invention are communicated from the control mechanism 26 to the display mechanism 28. Next, the display mechanism 28 displays the results in the form of a report. Again, as discussed above, this report can be in the form of a chart, a graph, text, visual display, graphic depiction, etc.

### EXAMPLE 1

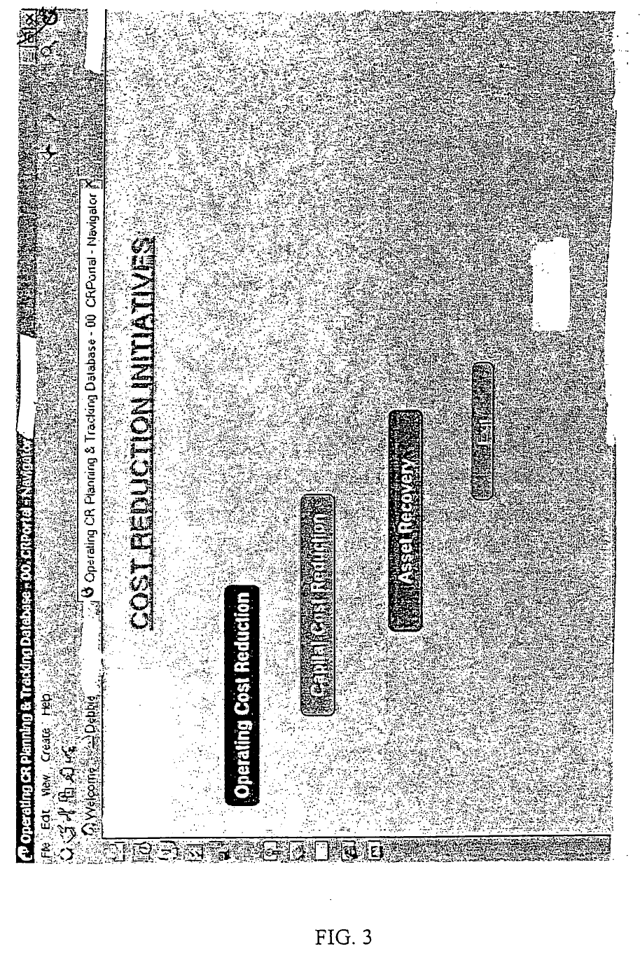

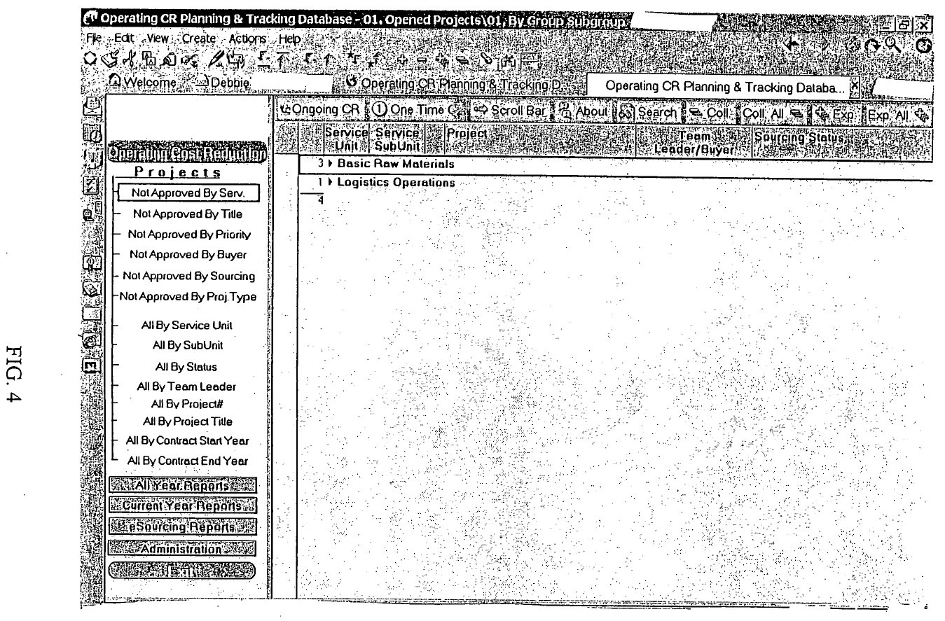

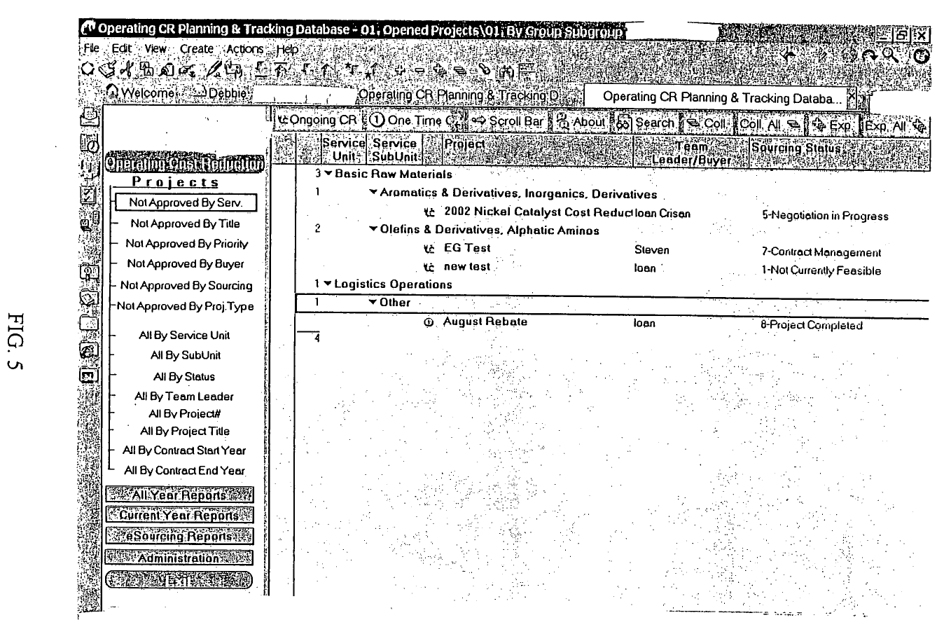

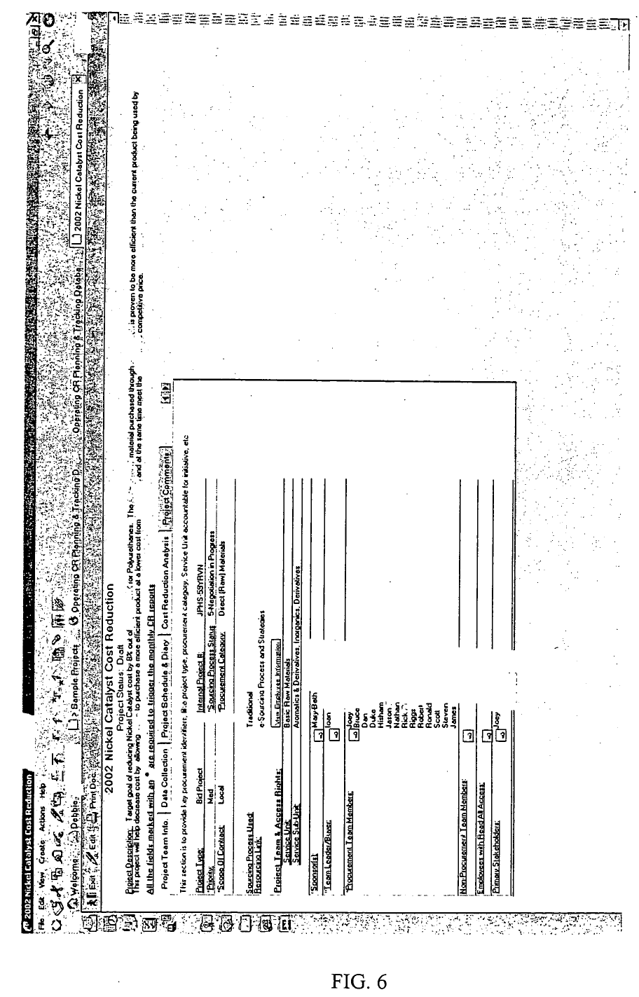

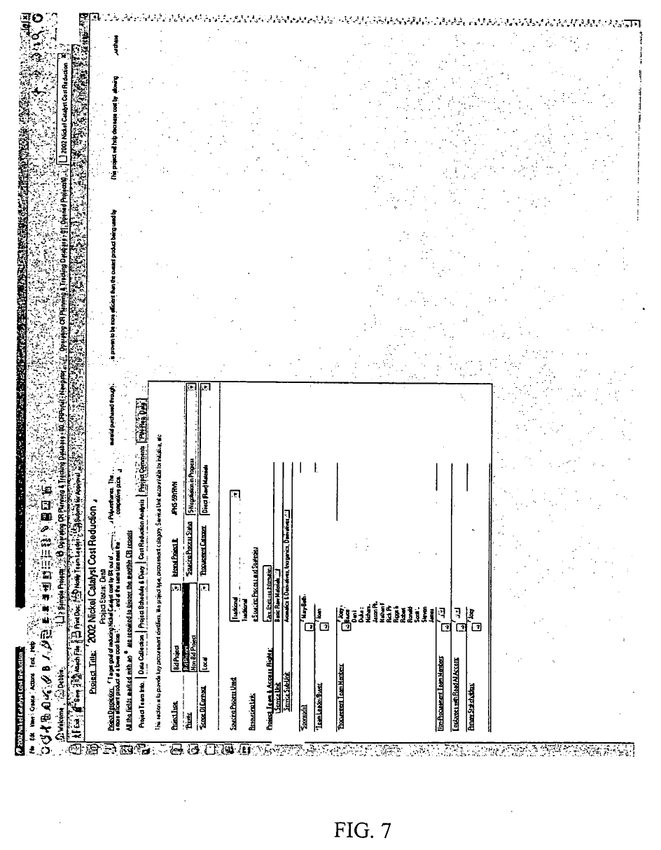

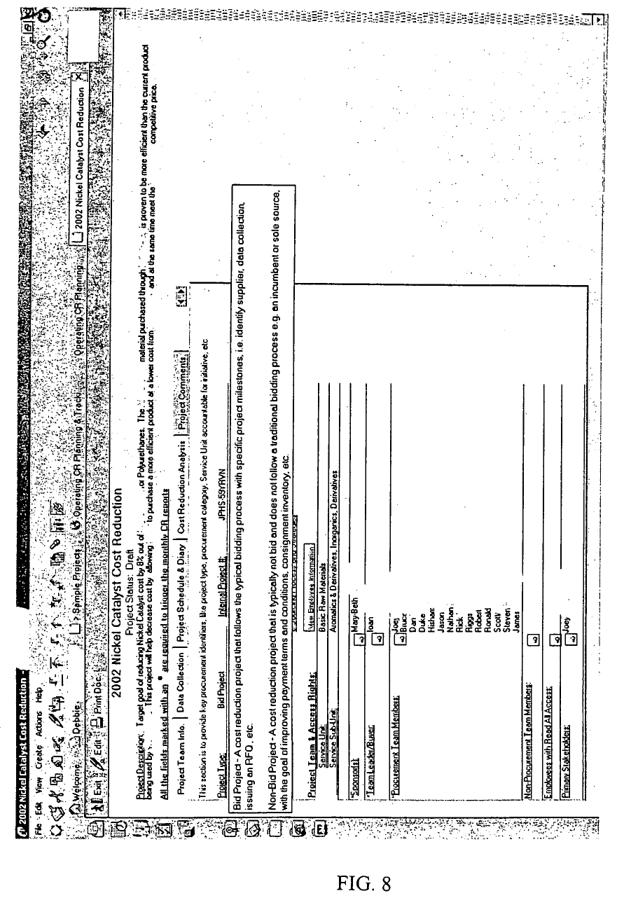

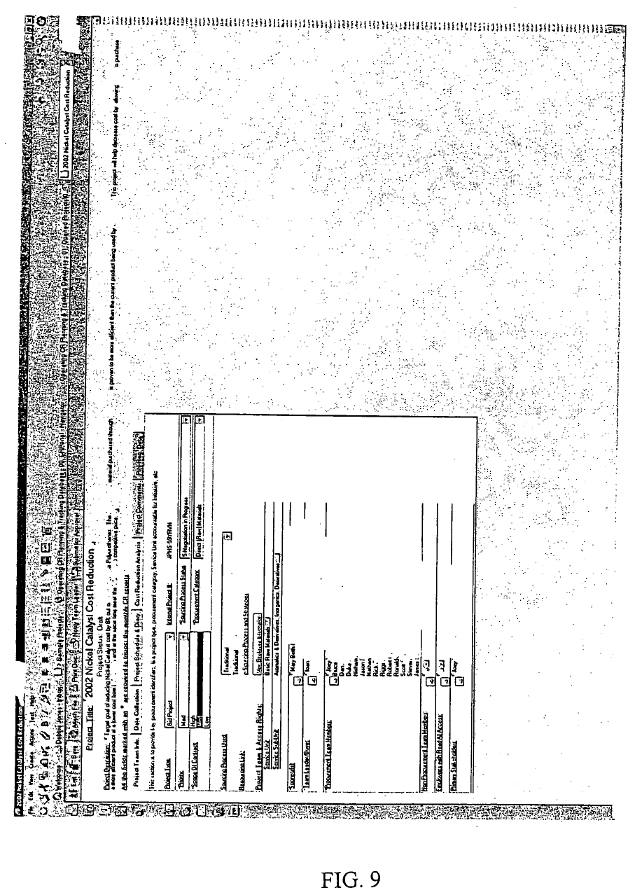

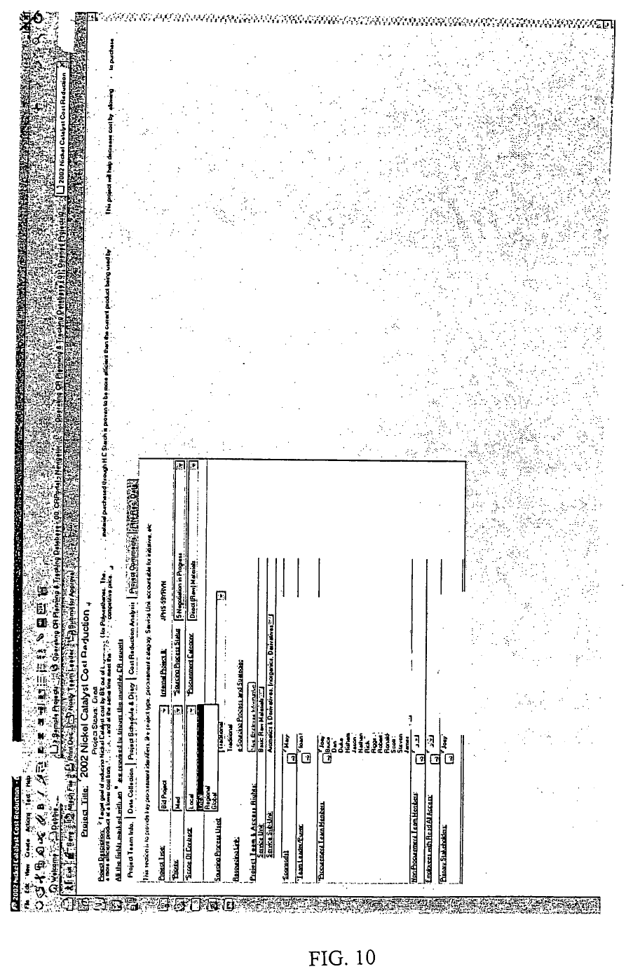

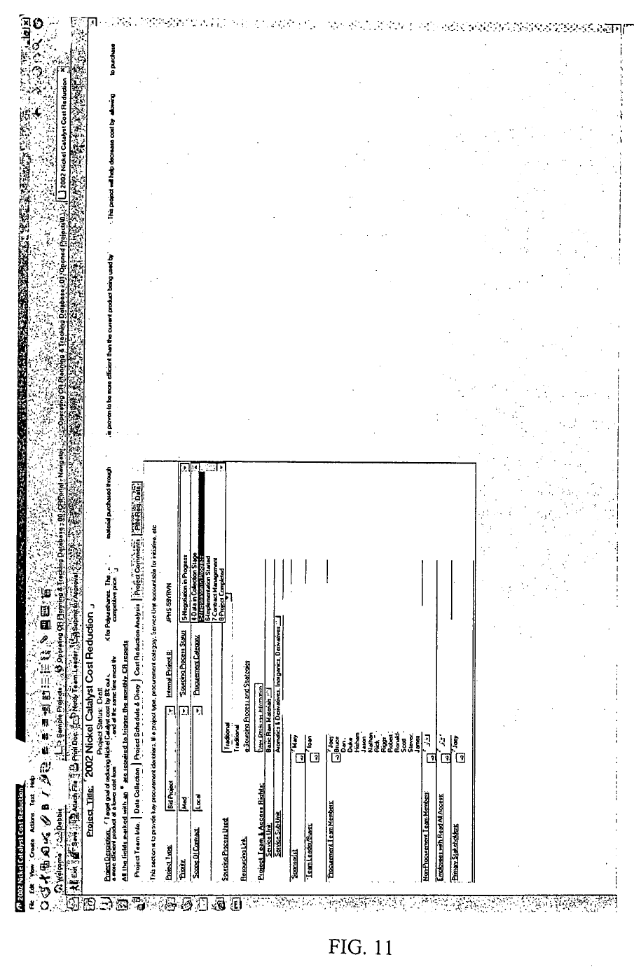

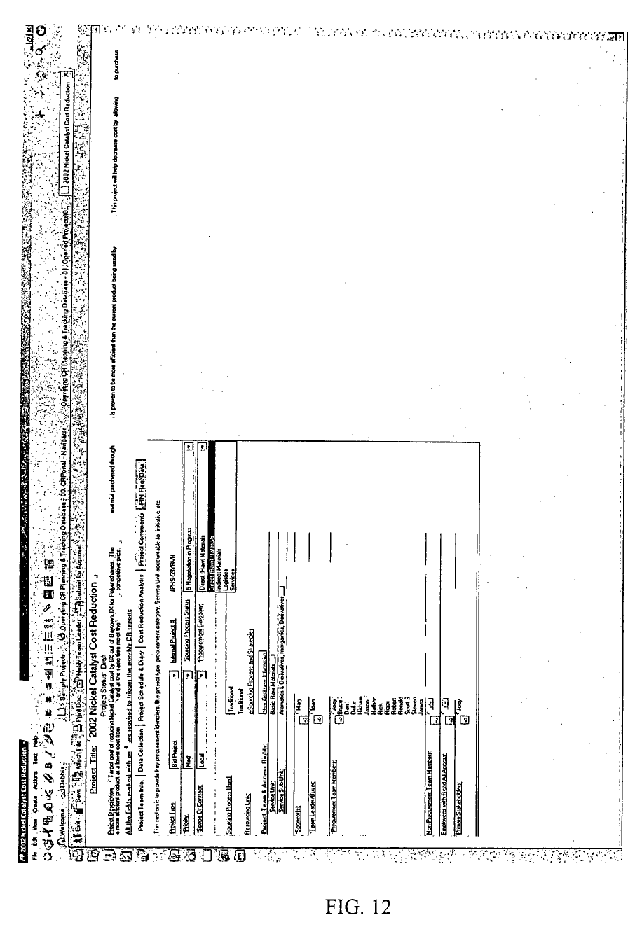

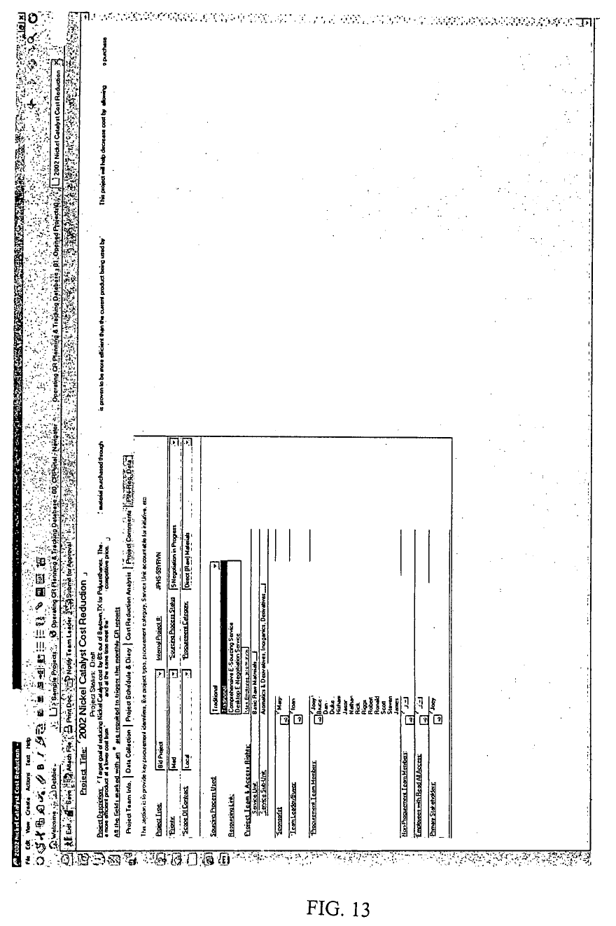

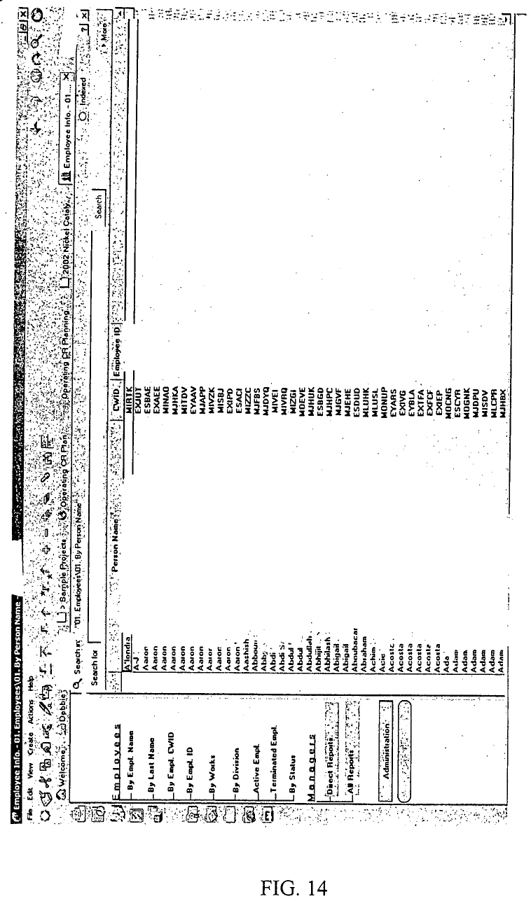

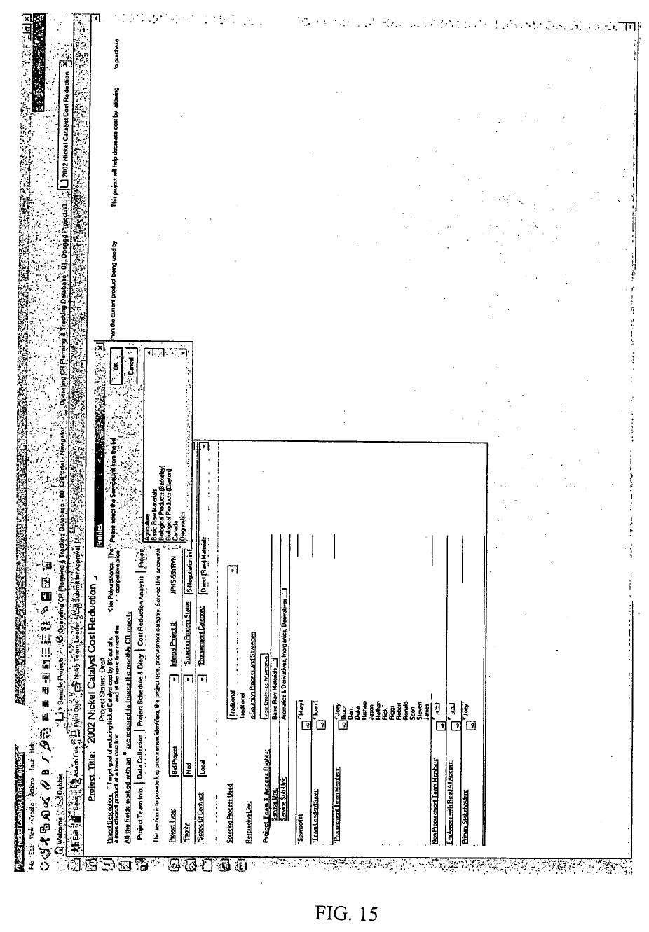

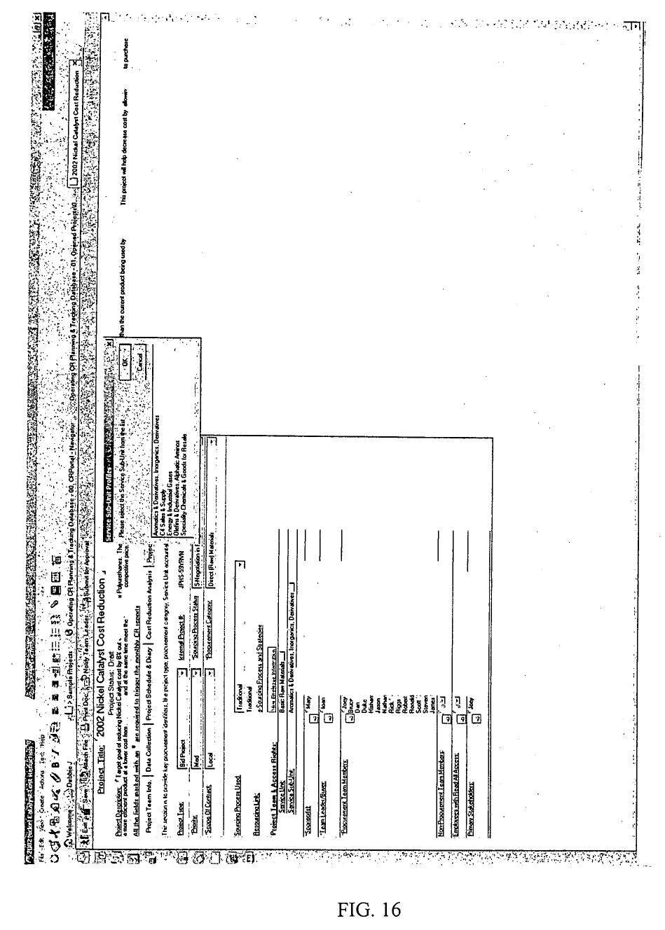

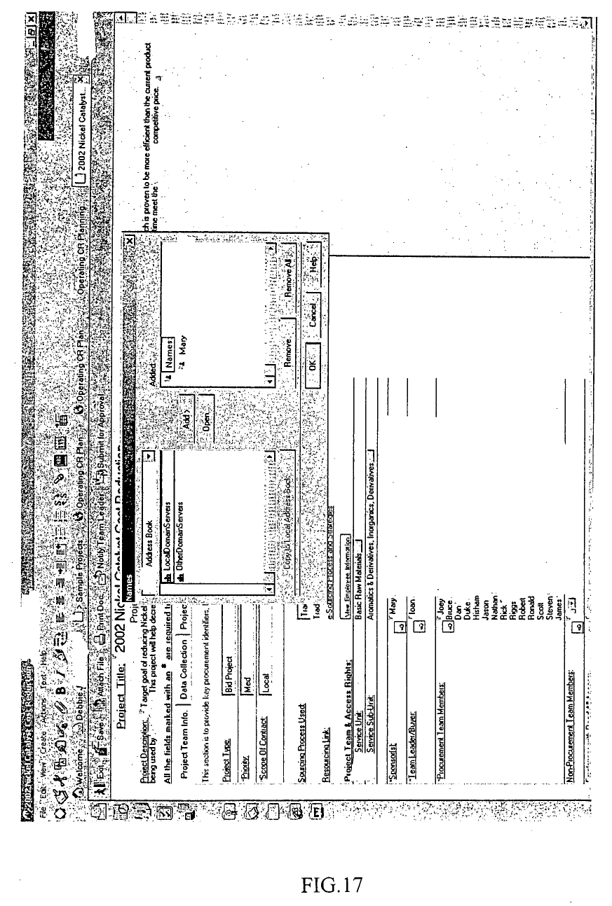

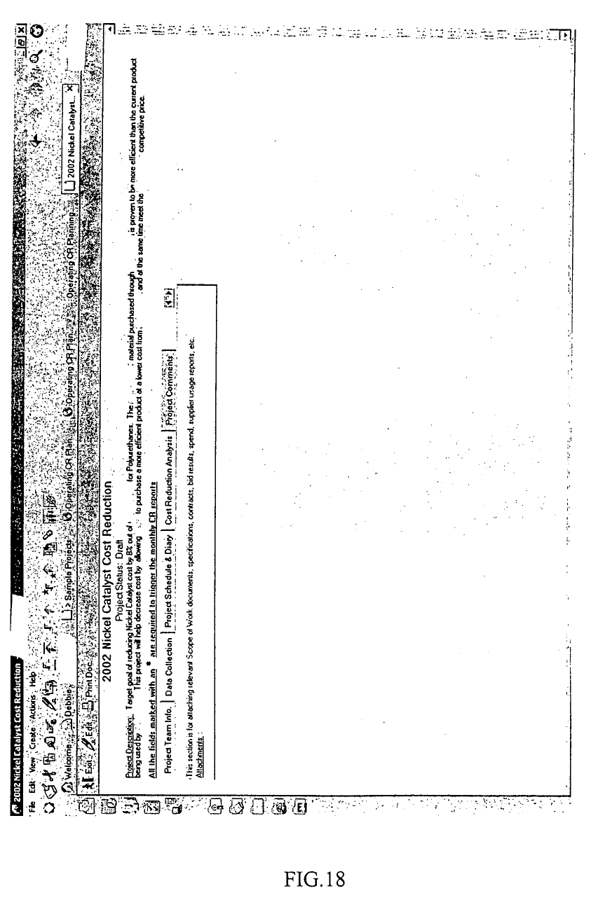

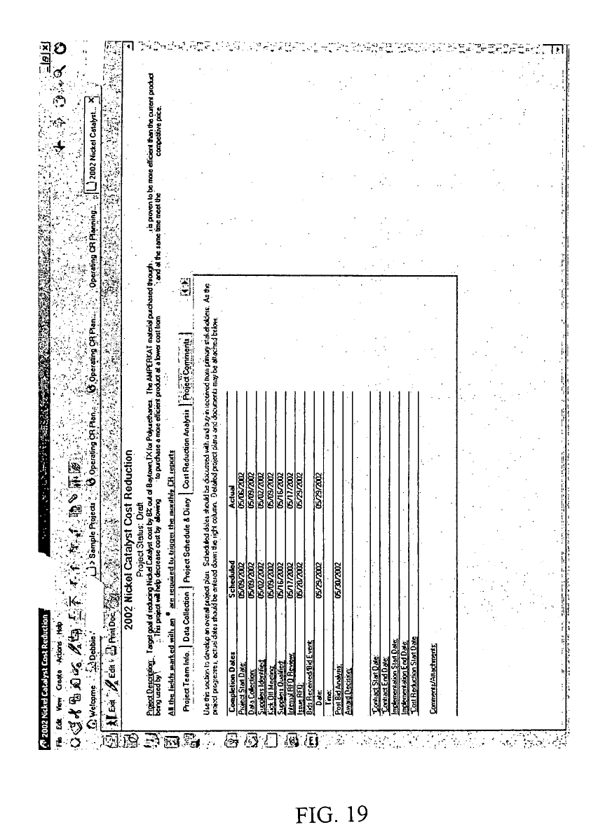

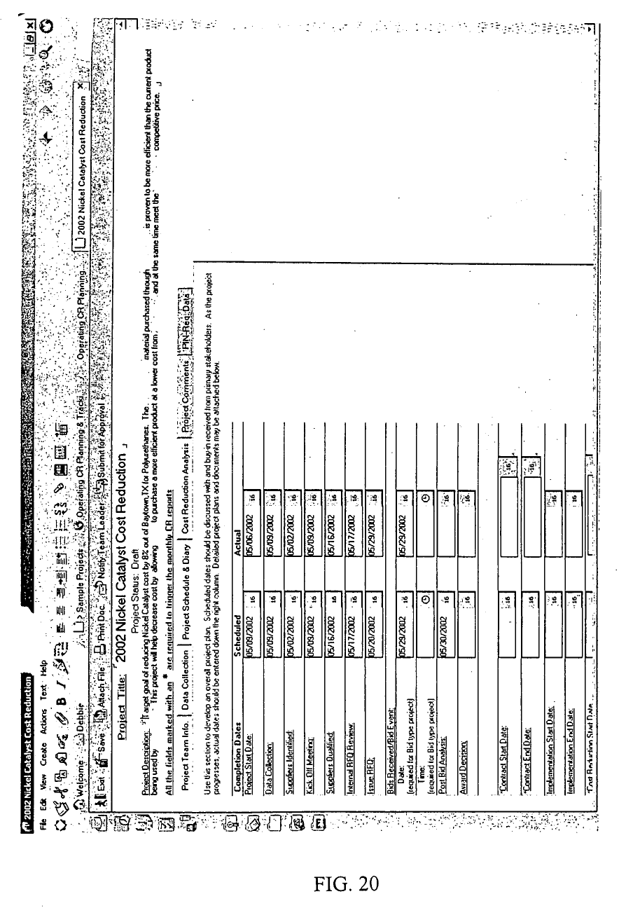

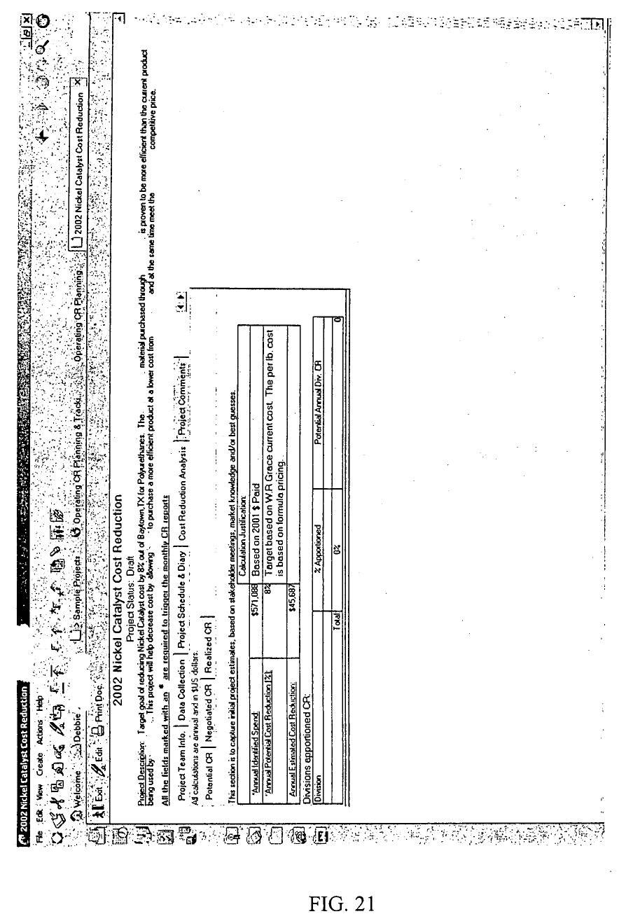

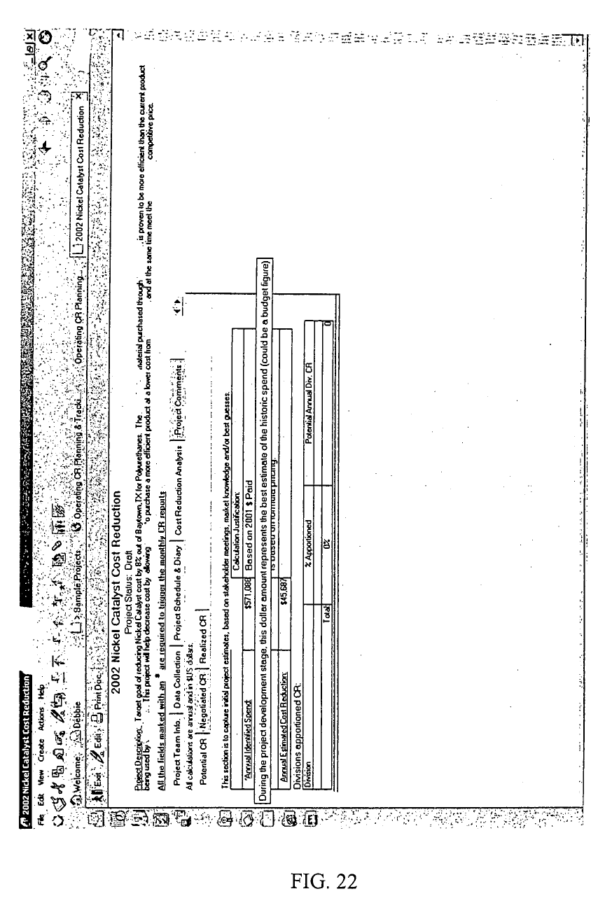

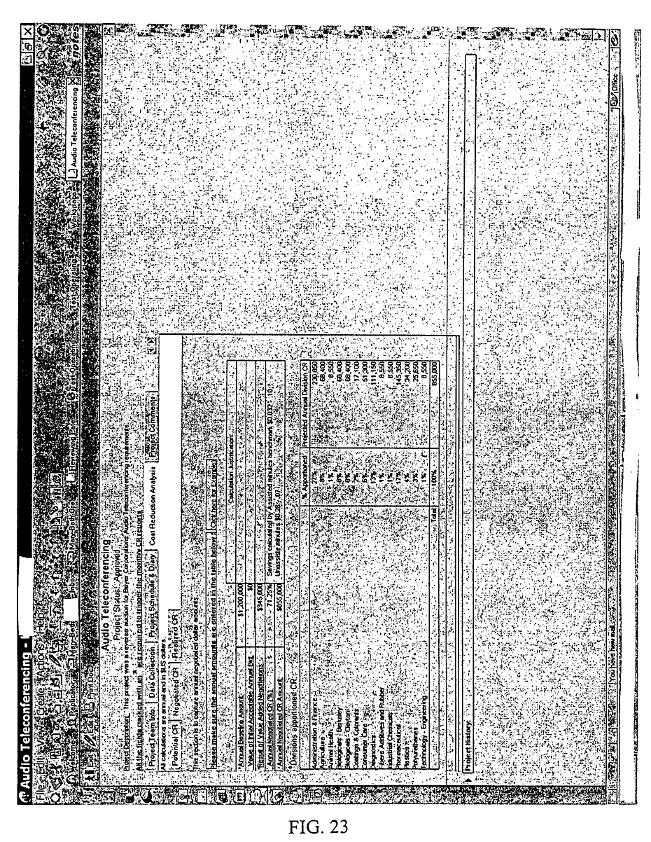

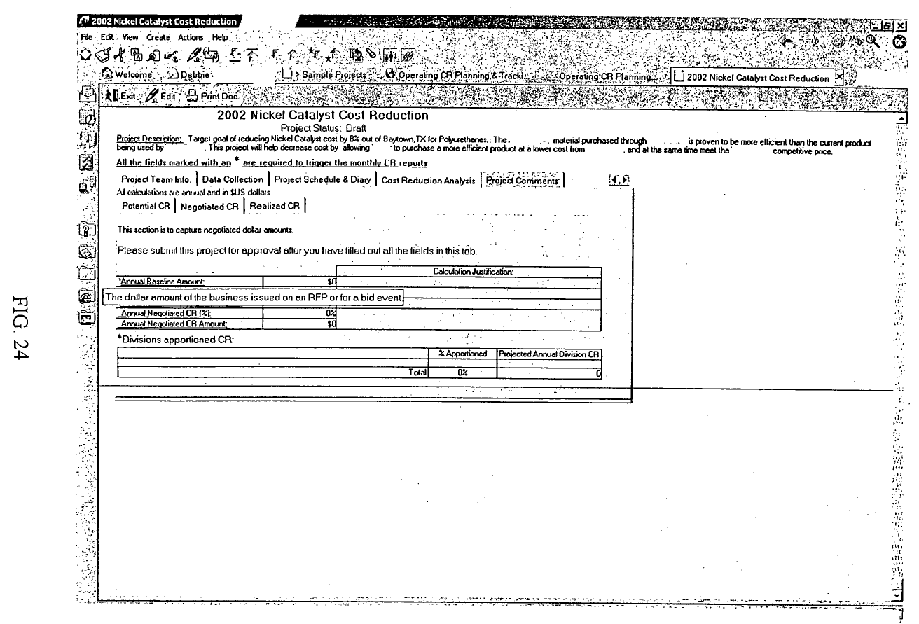

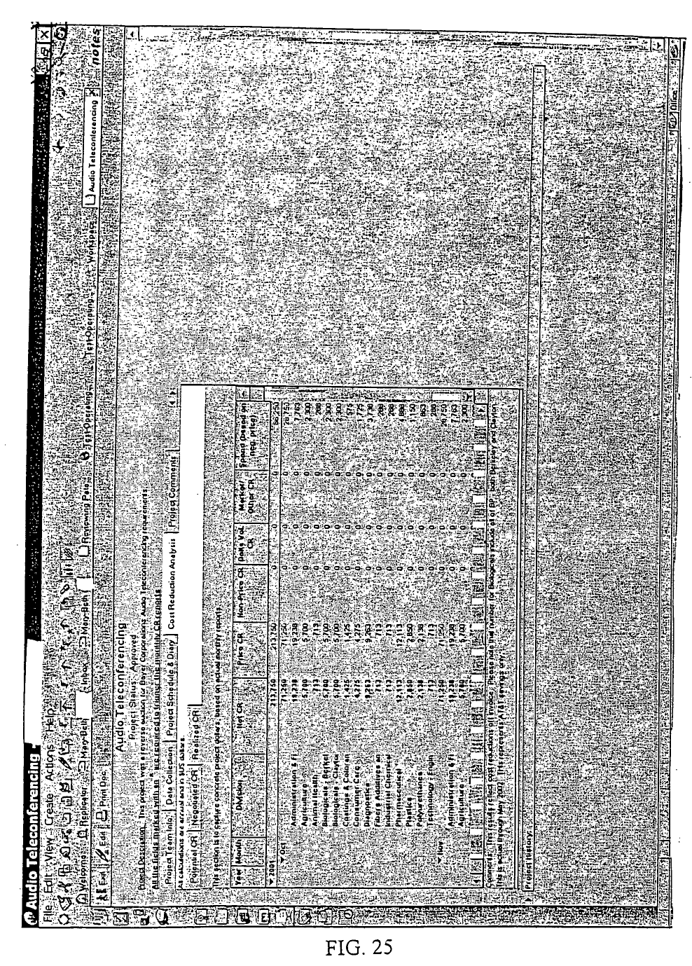

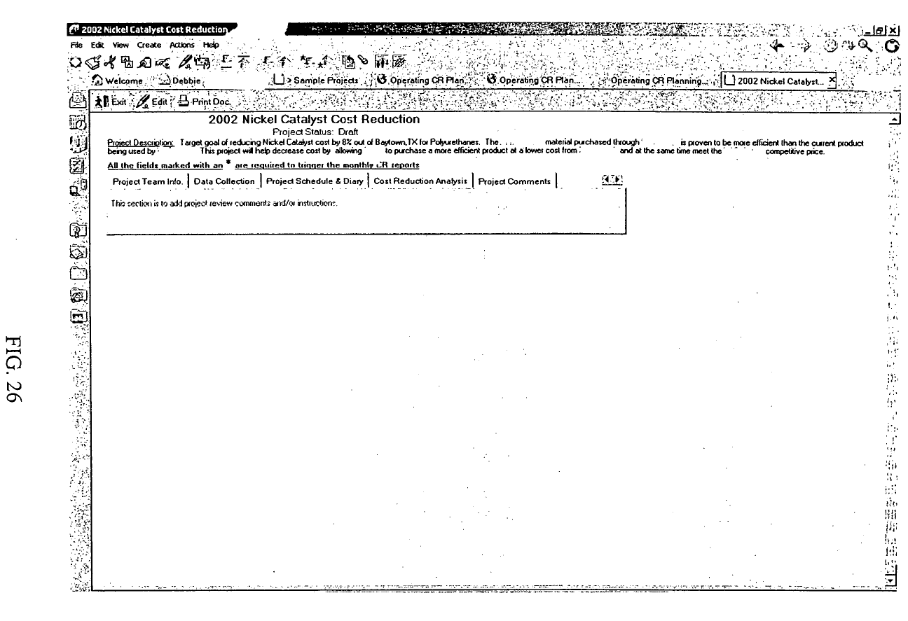

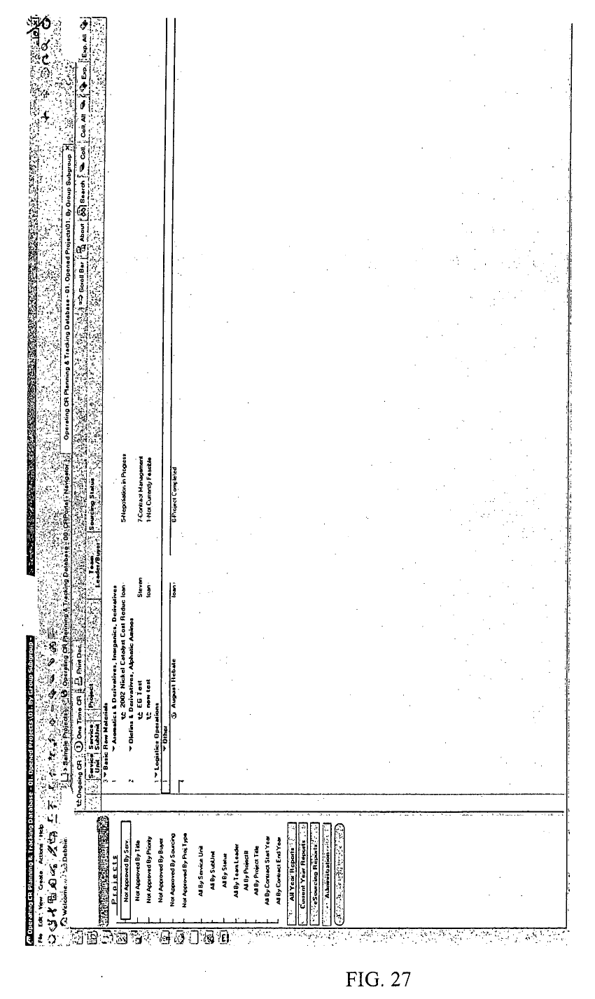

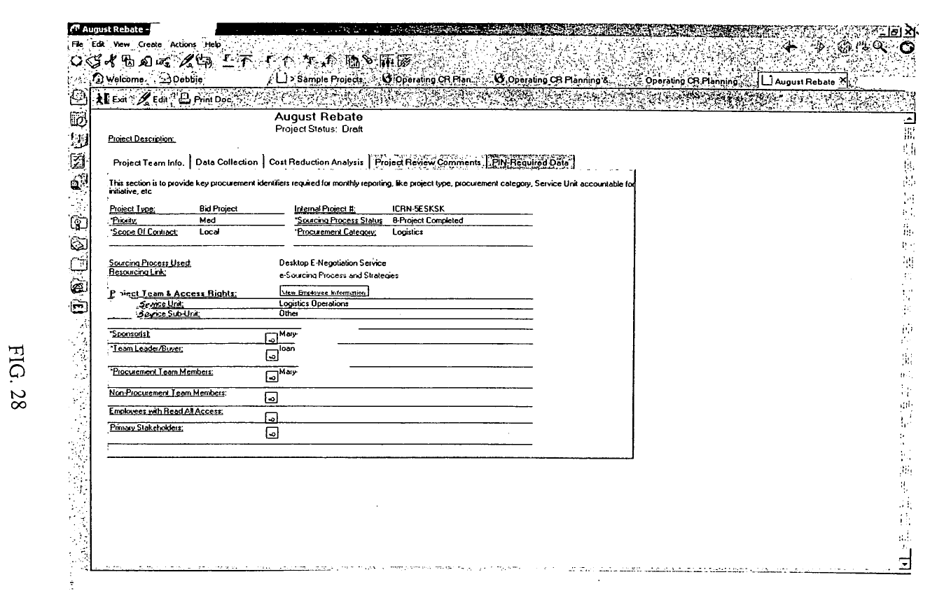

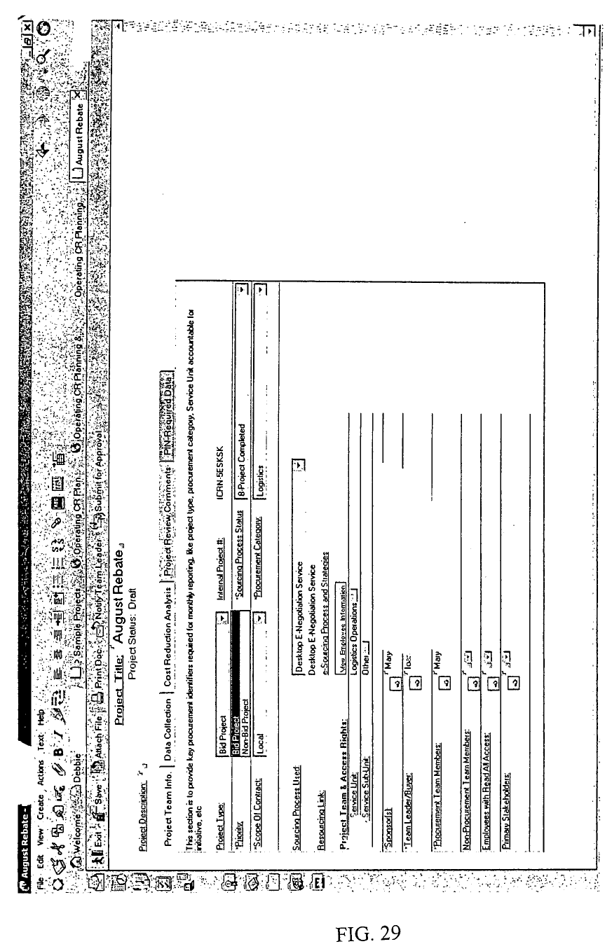

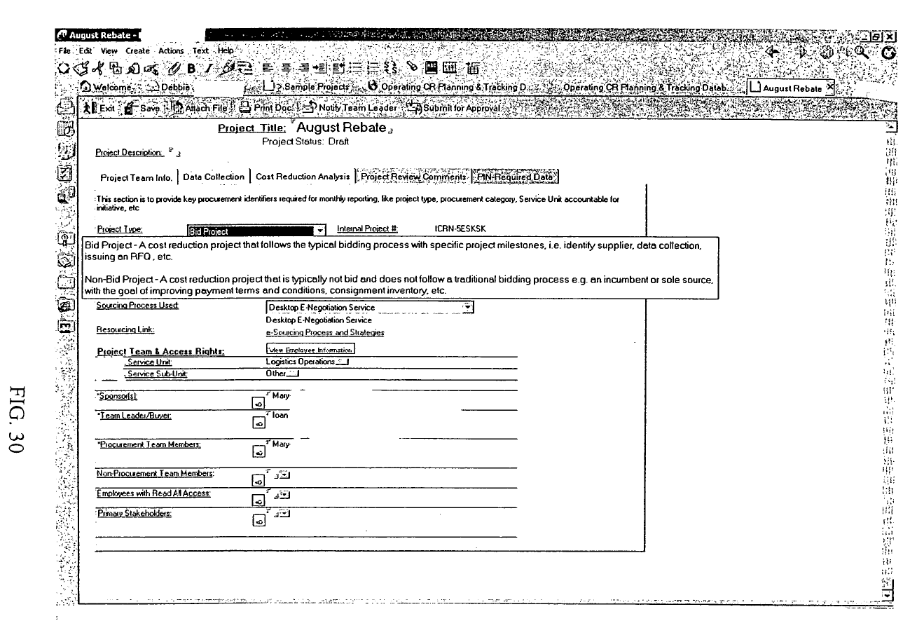

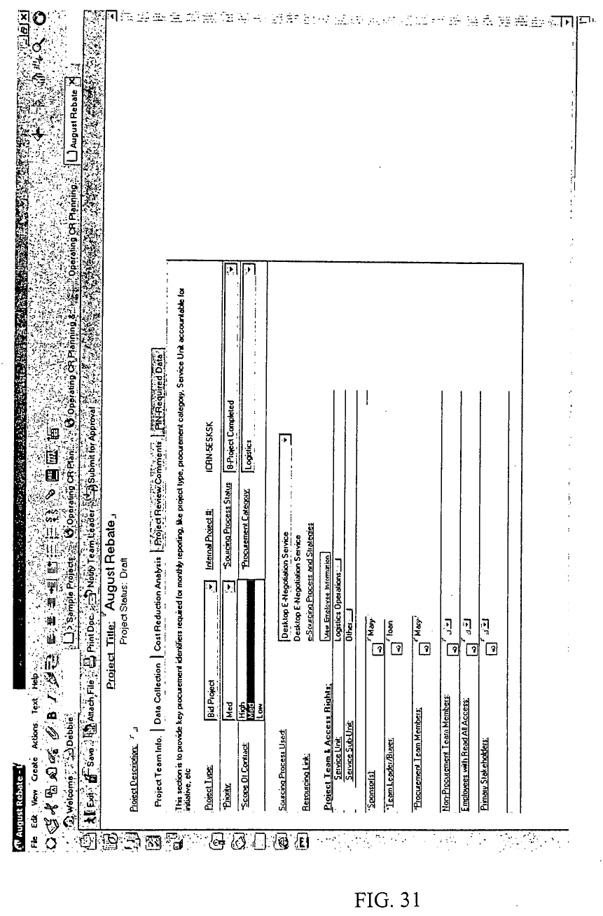

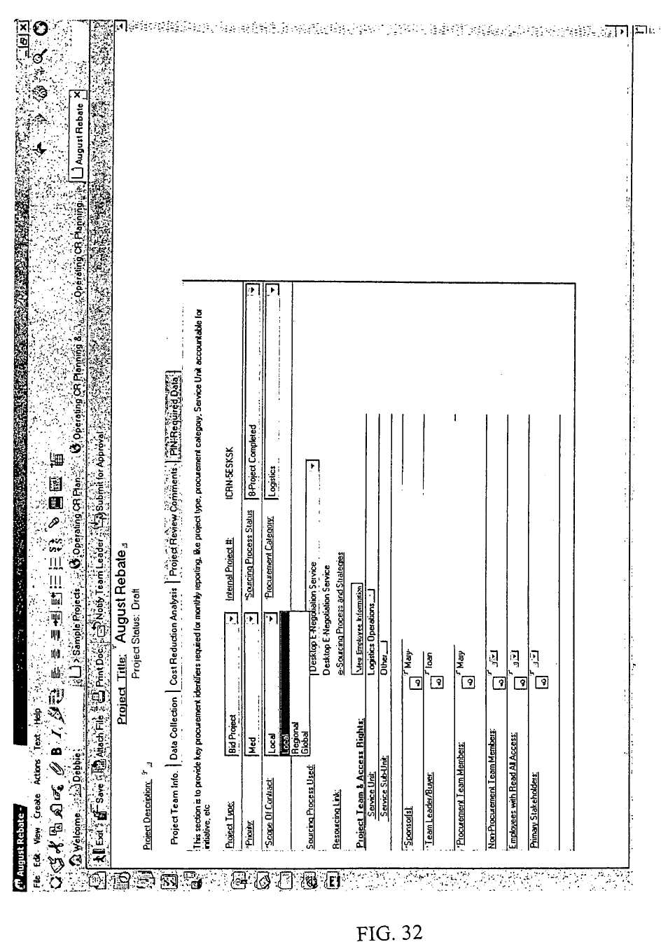

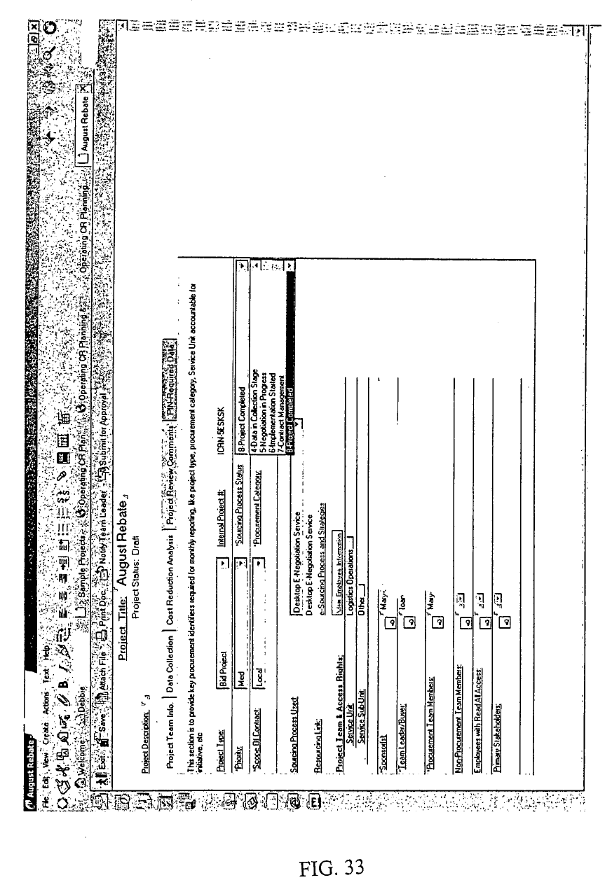

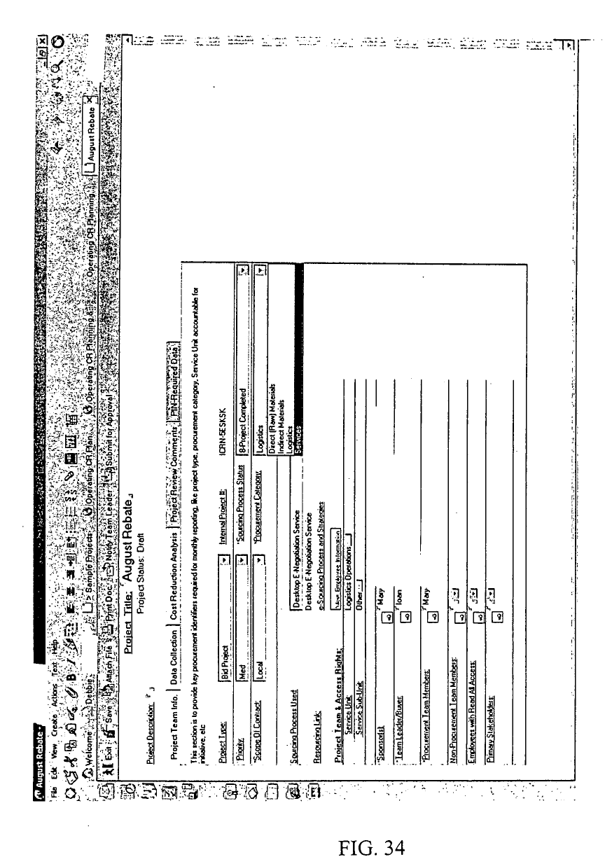

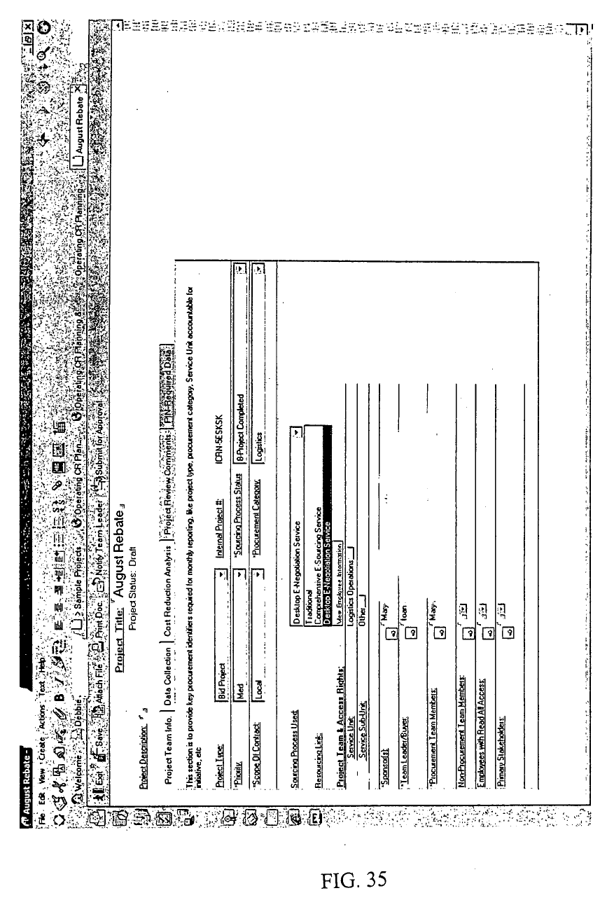

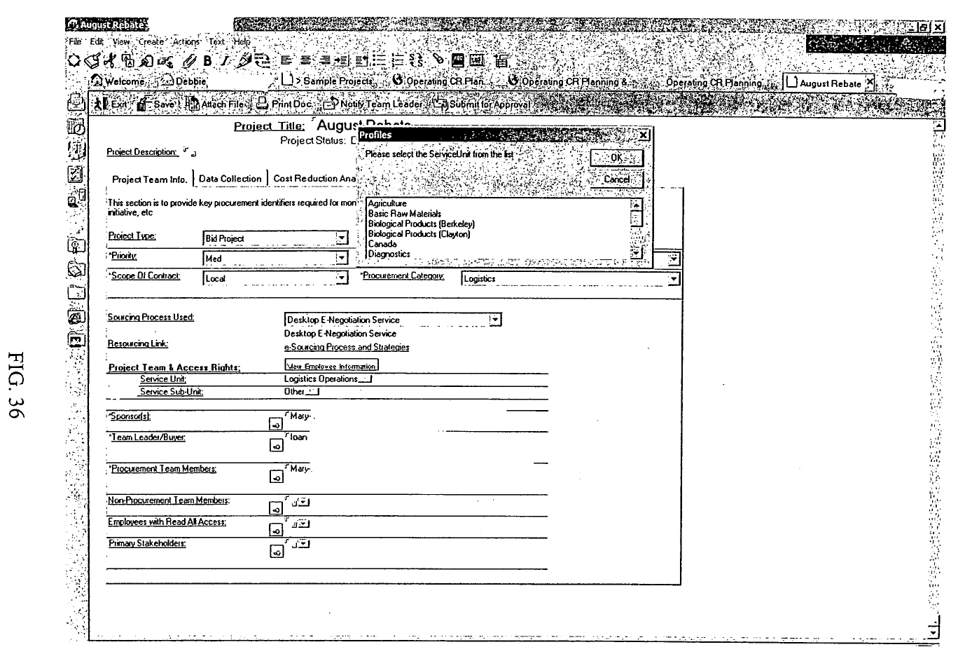

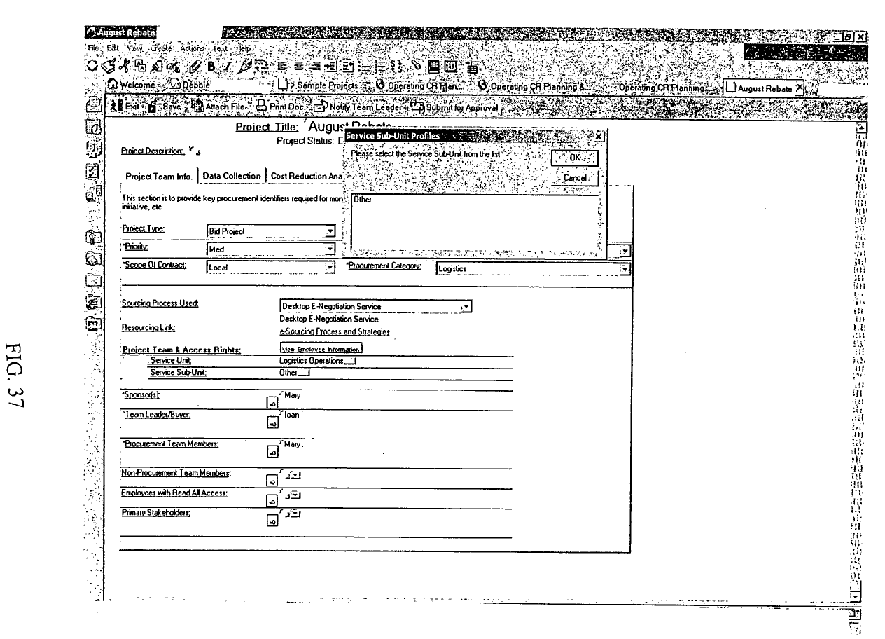

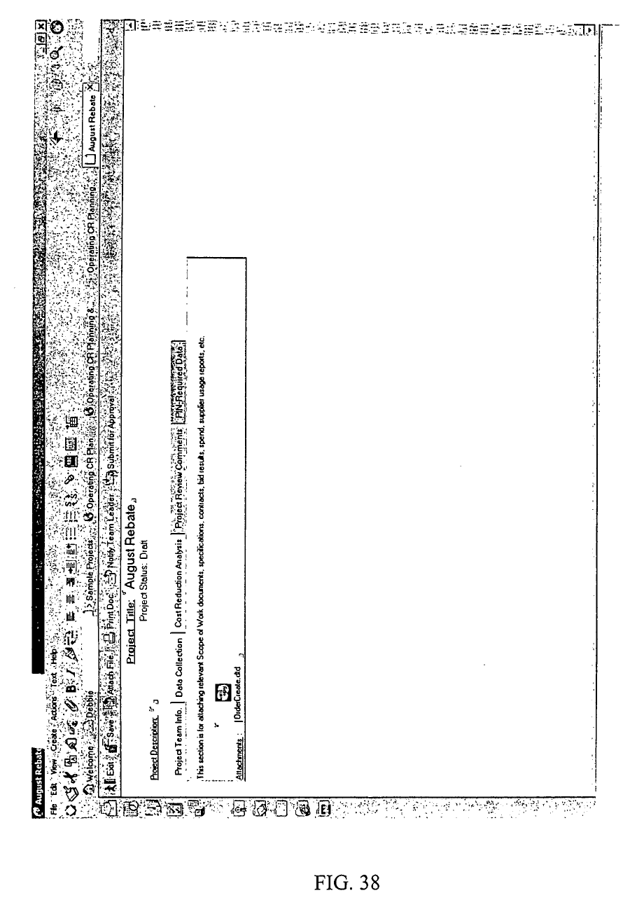

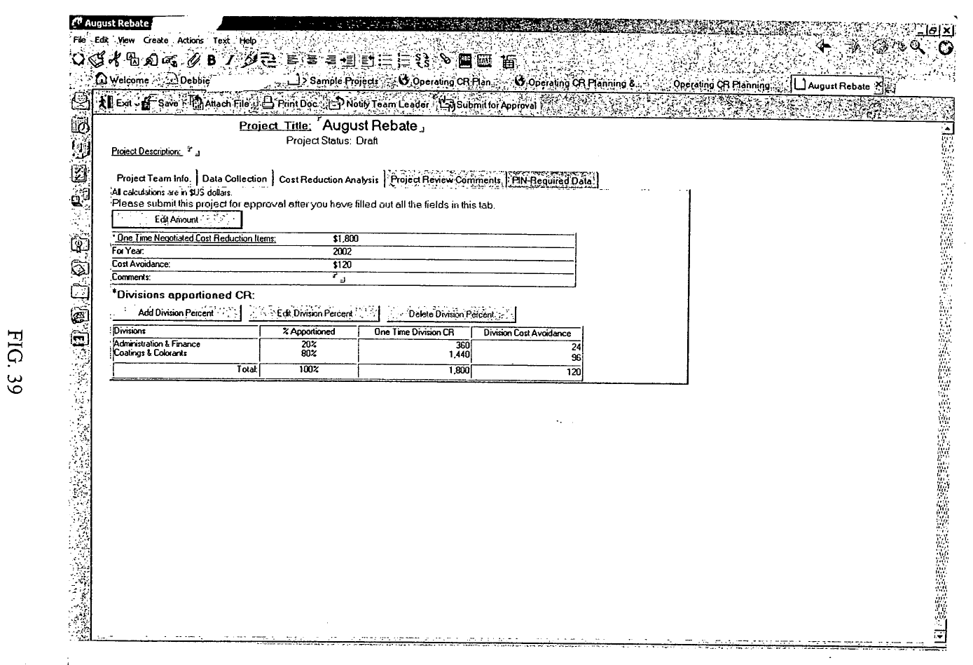

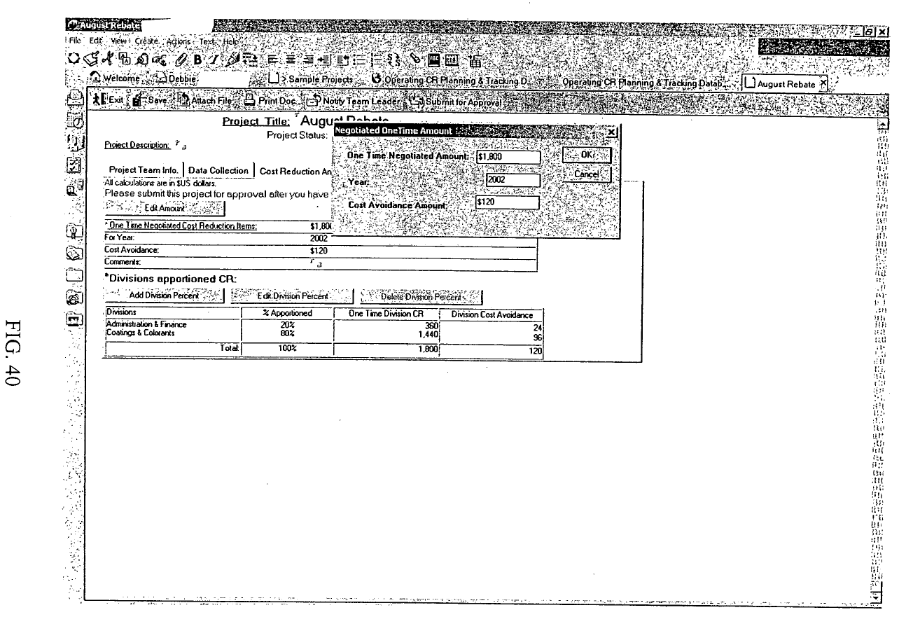

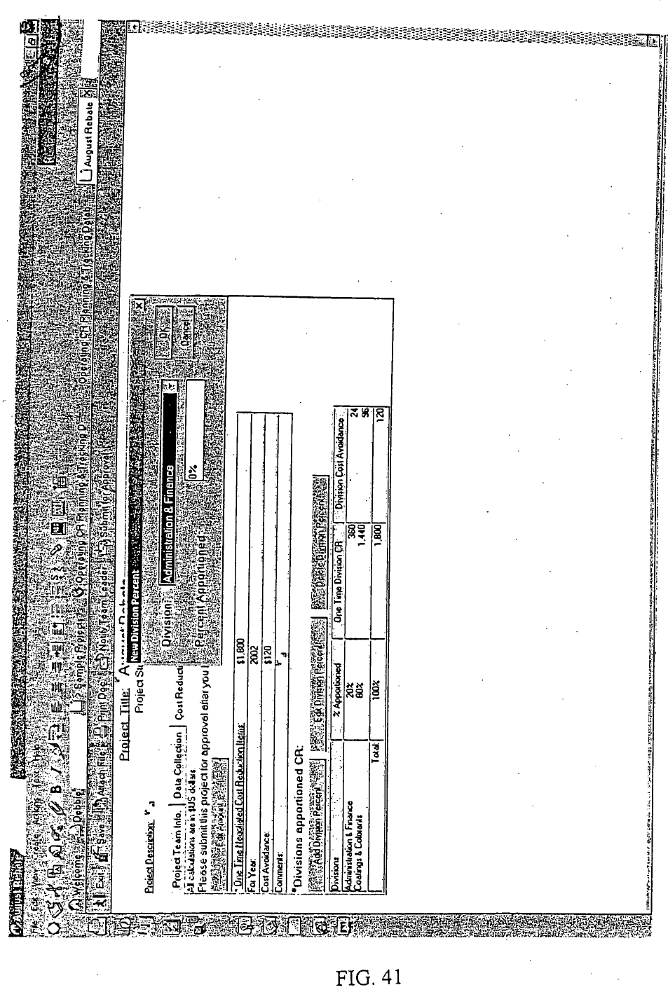

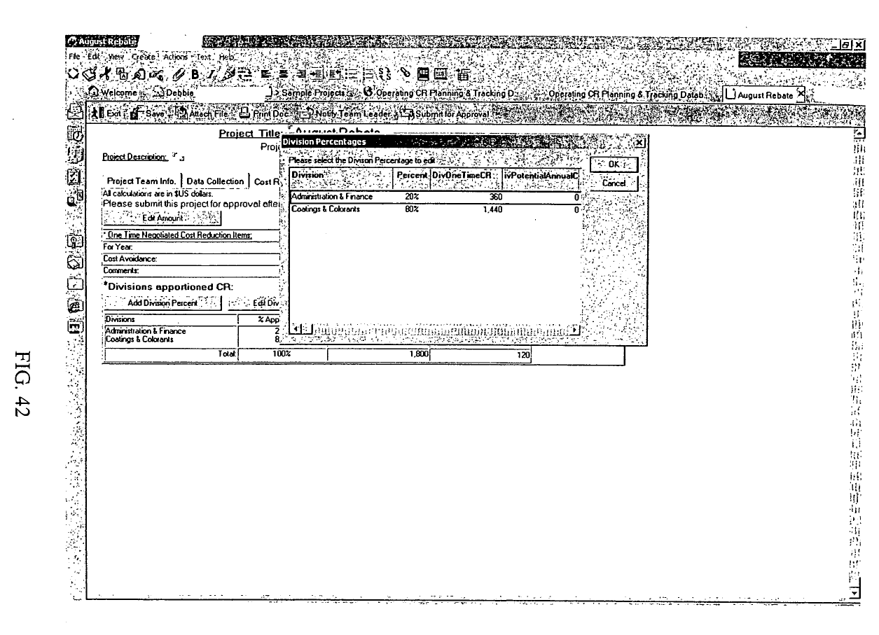

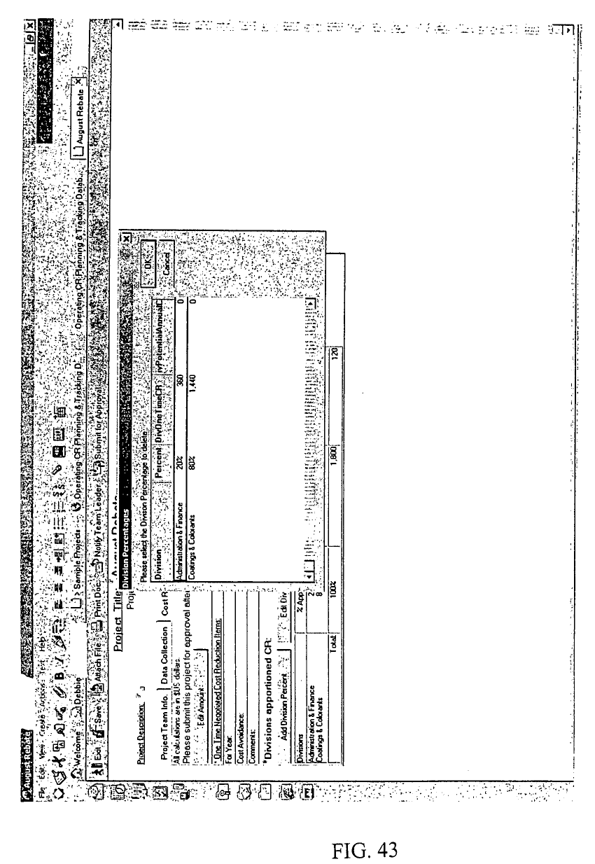

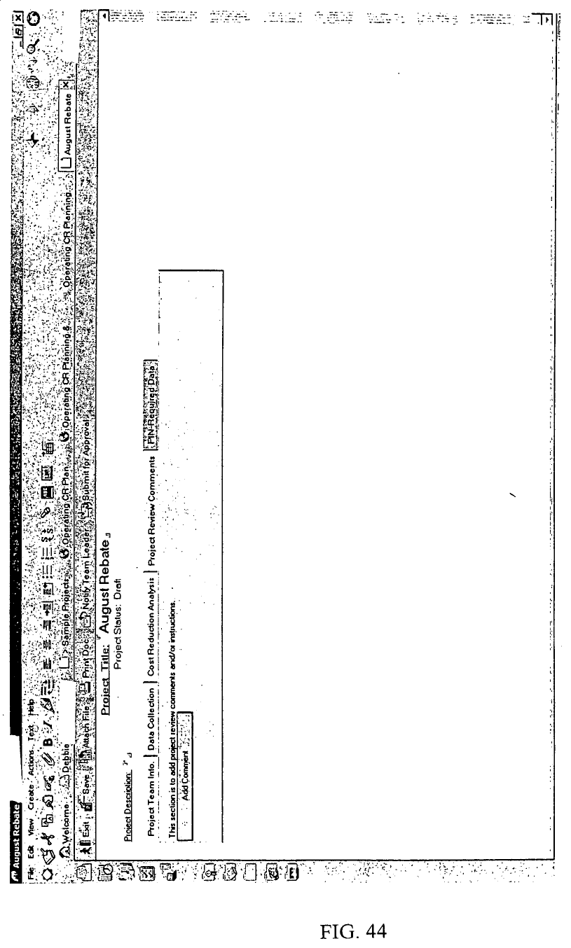

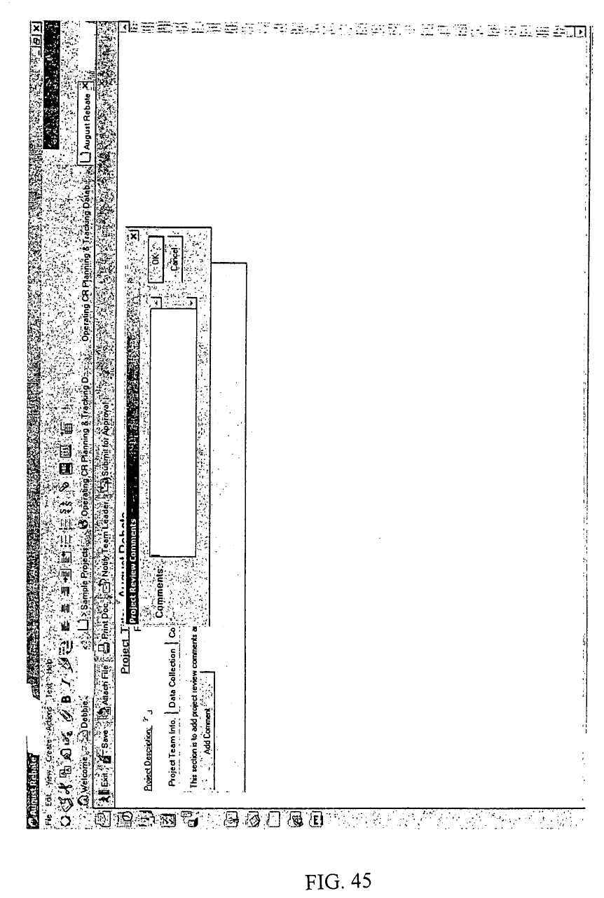

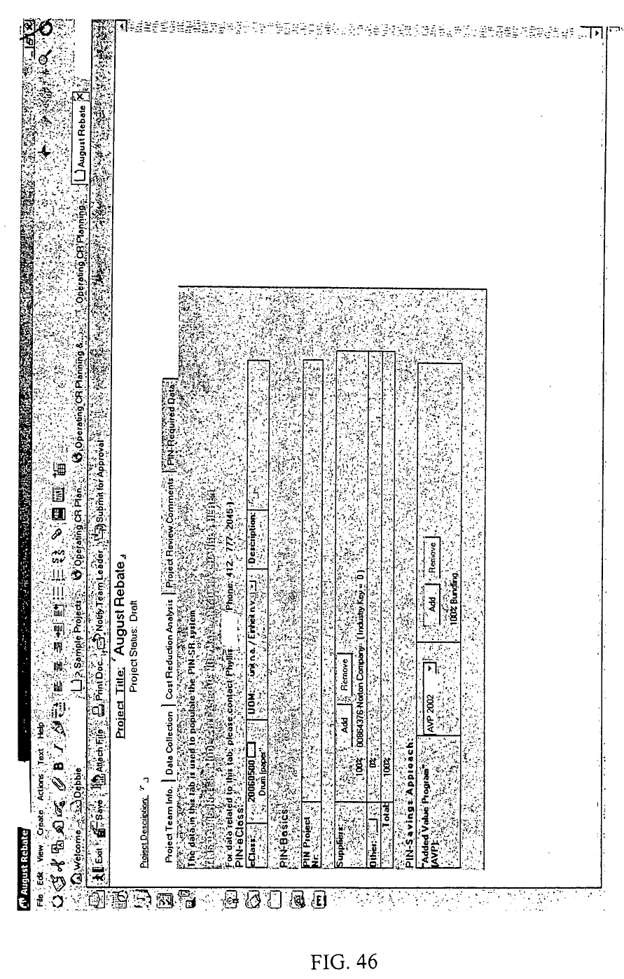

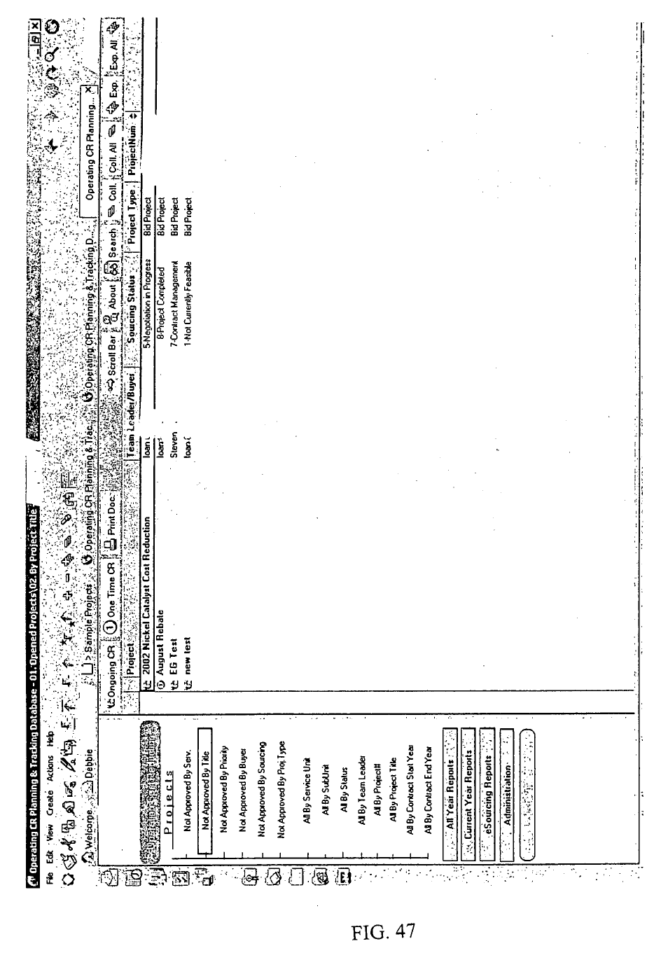

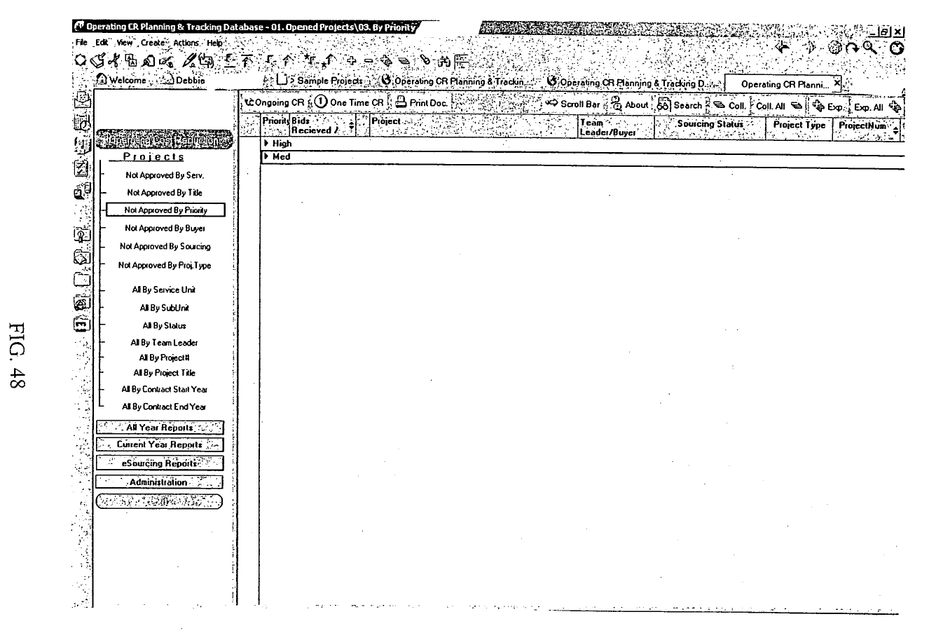

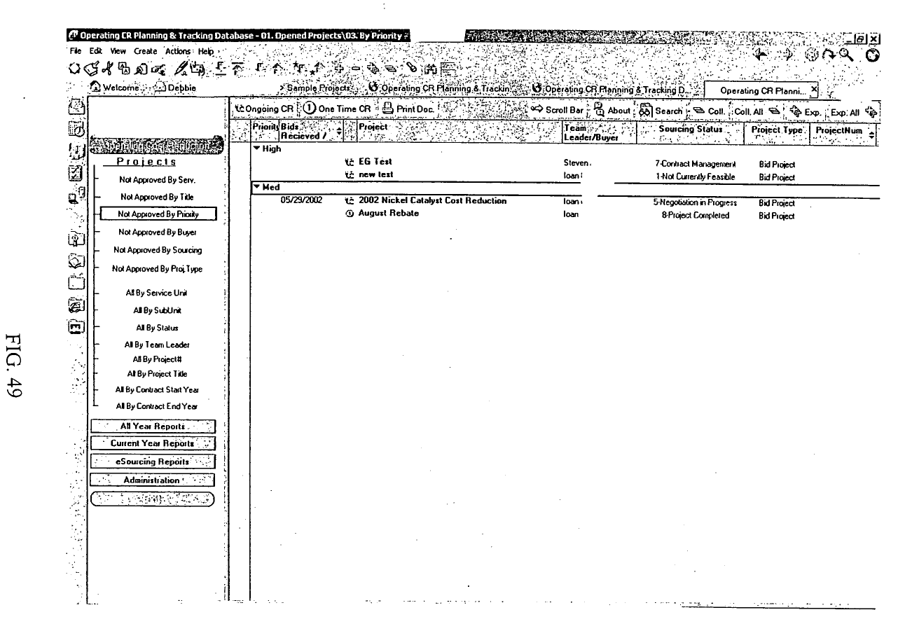

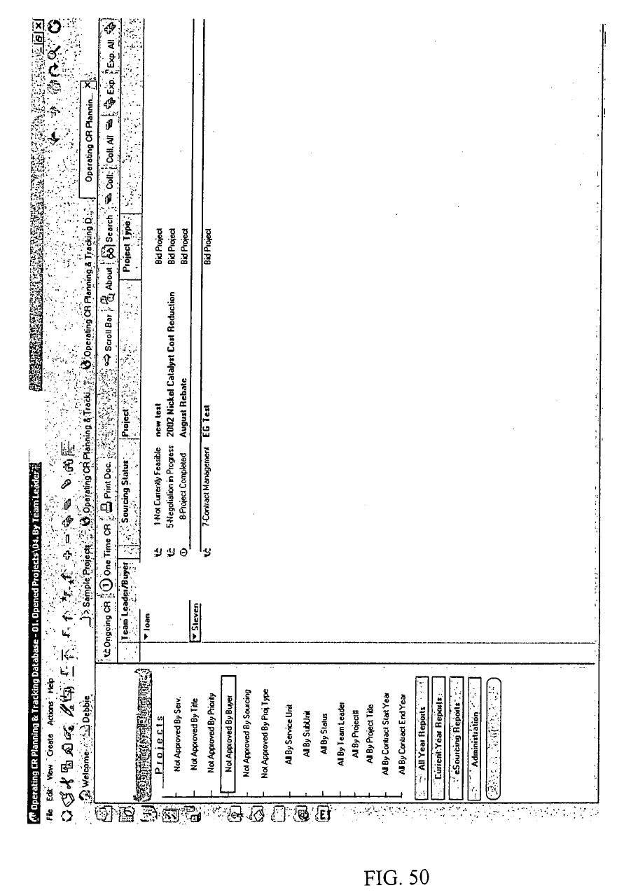

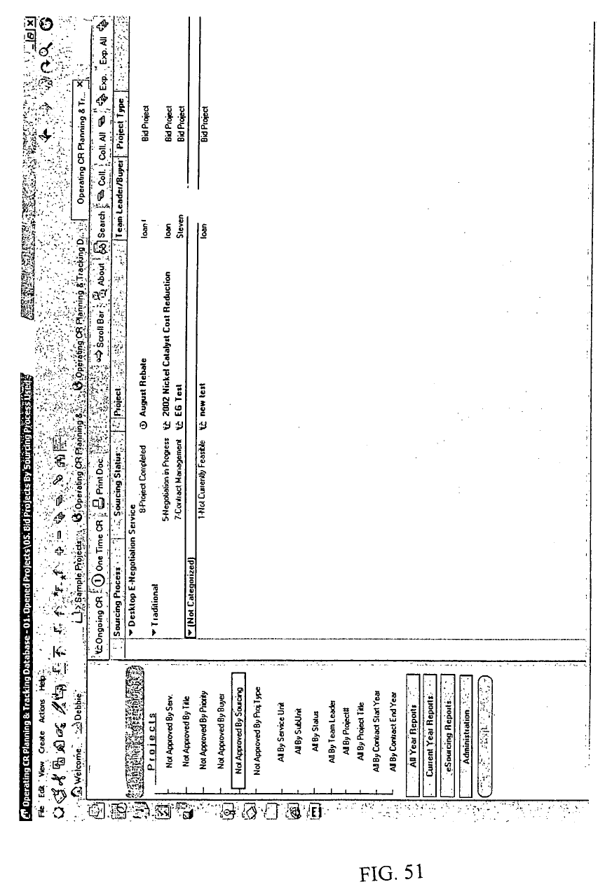

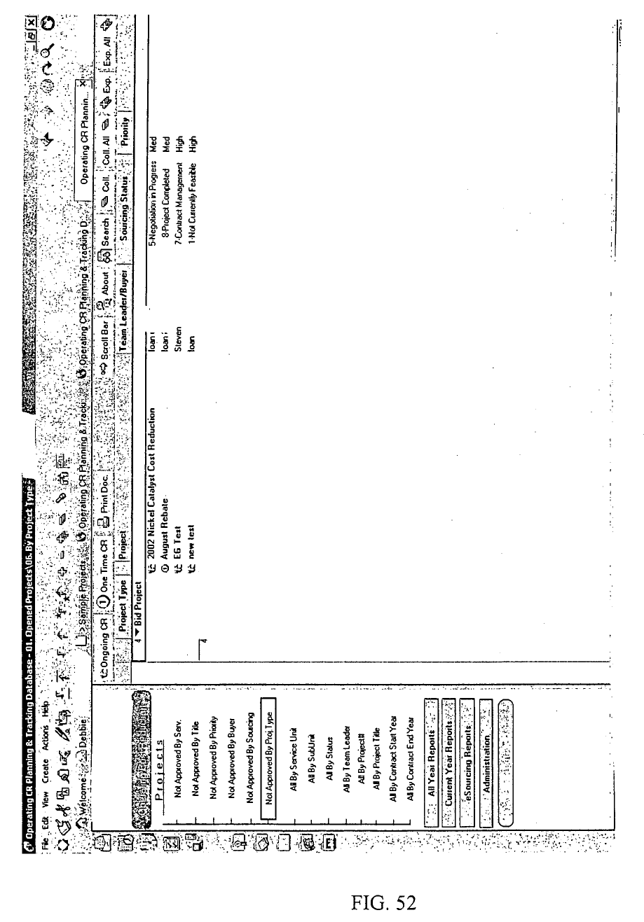

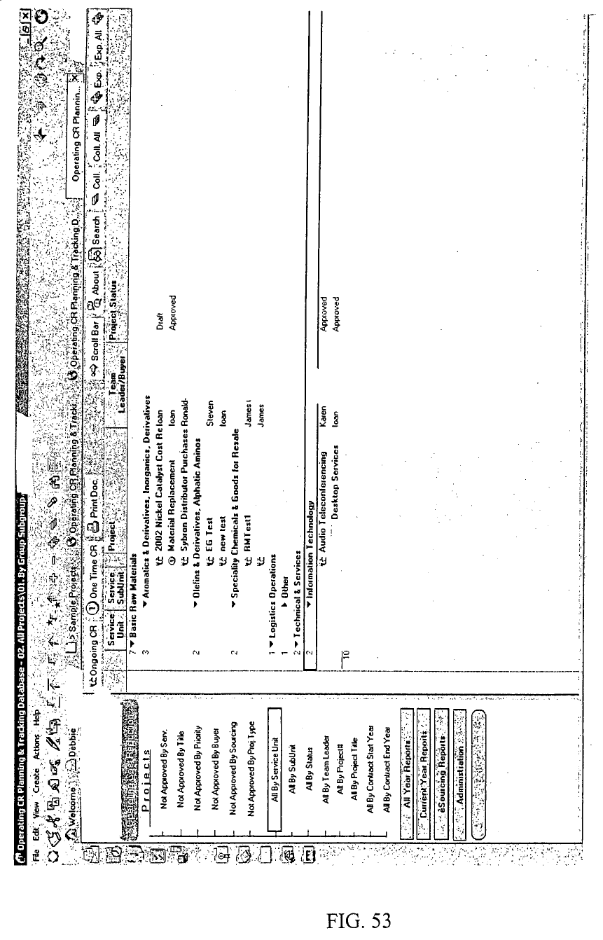

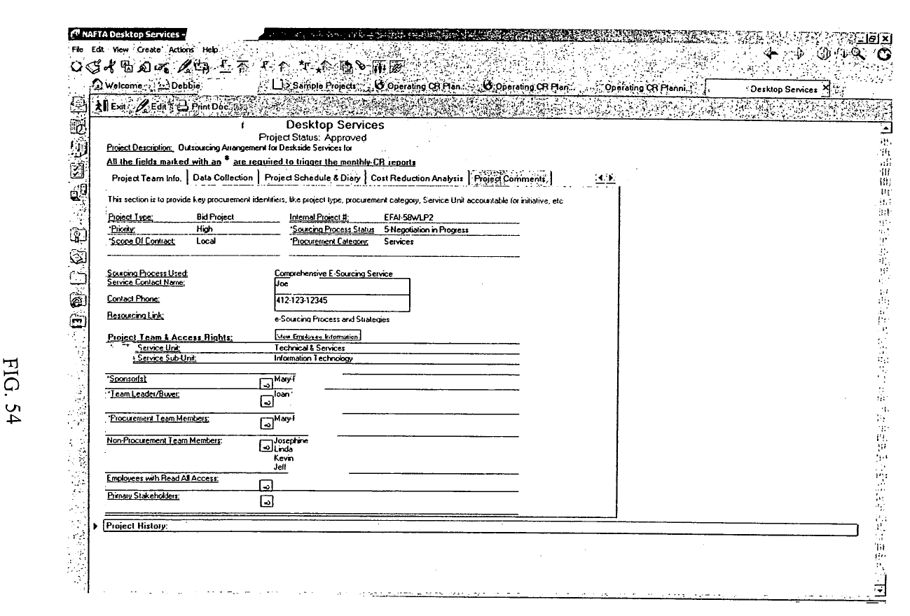

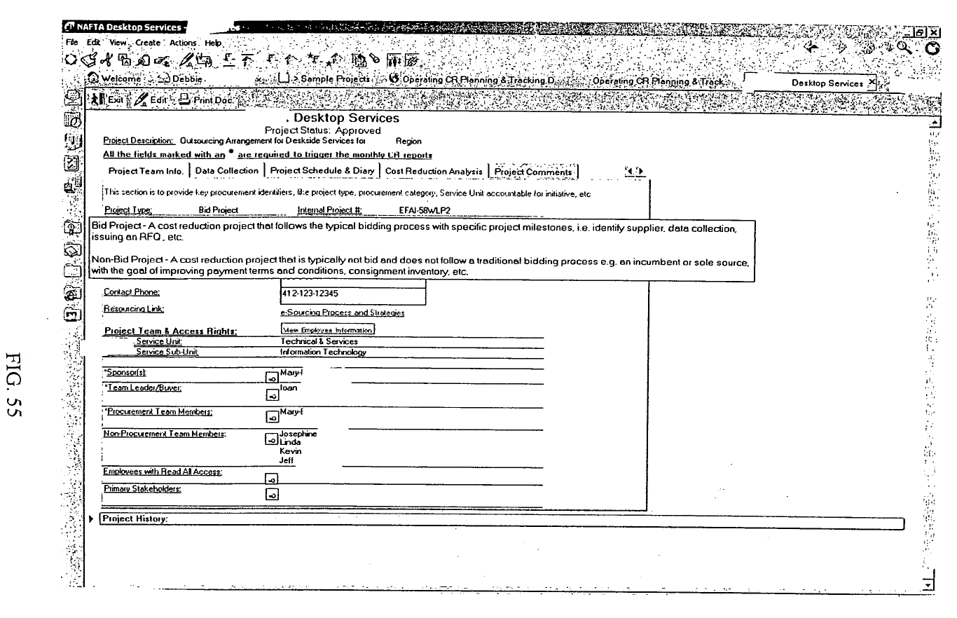

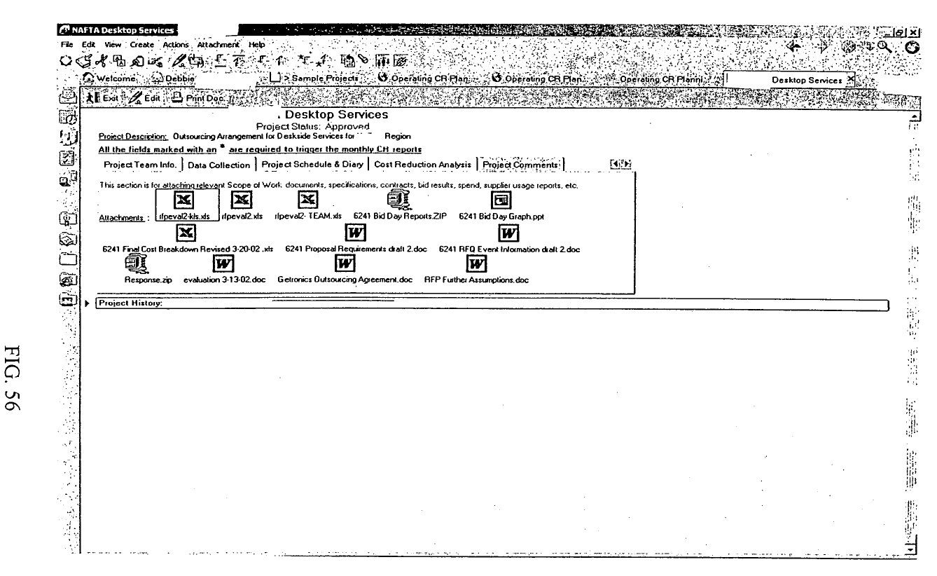

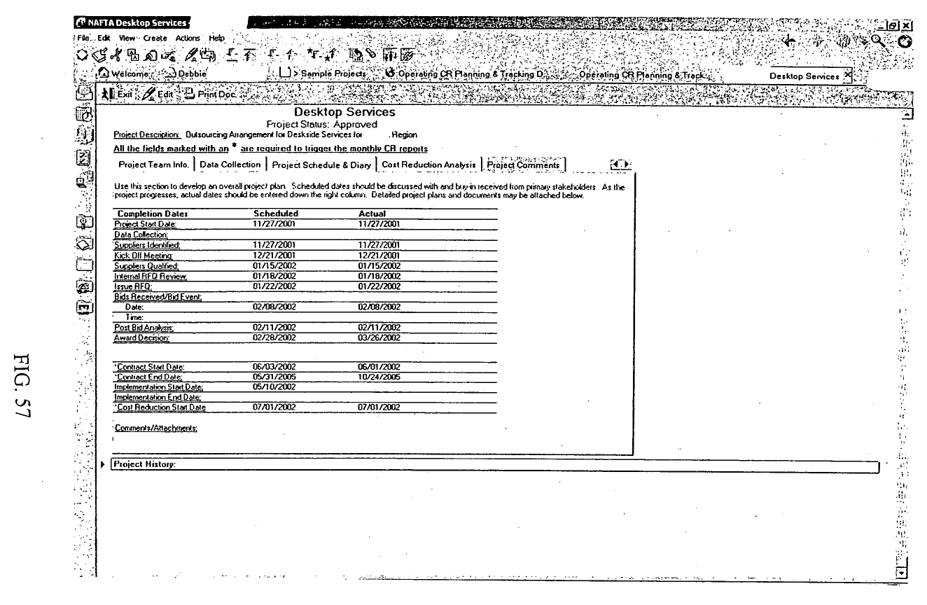

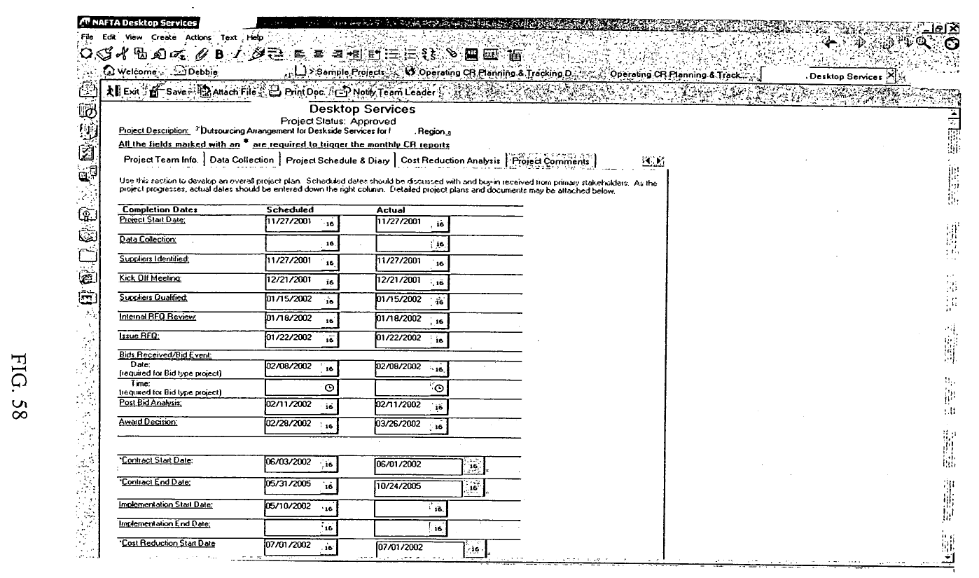

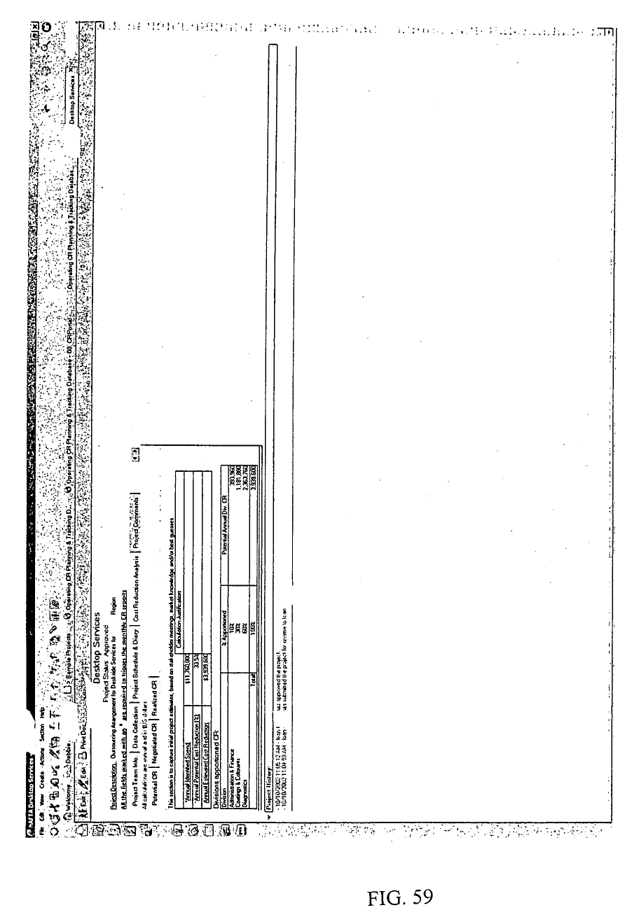

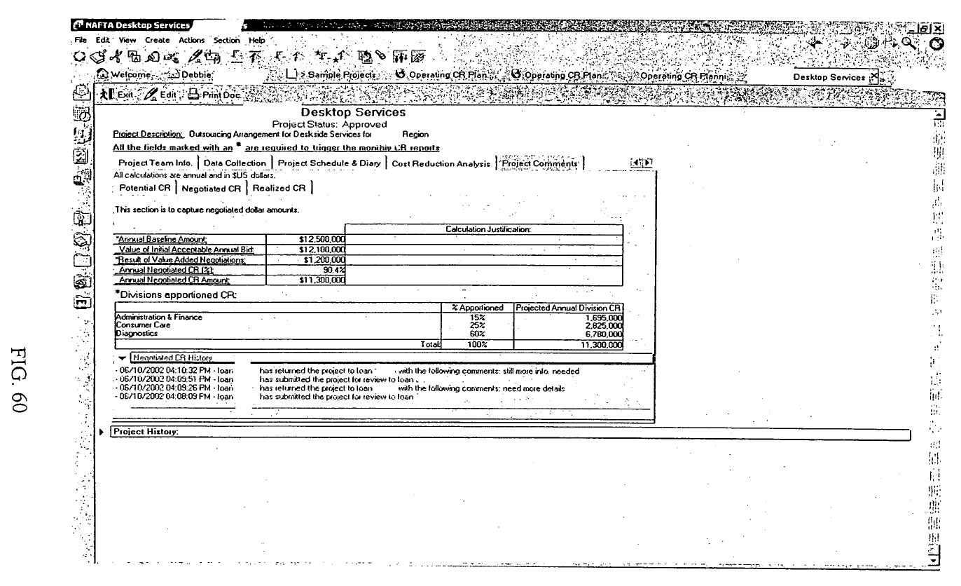

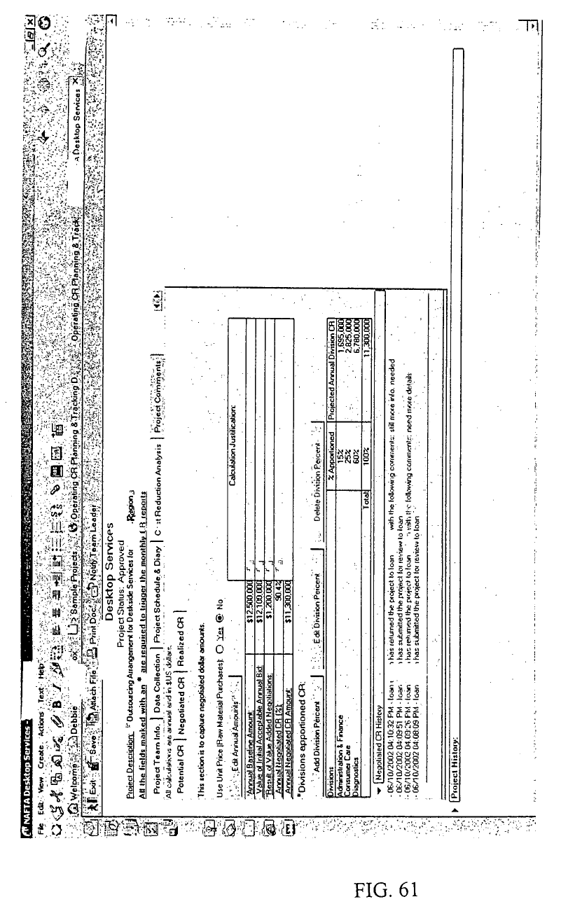

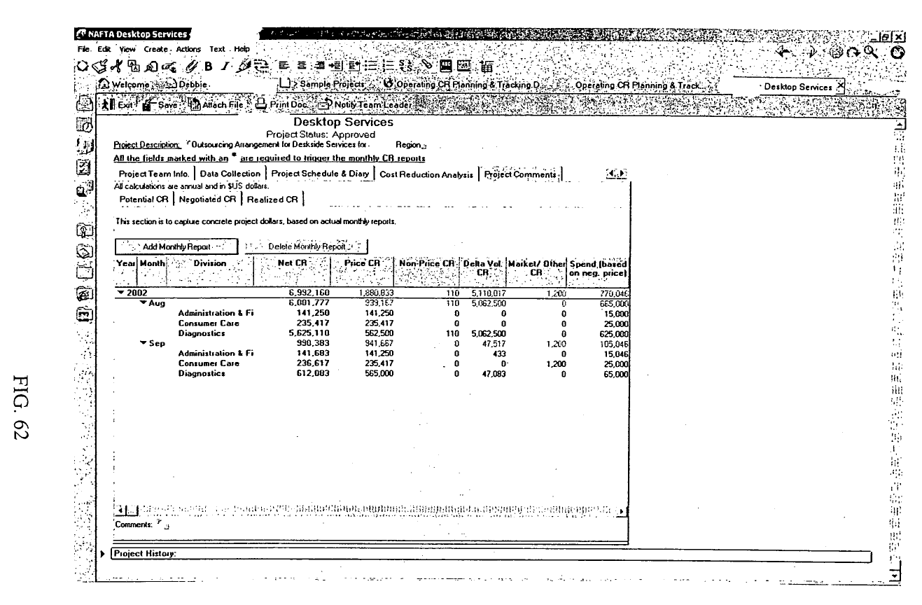

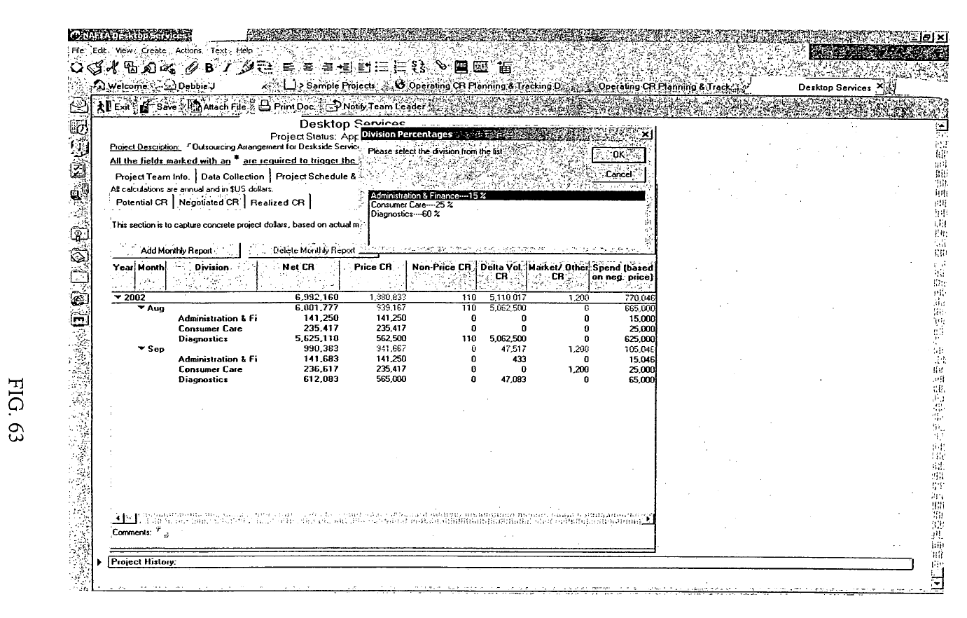

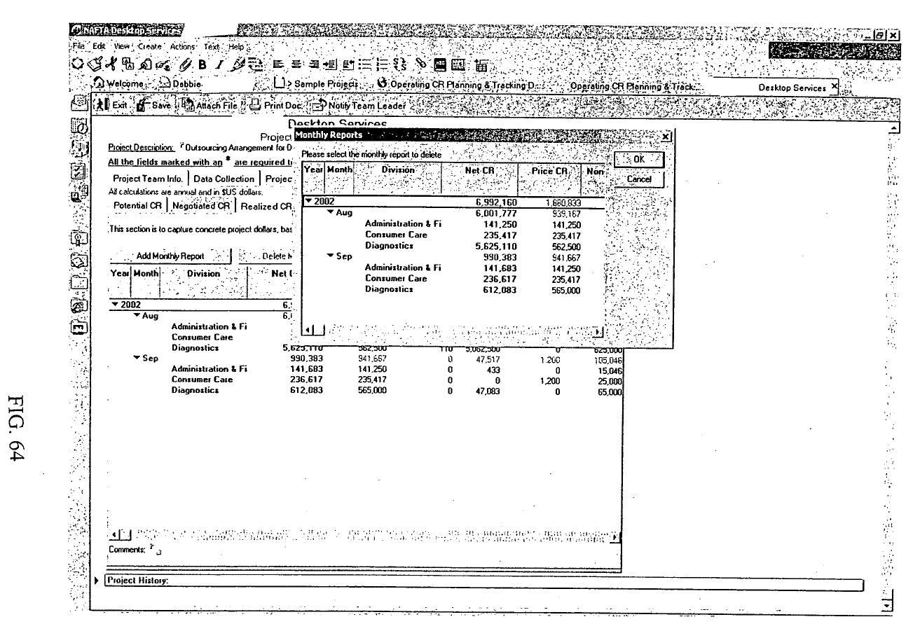

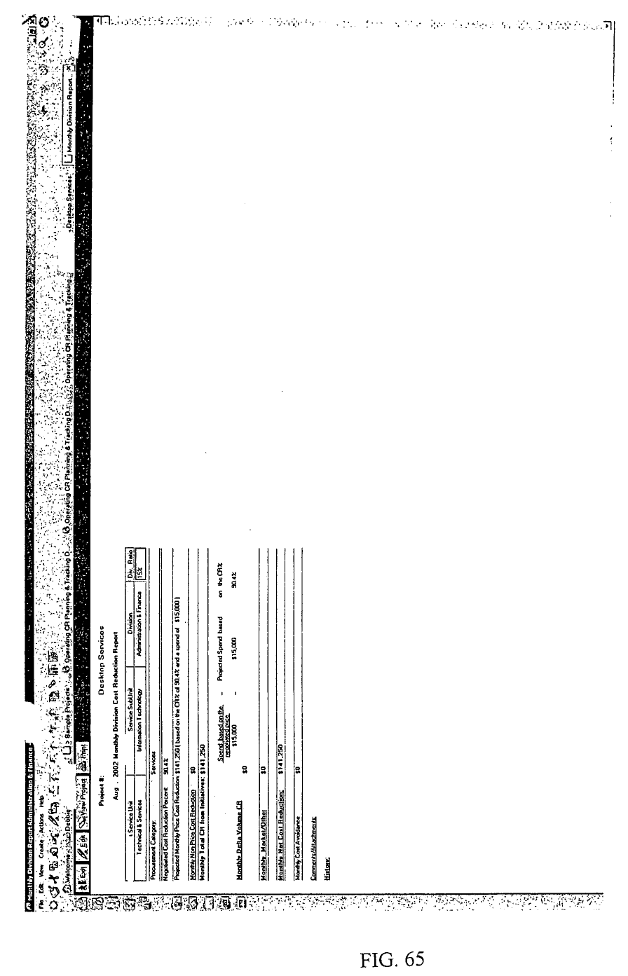

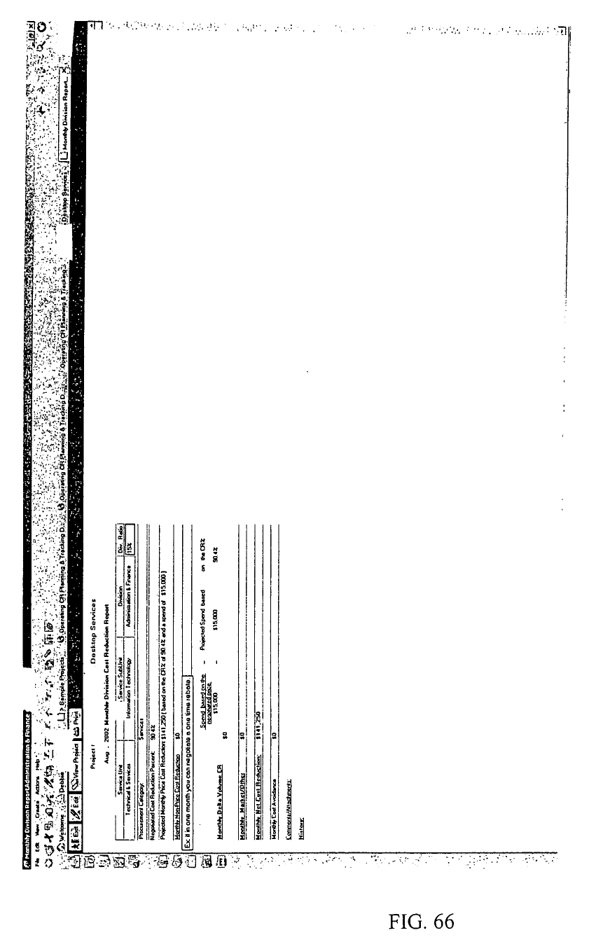

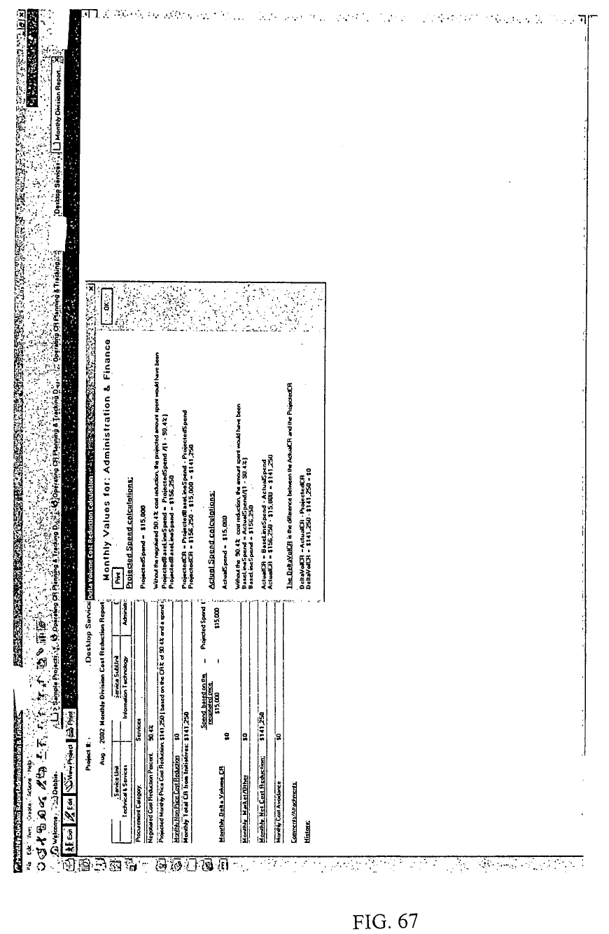

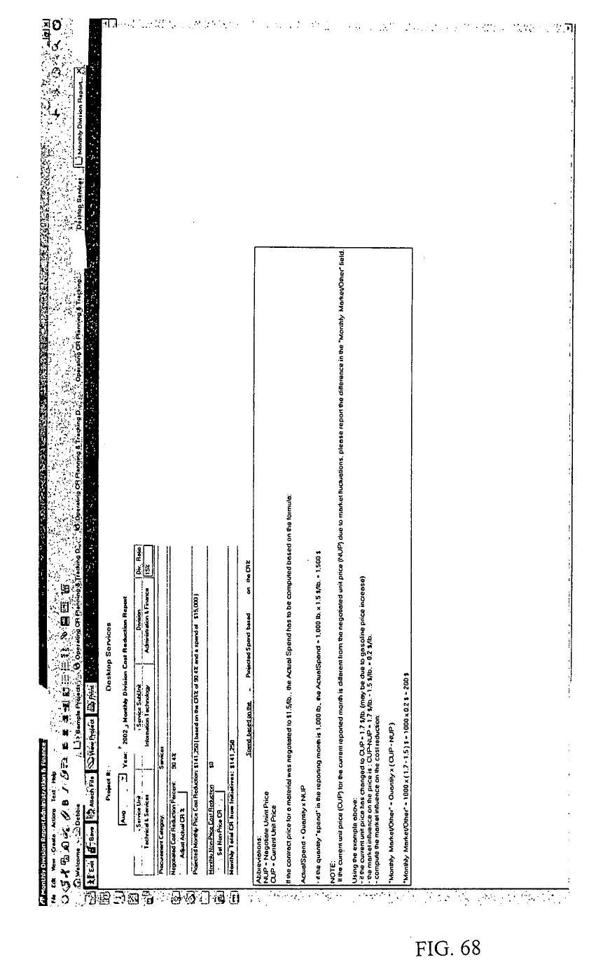

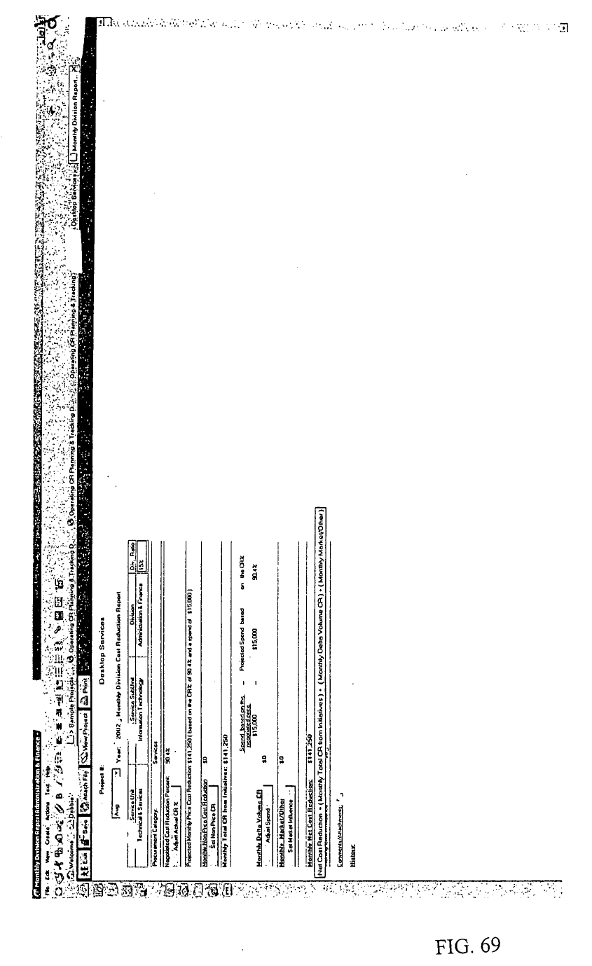

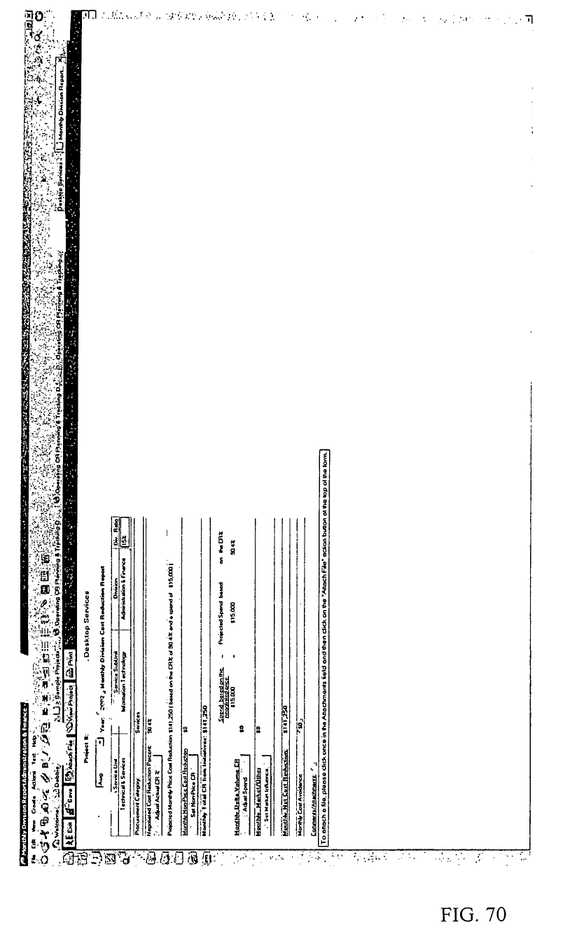

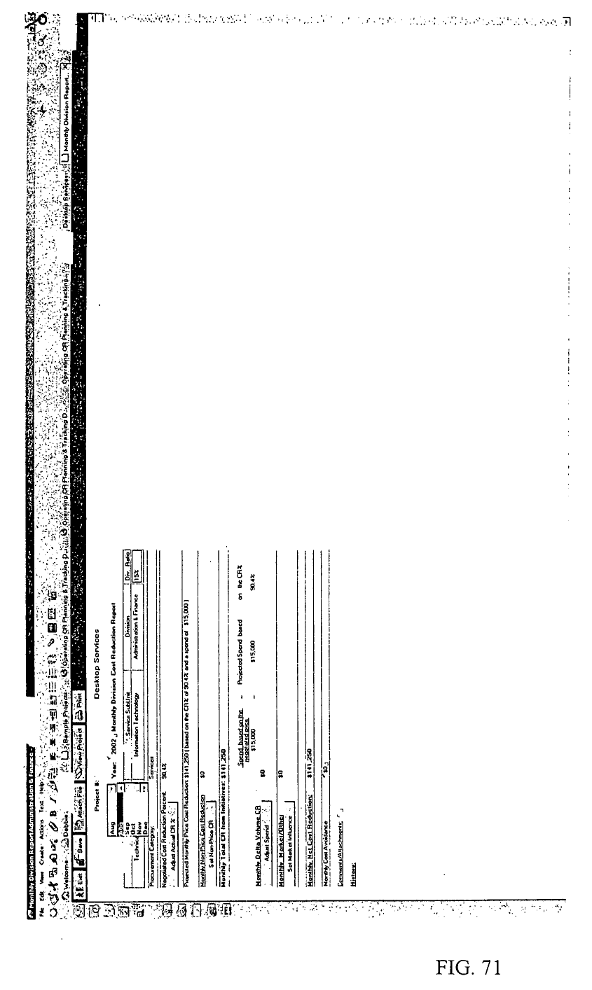

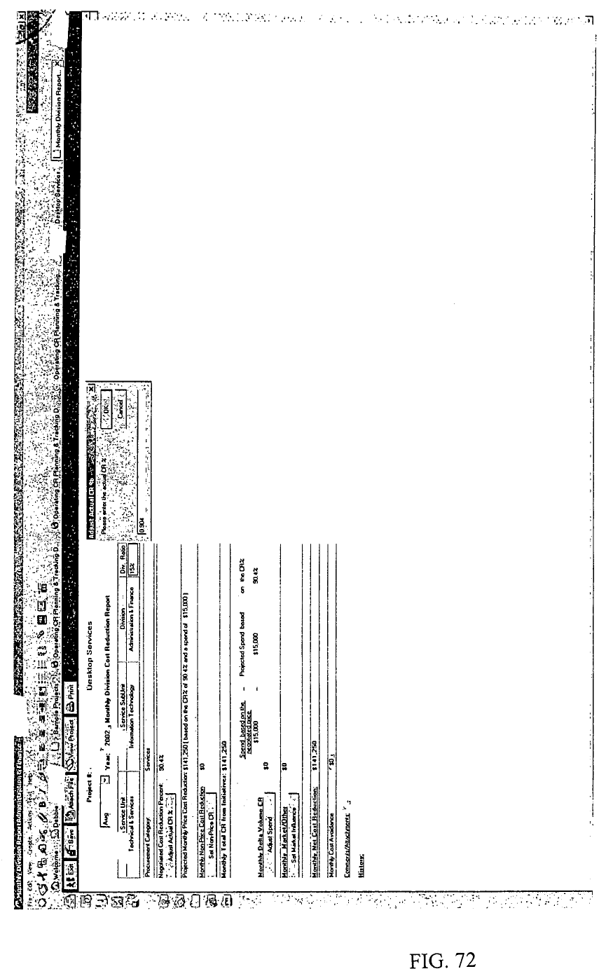

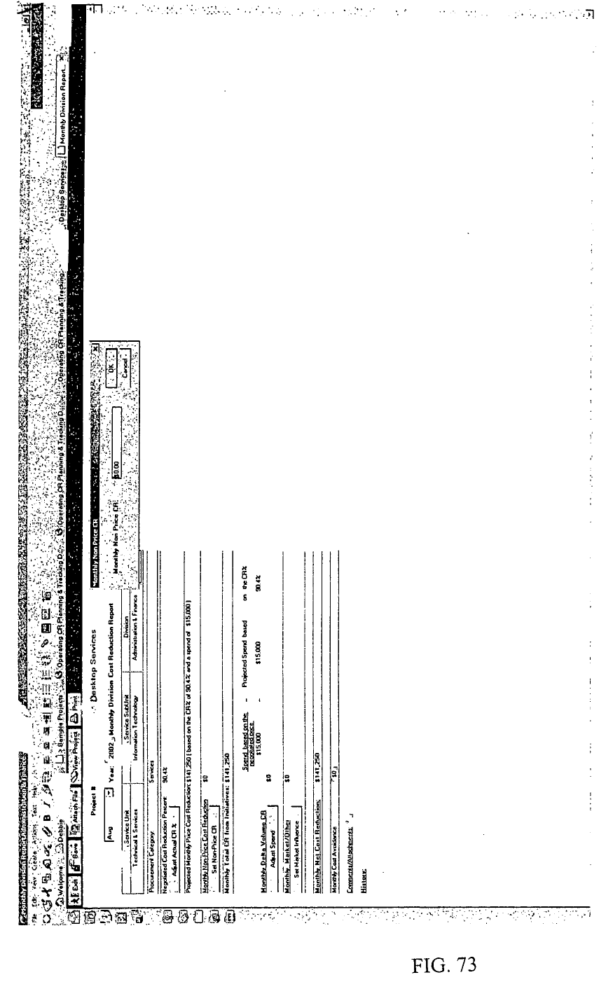

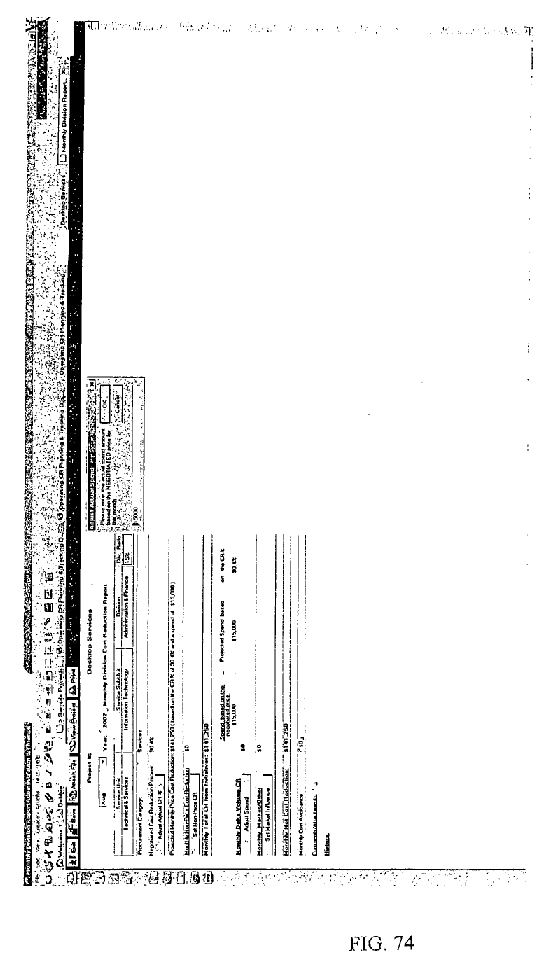

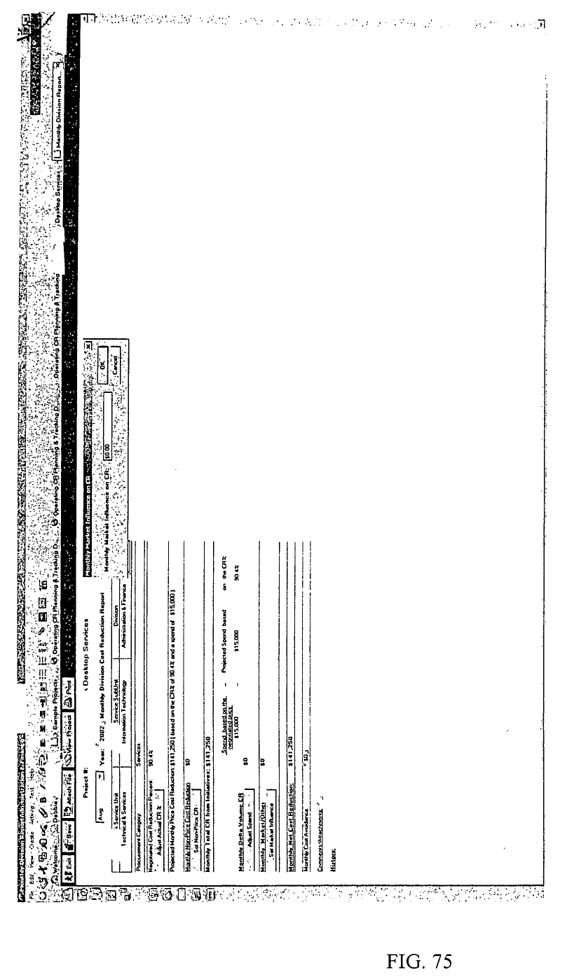

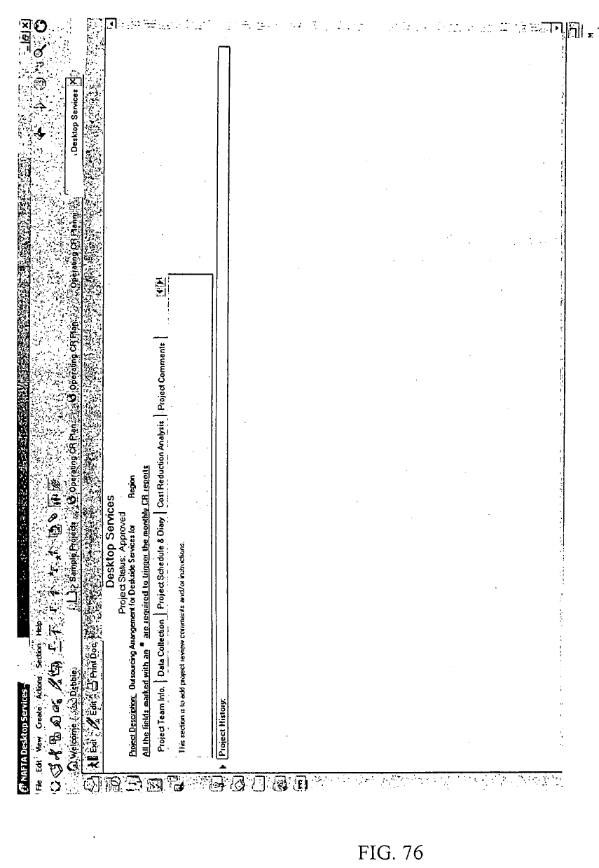

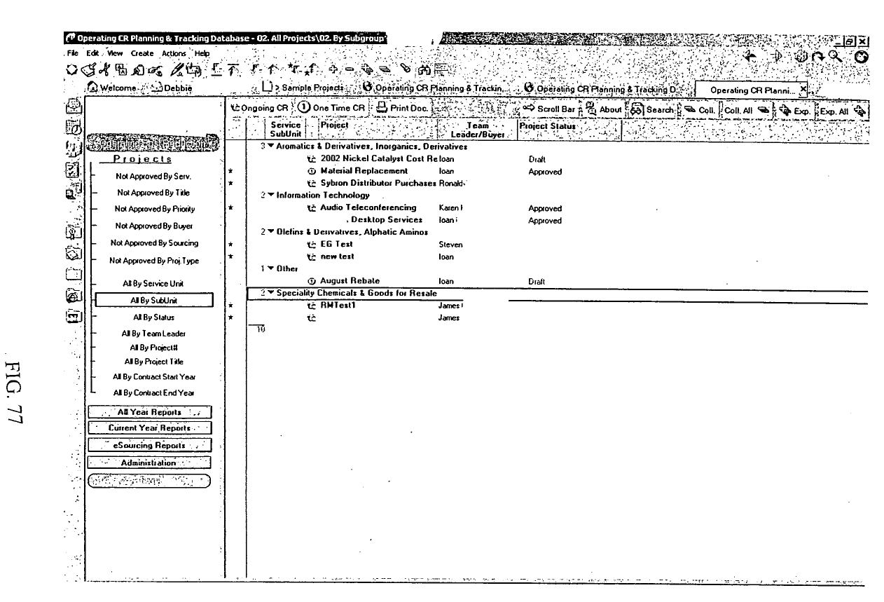

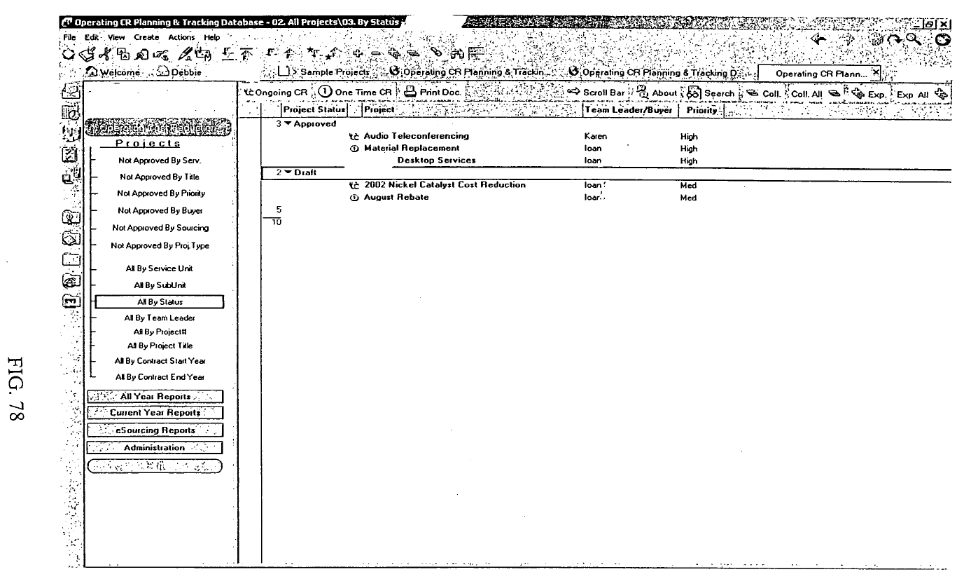

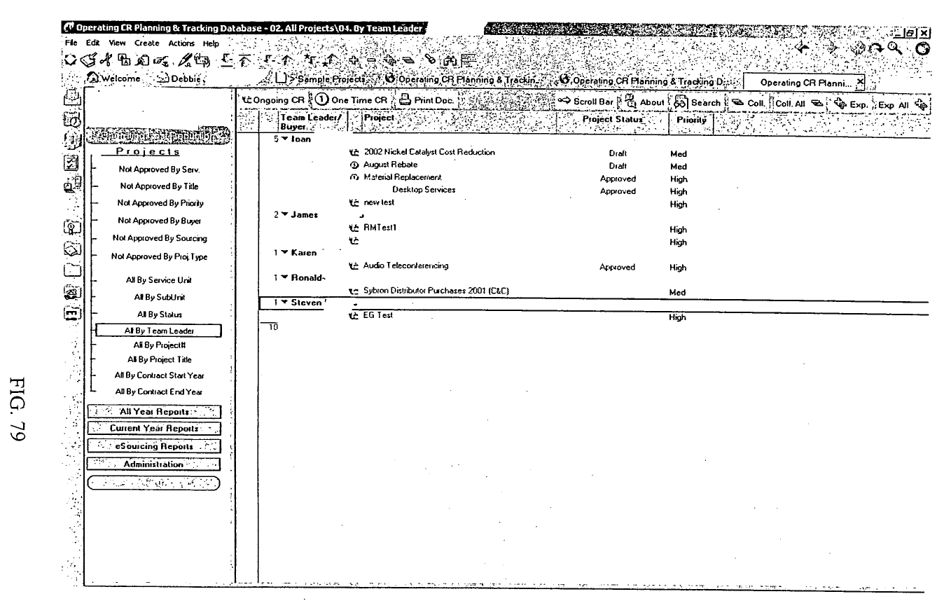

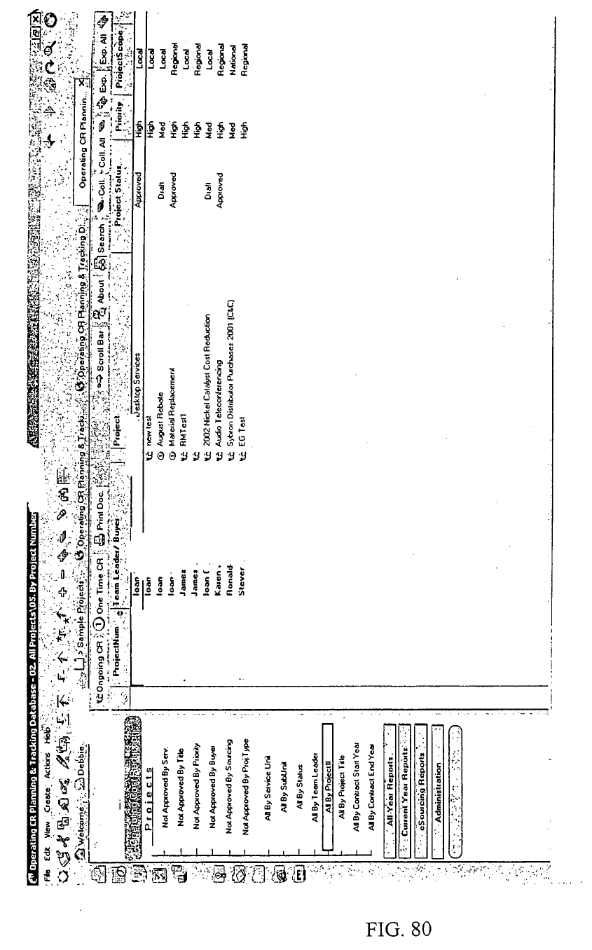

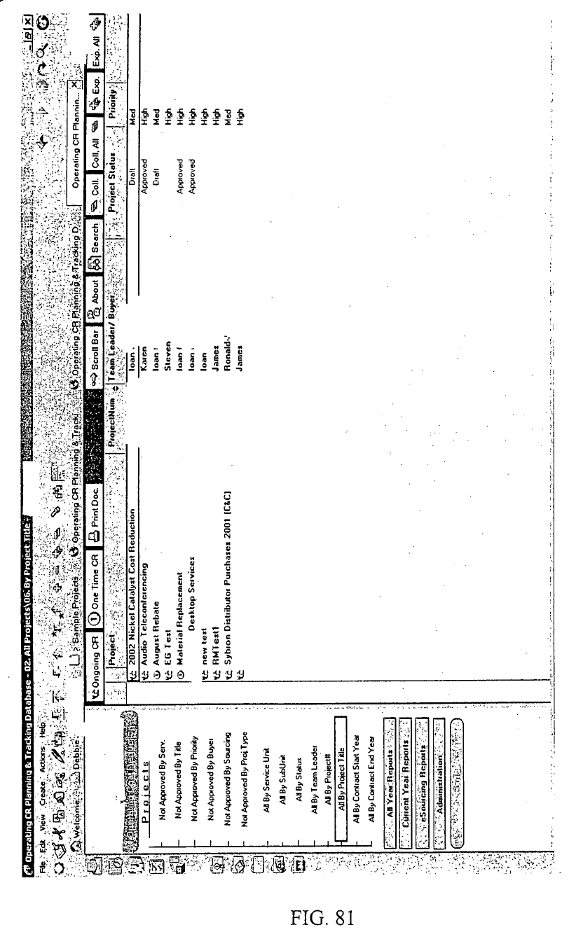

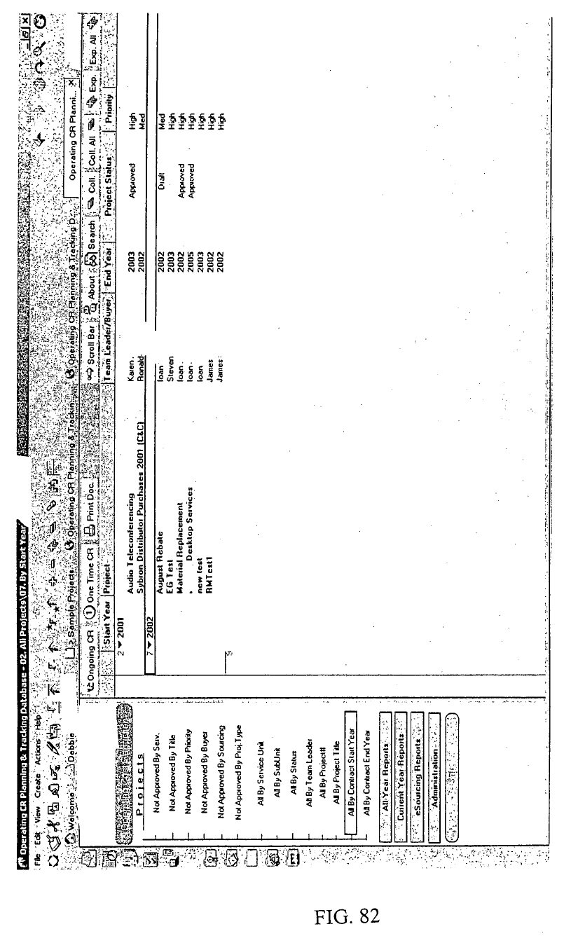

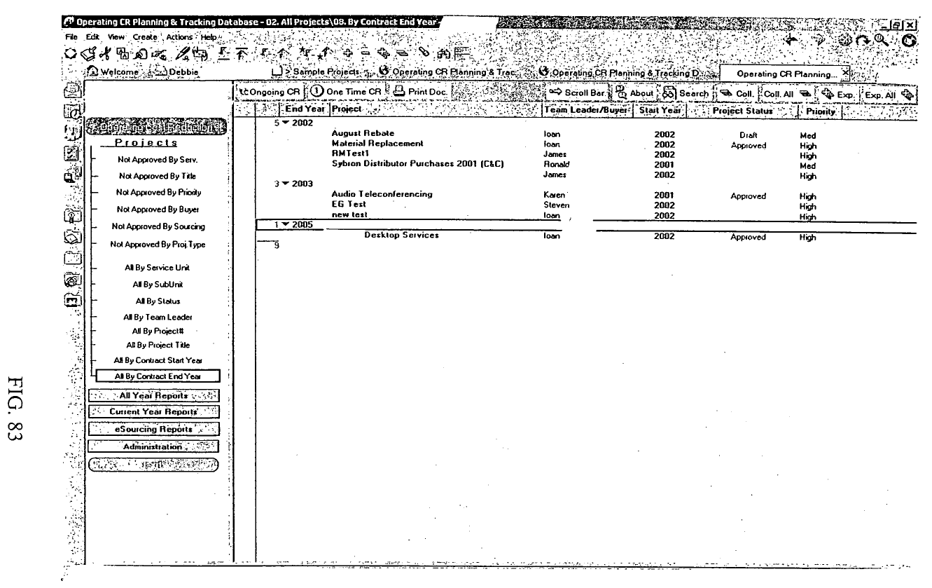

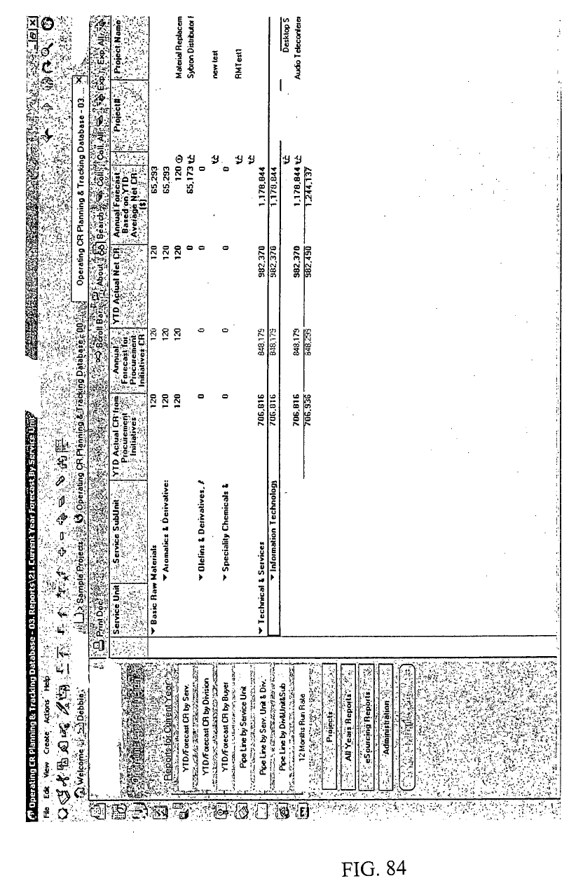

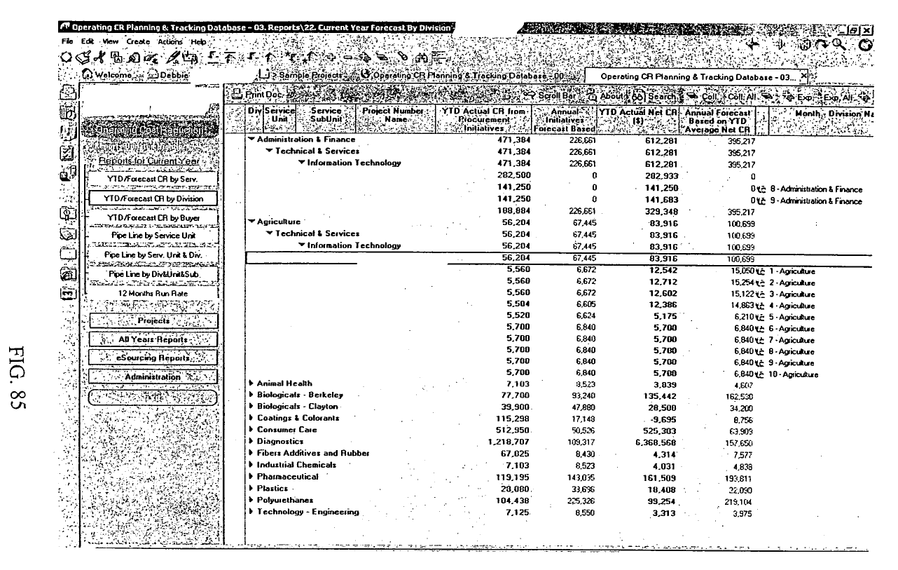

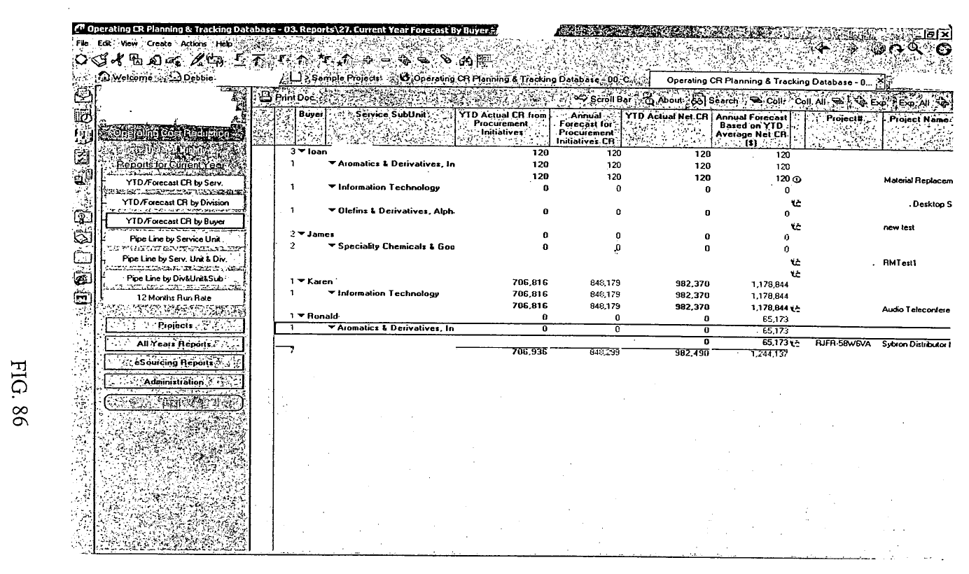

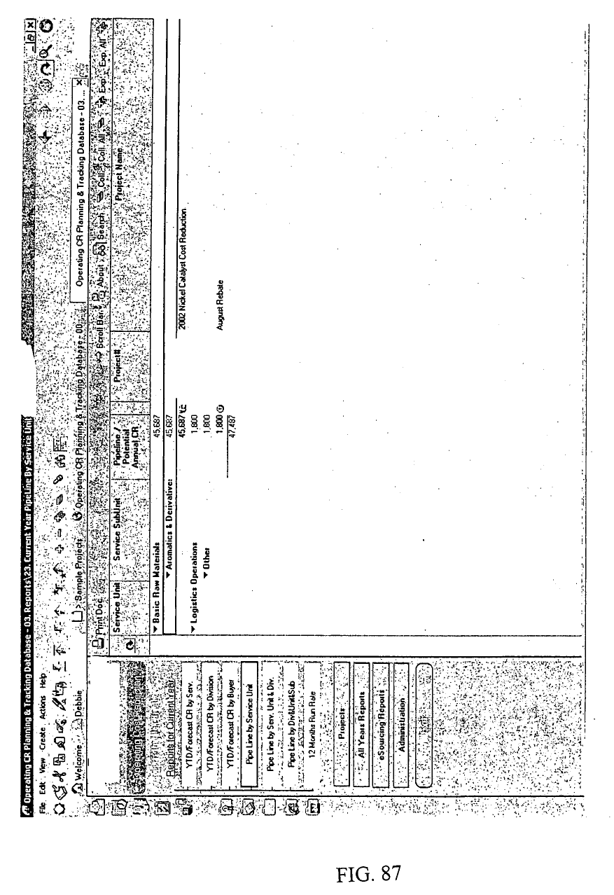

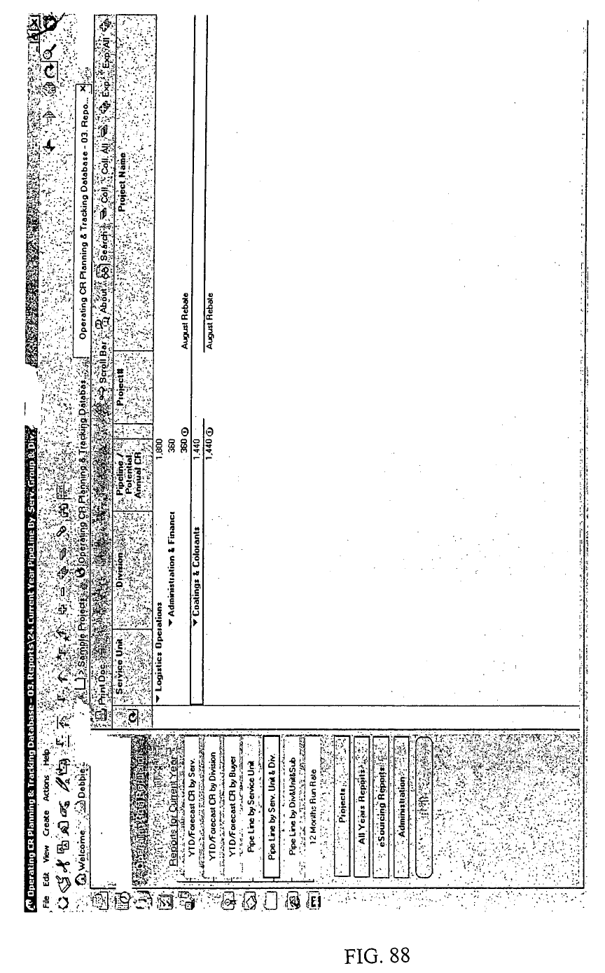

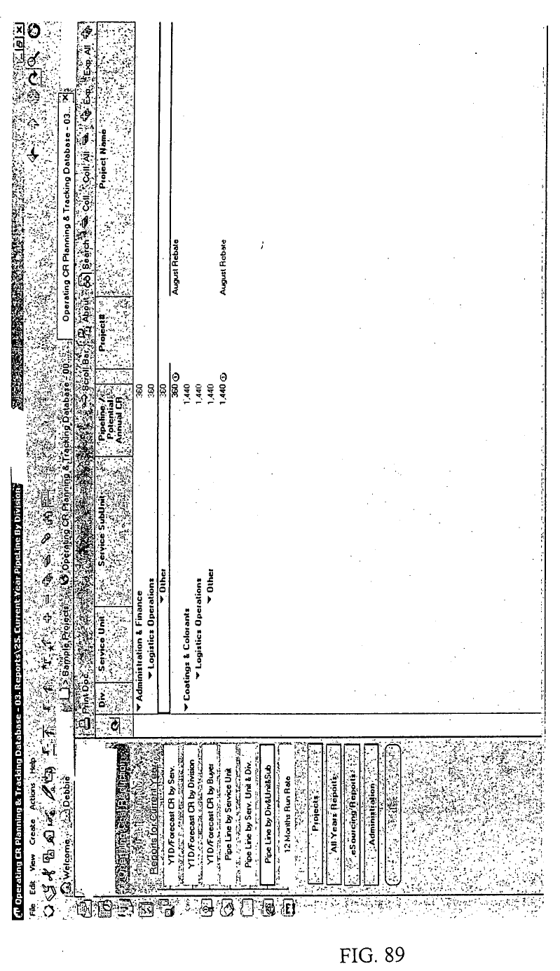

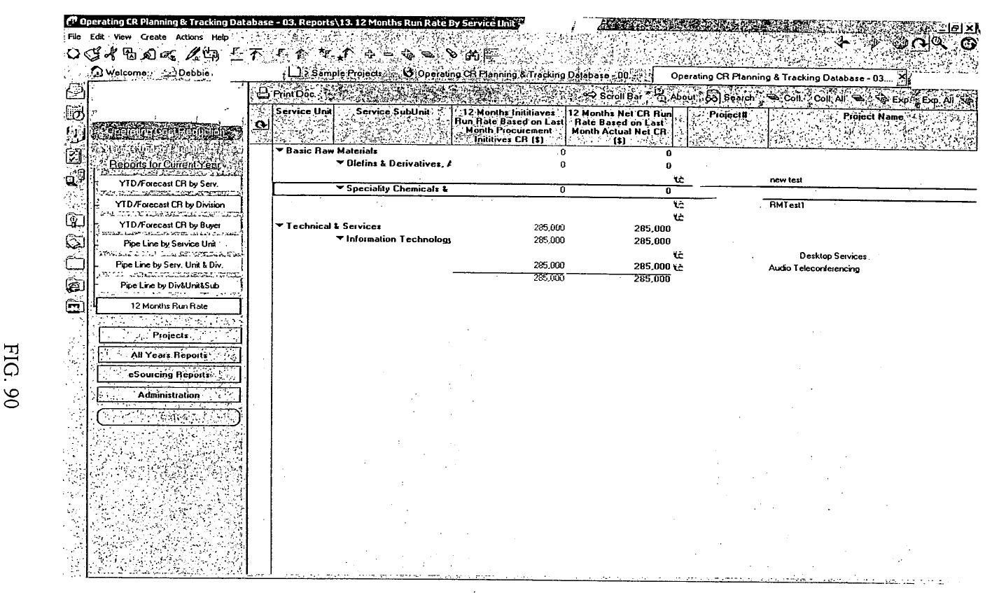

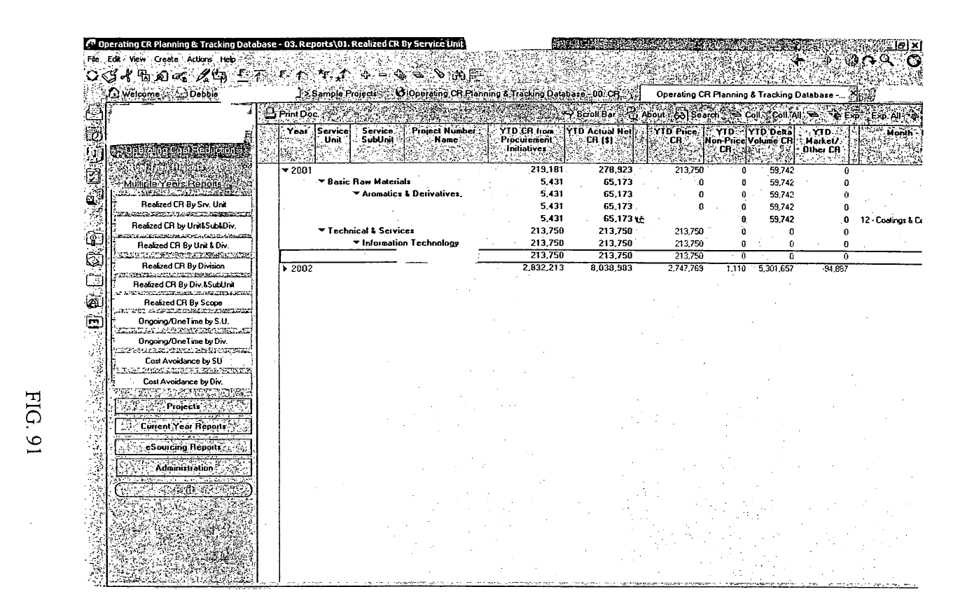

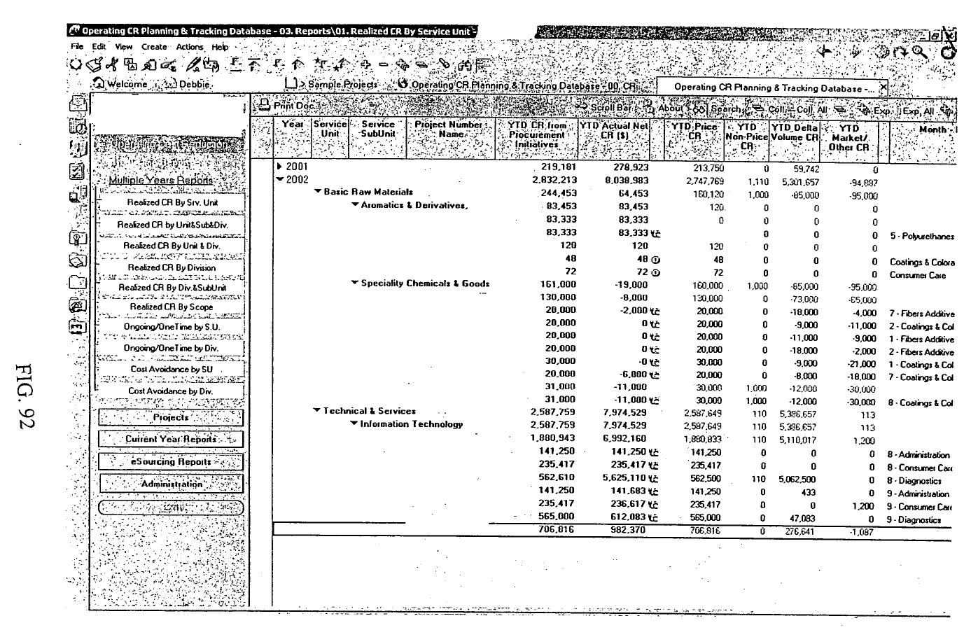

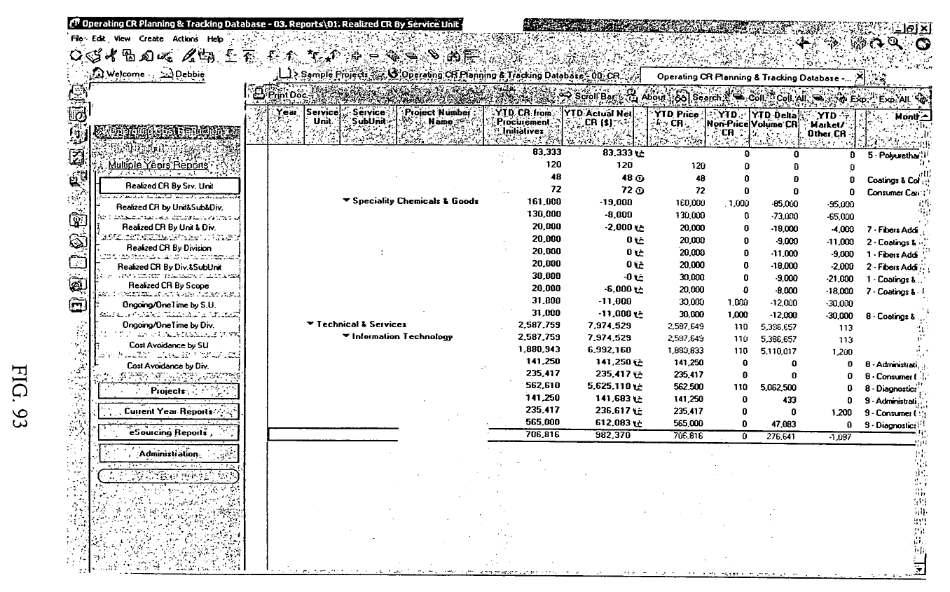

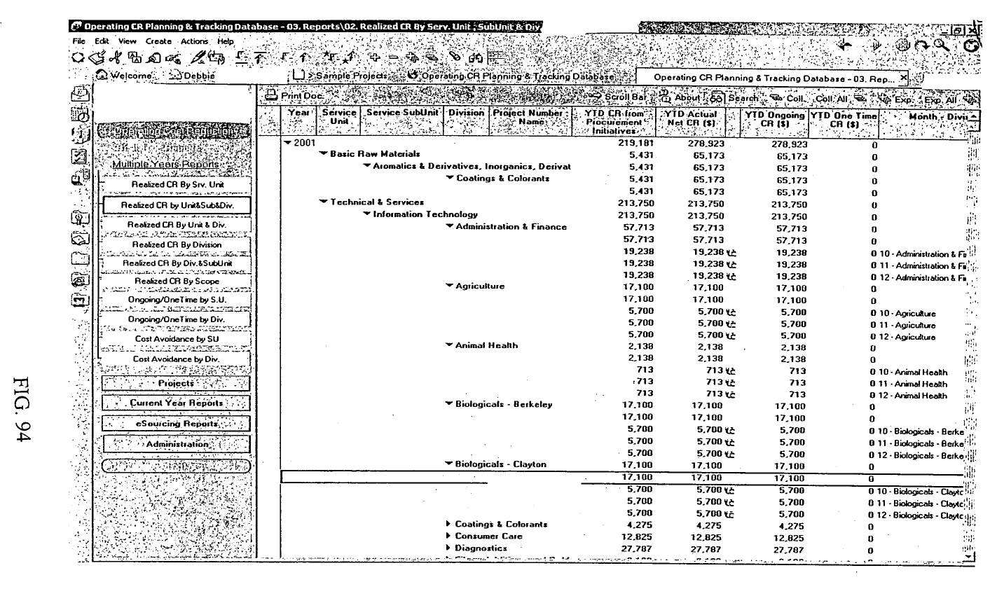

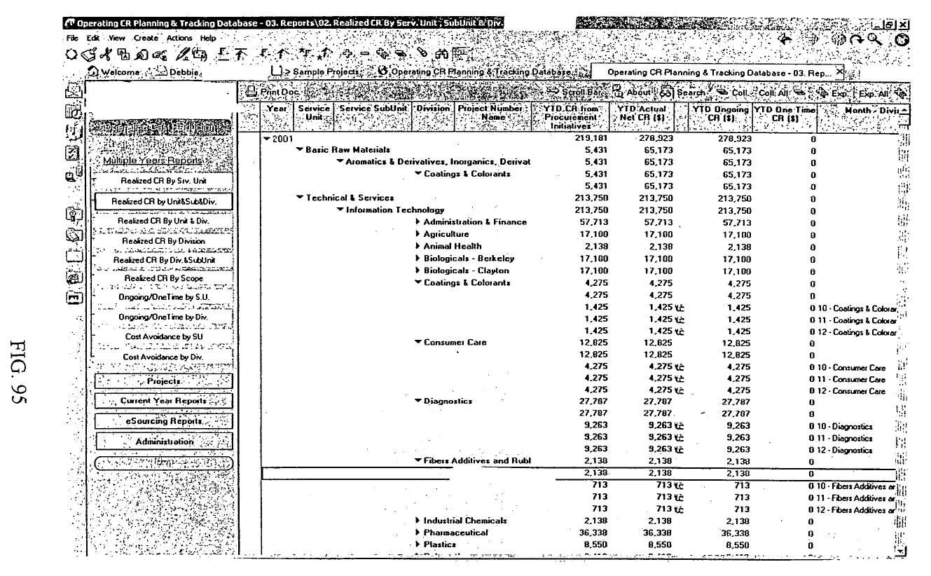

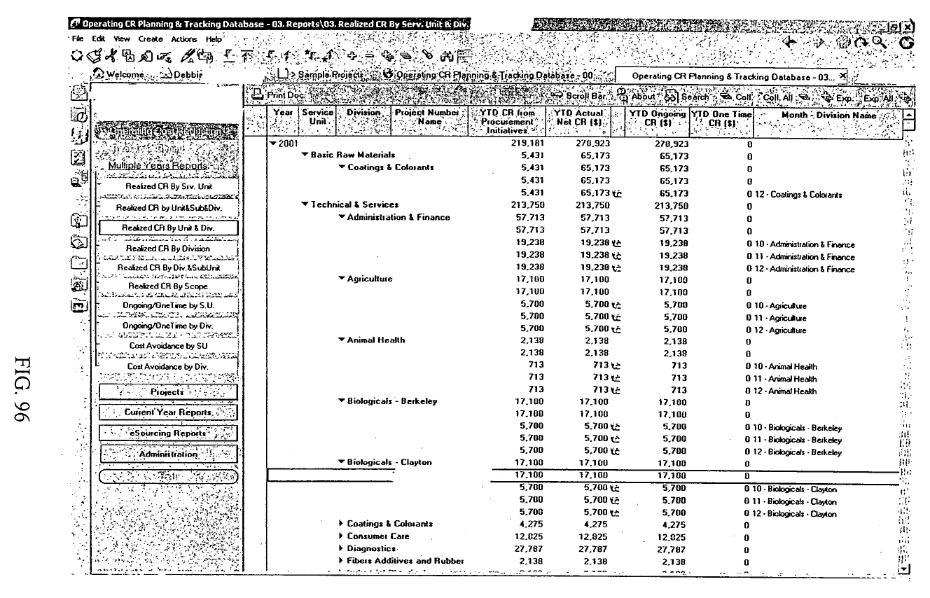

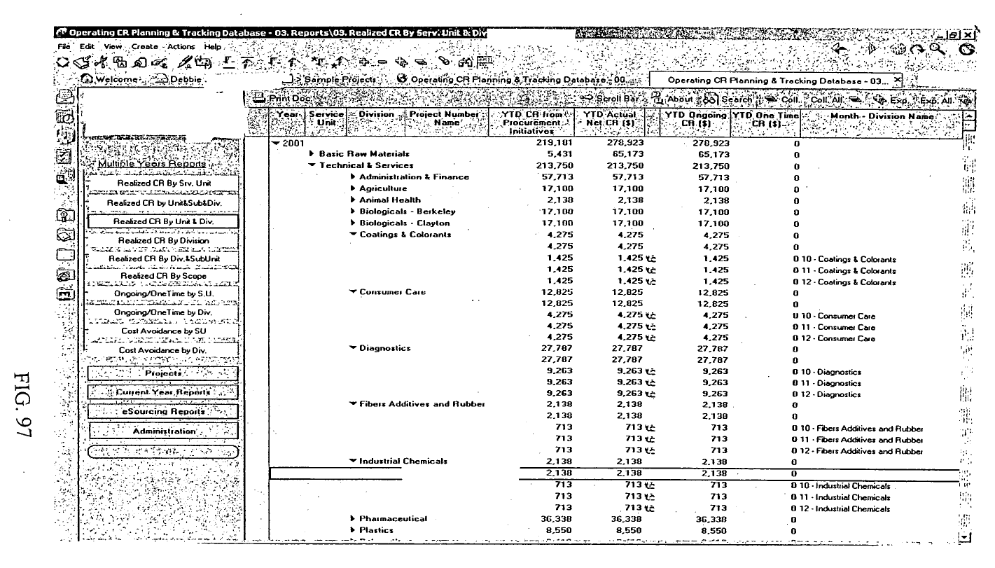

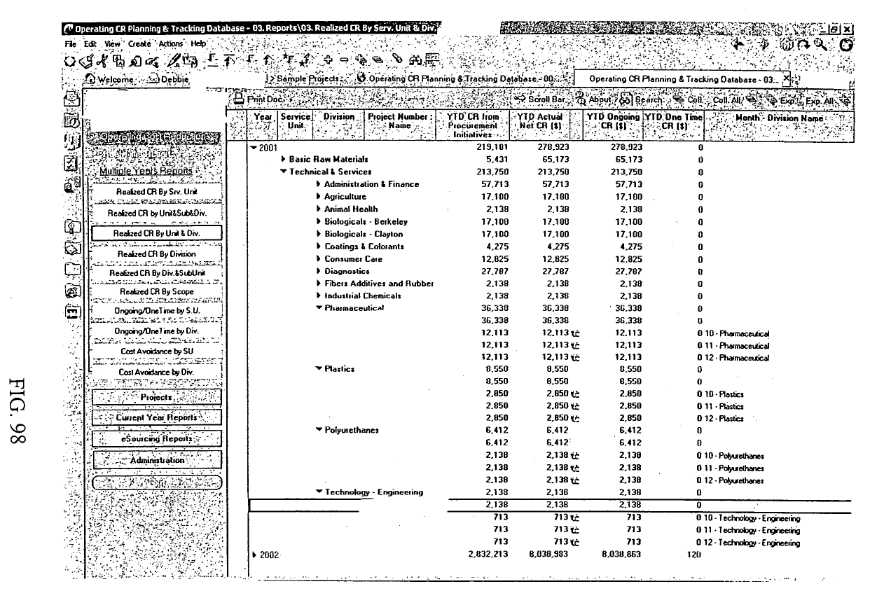

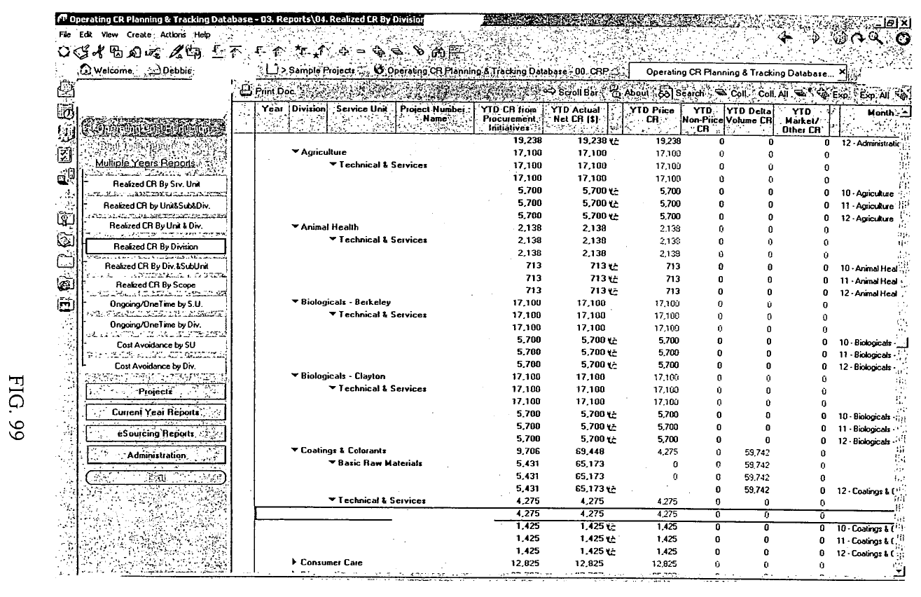

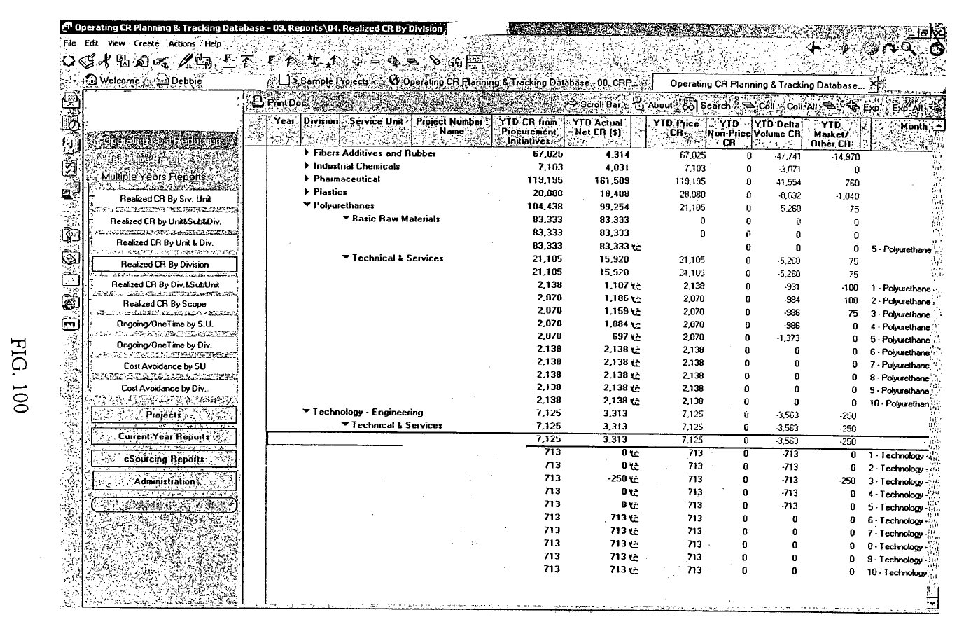

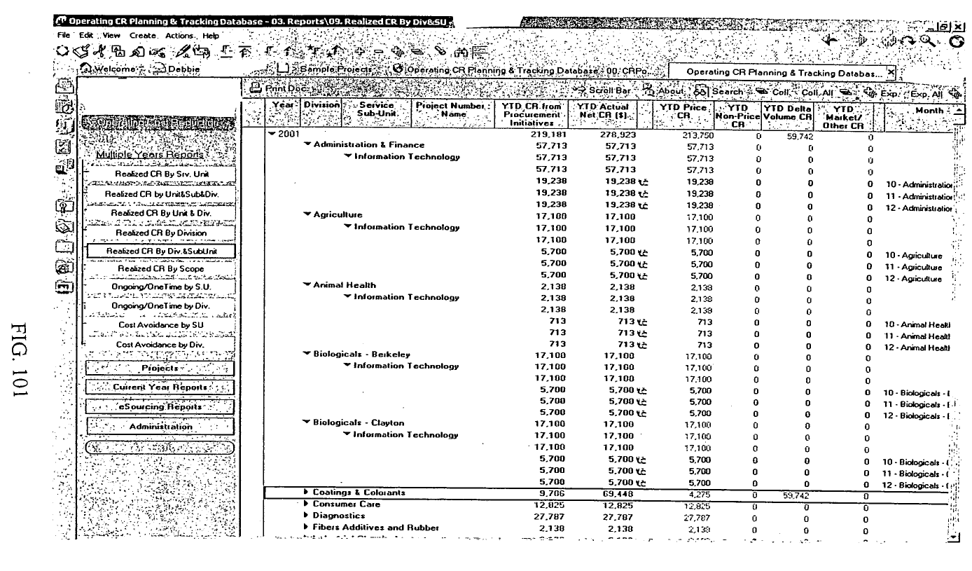

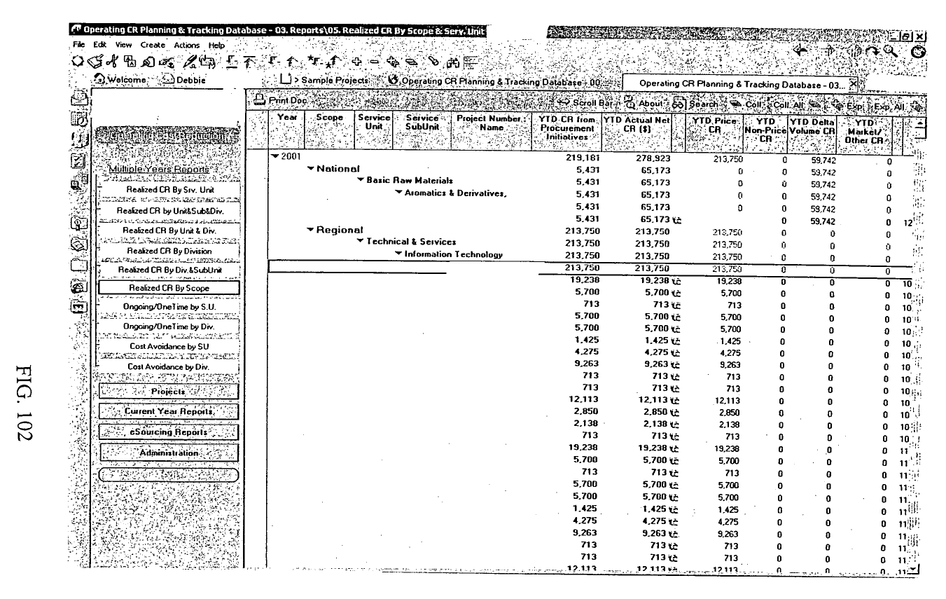

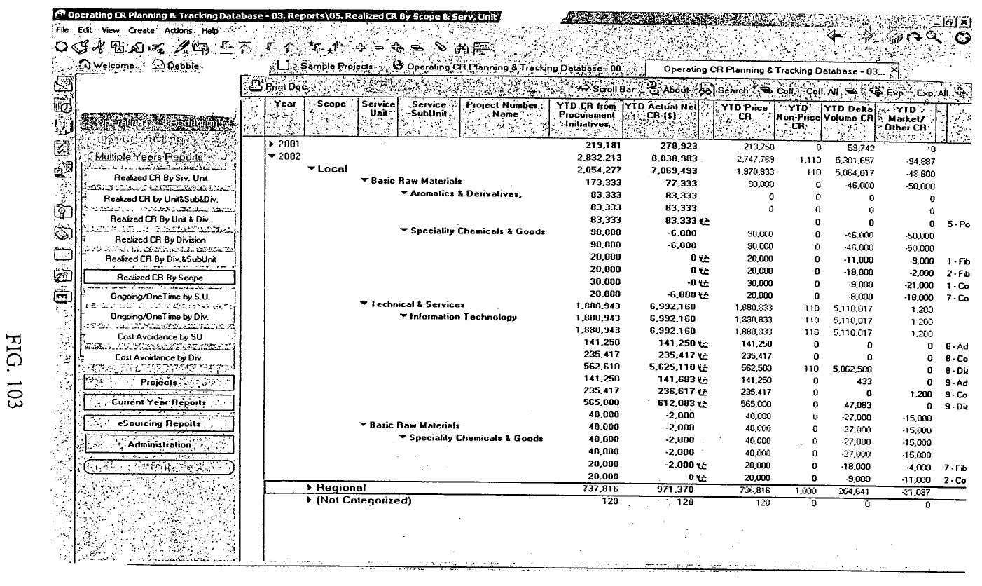

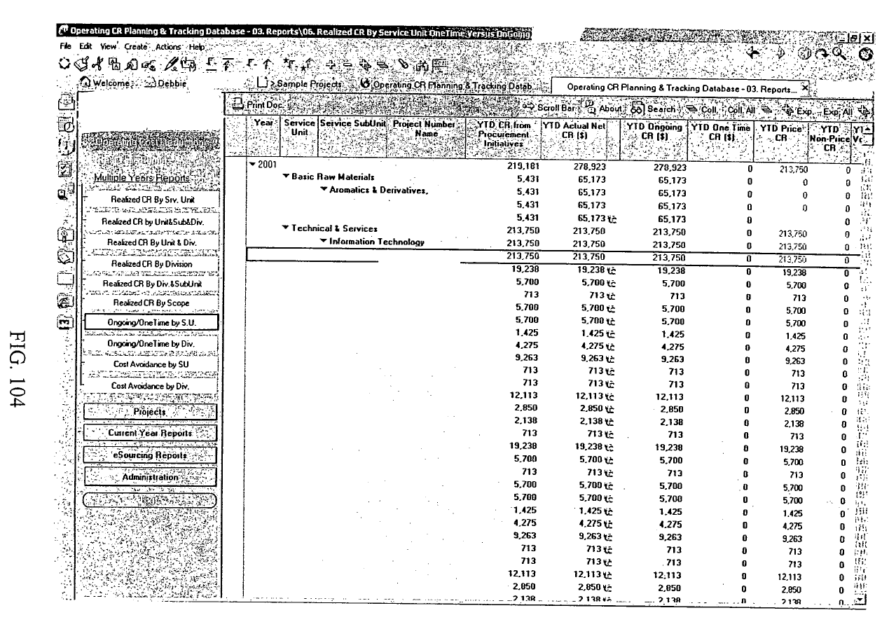

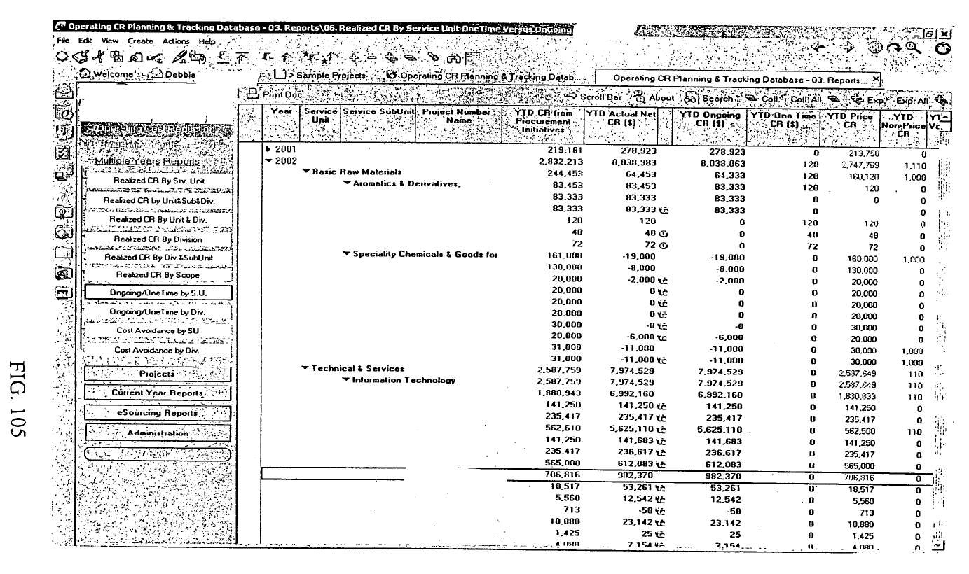

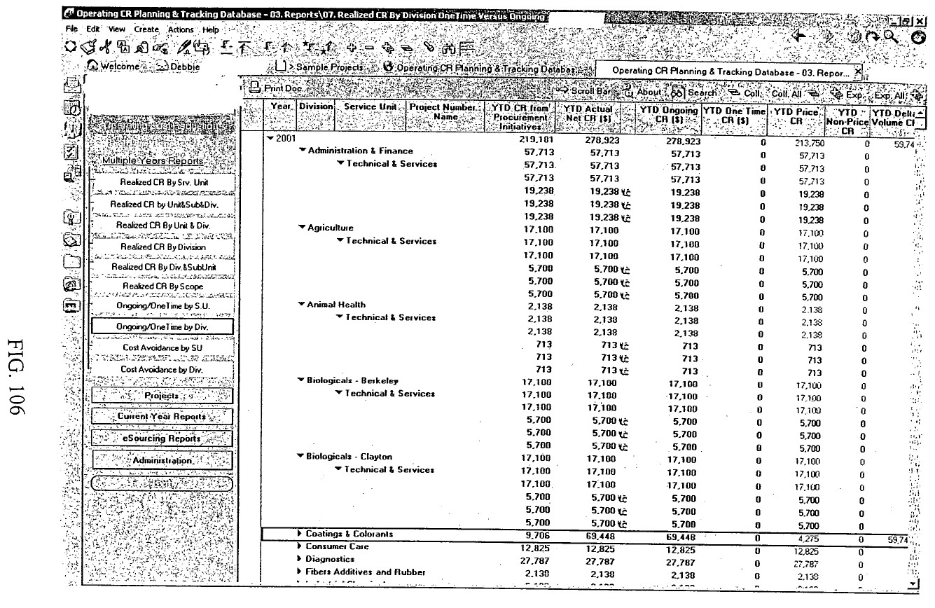

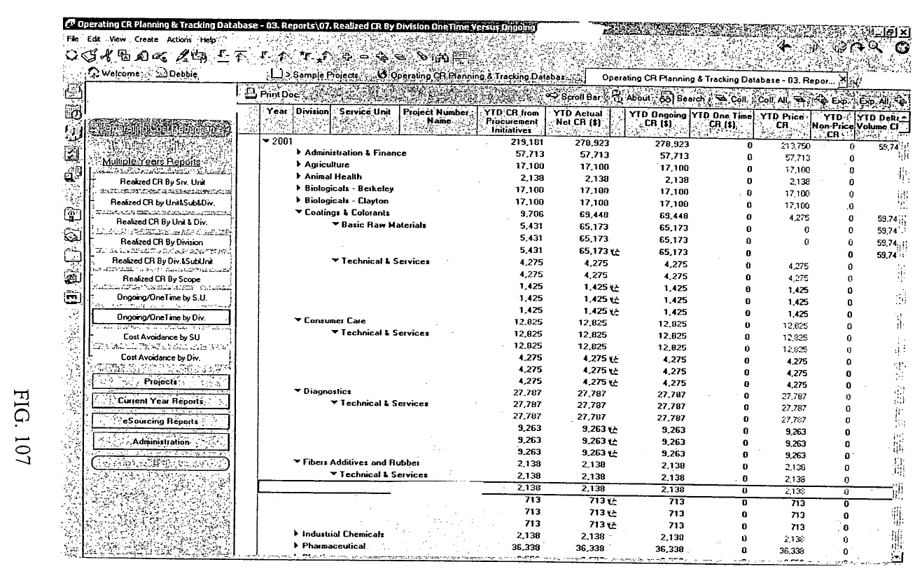

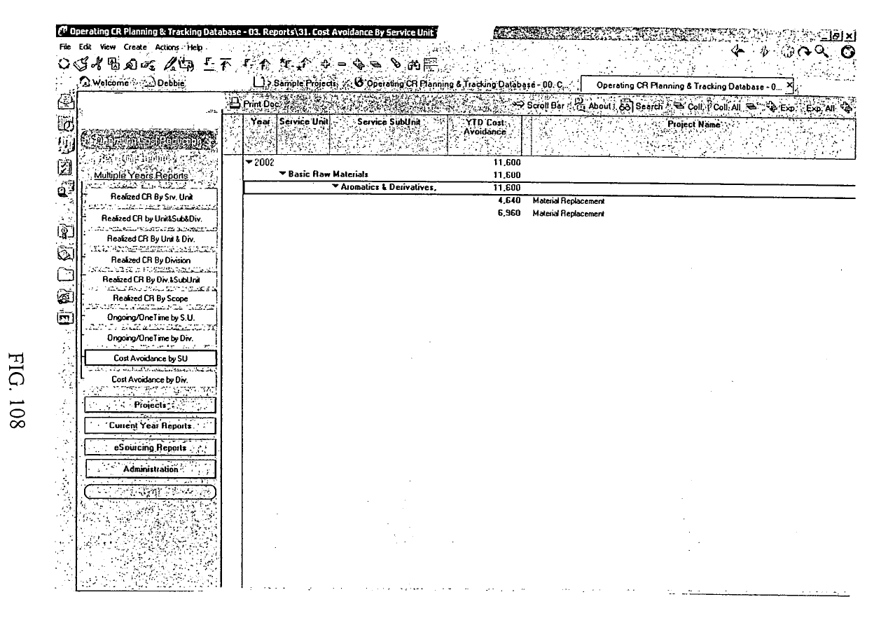

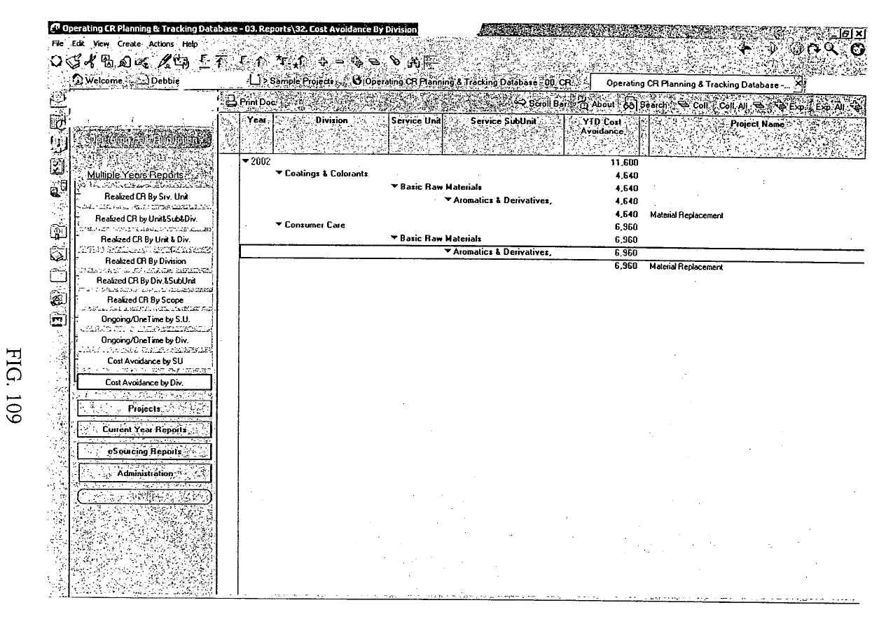

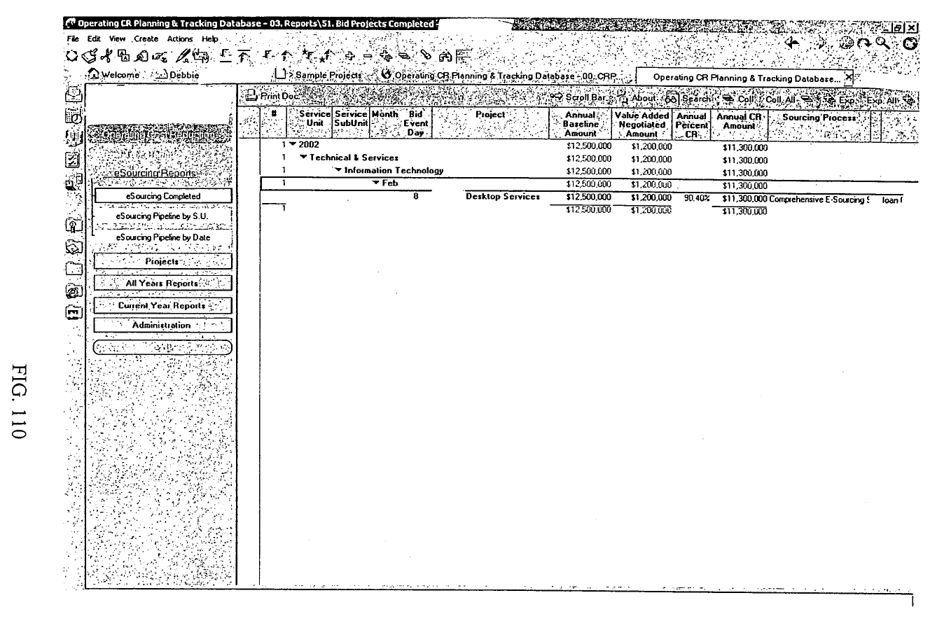

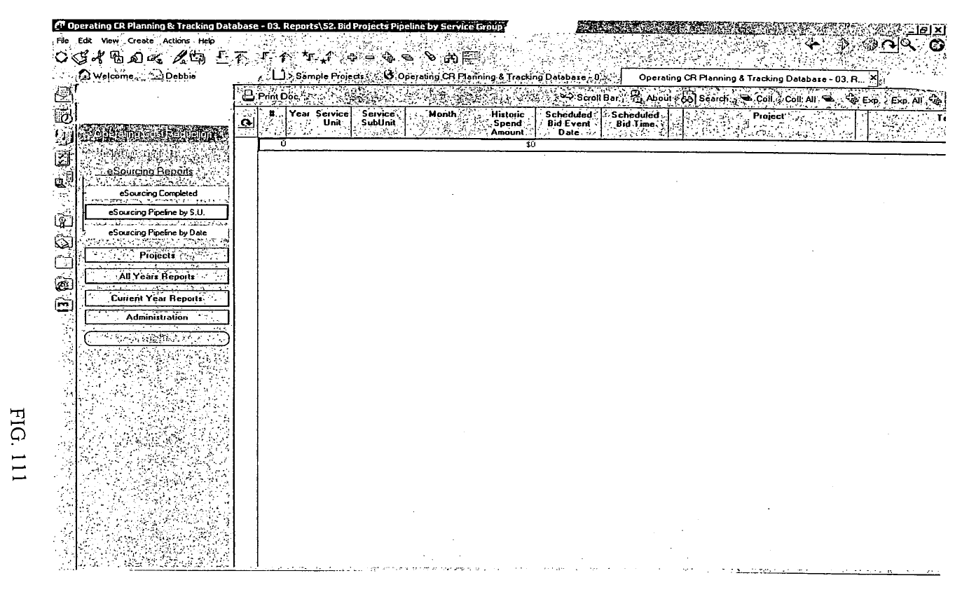

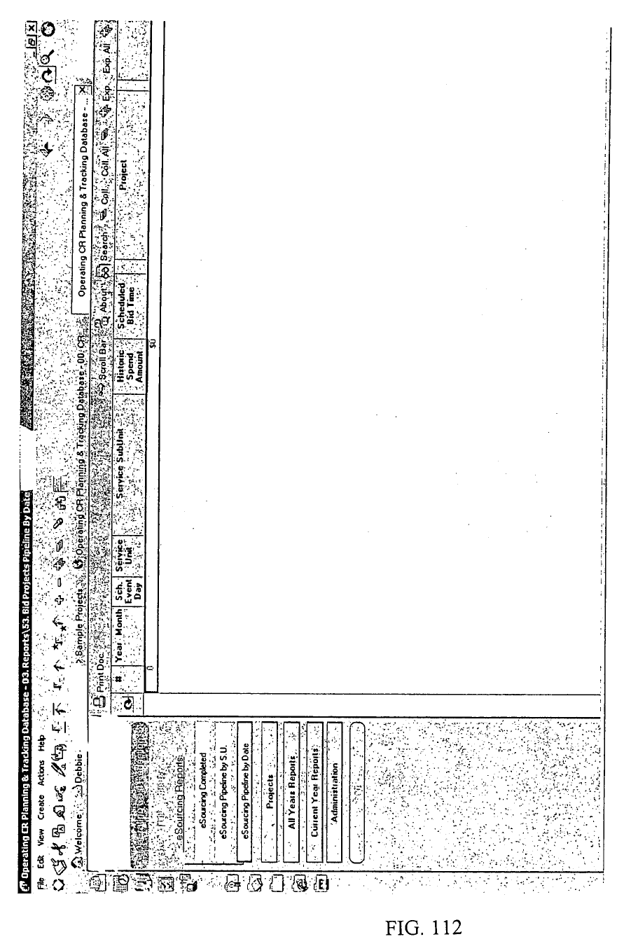

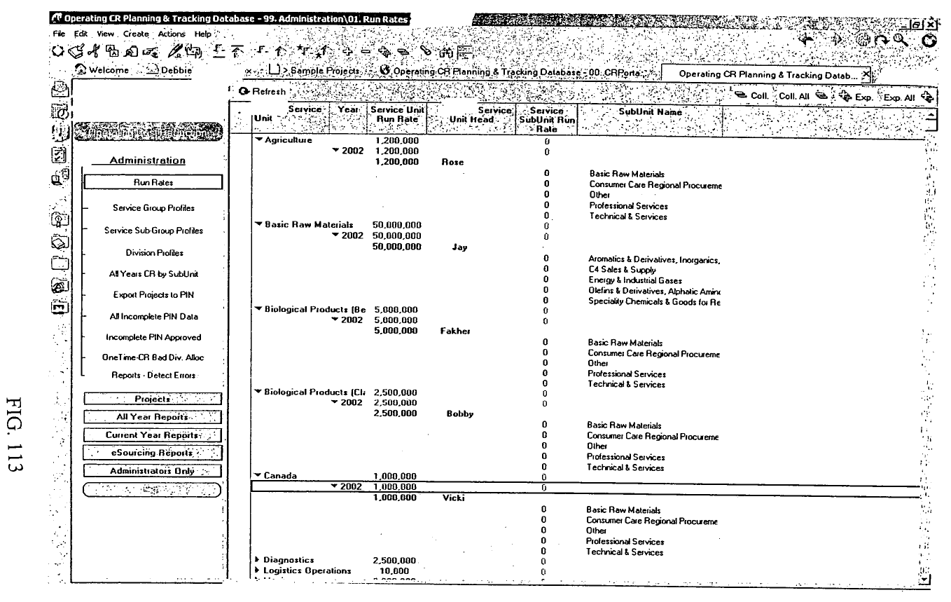

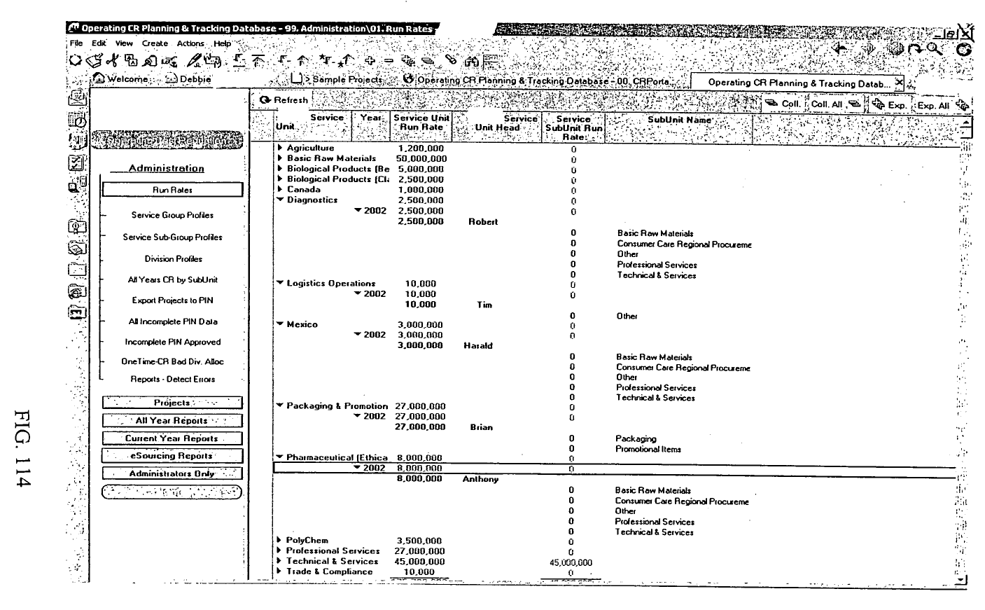

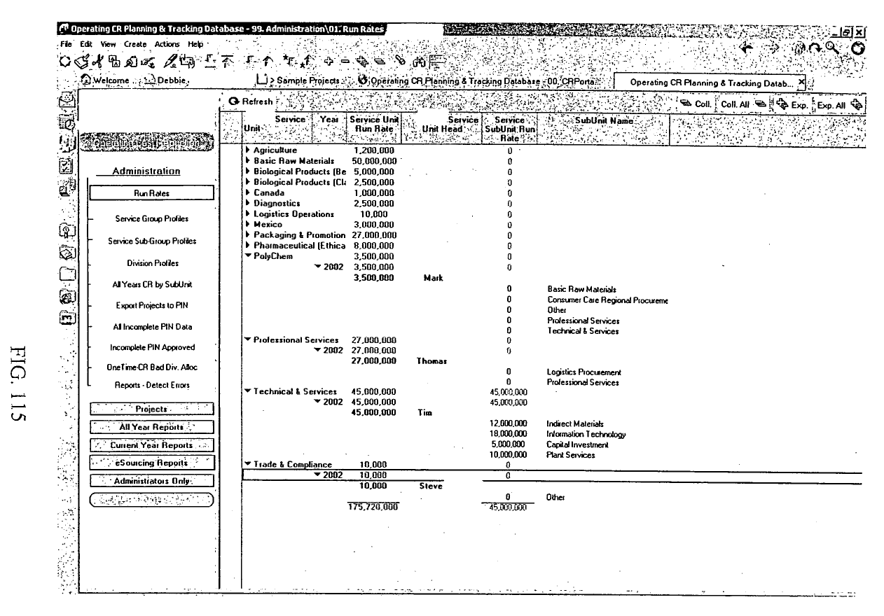

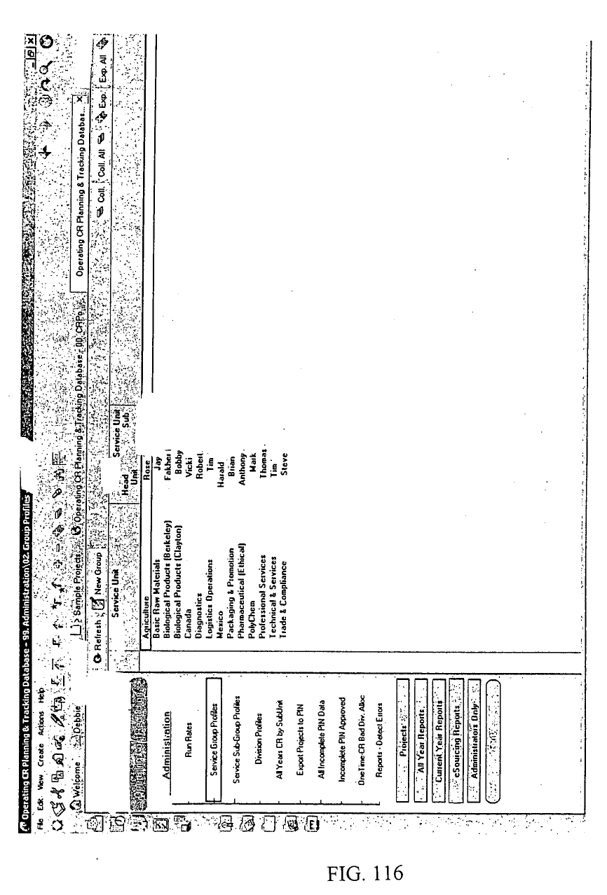

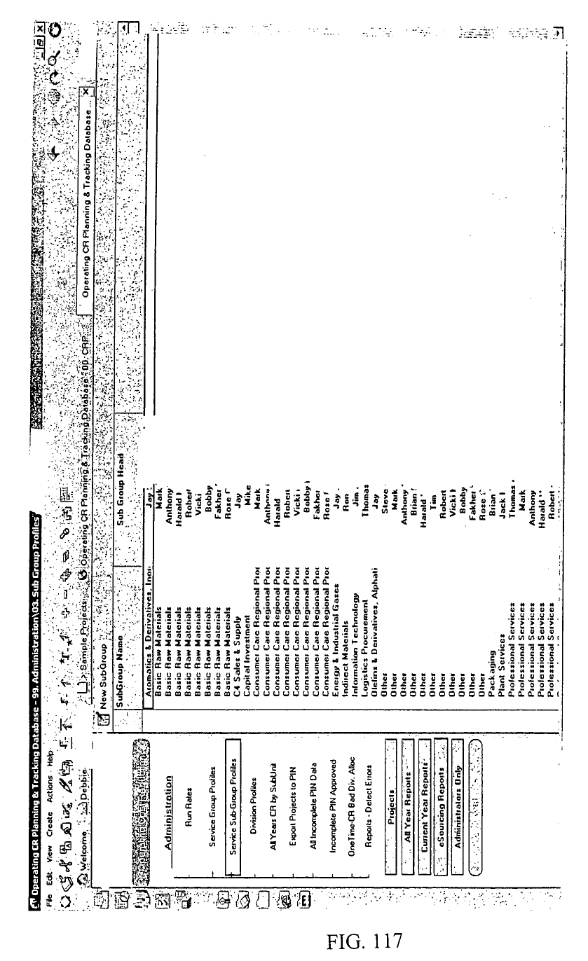

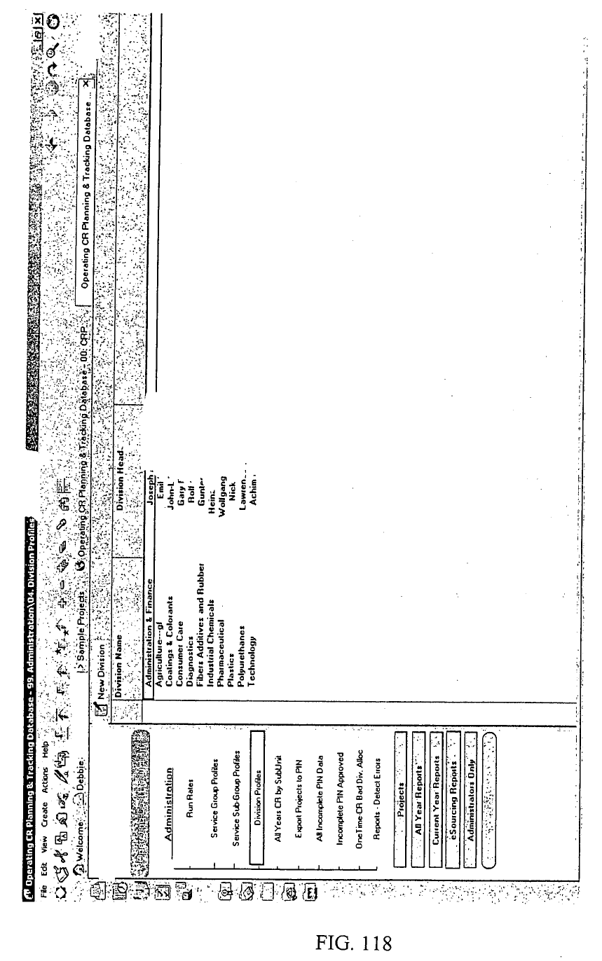

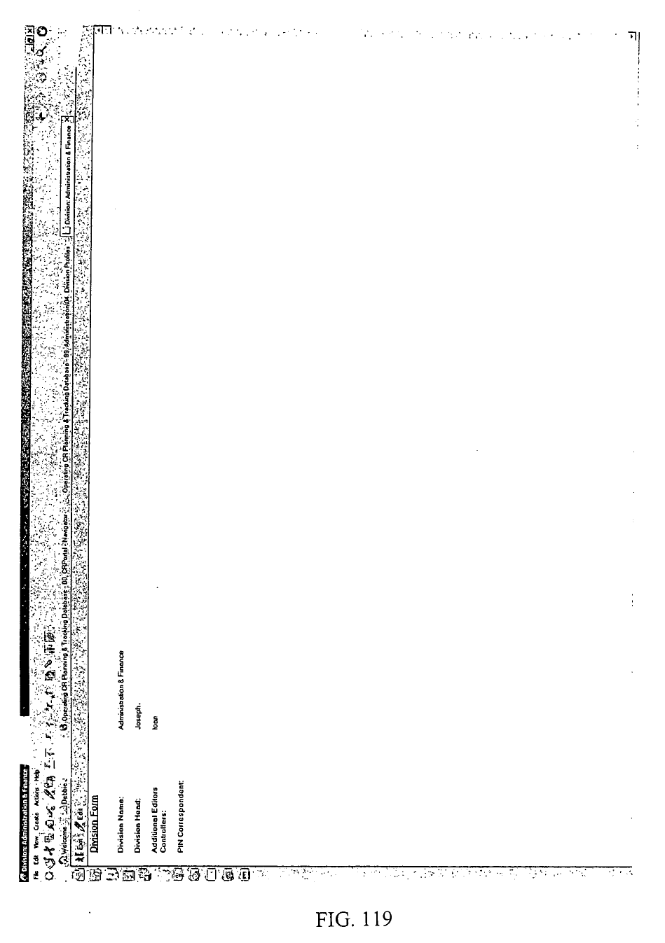

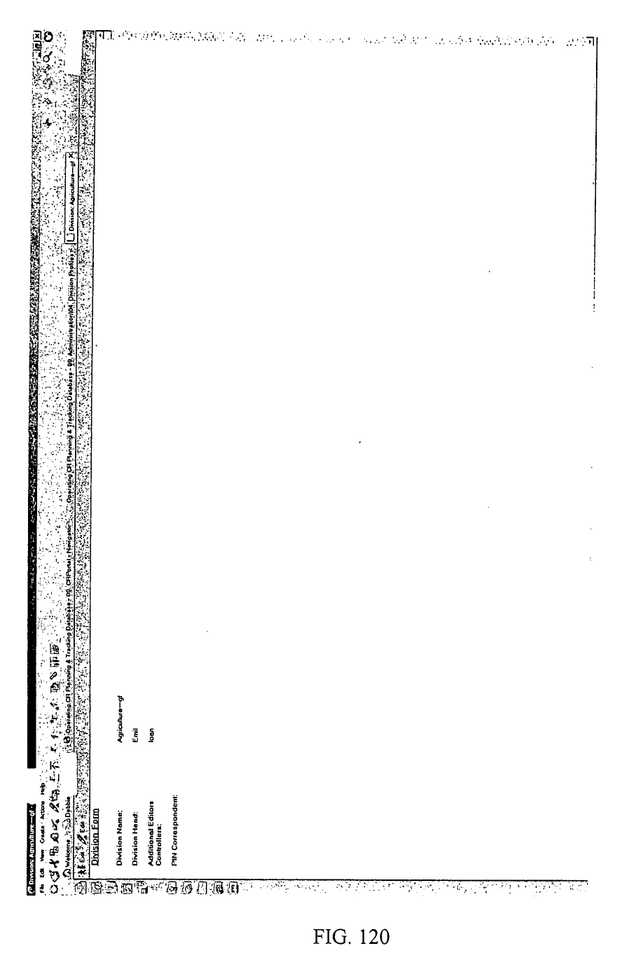

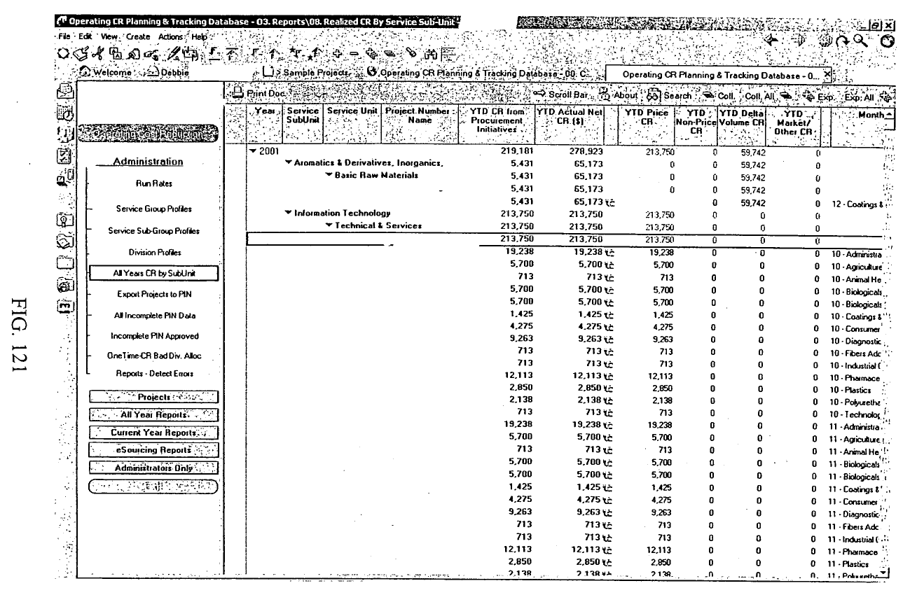

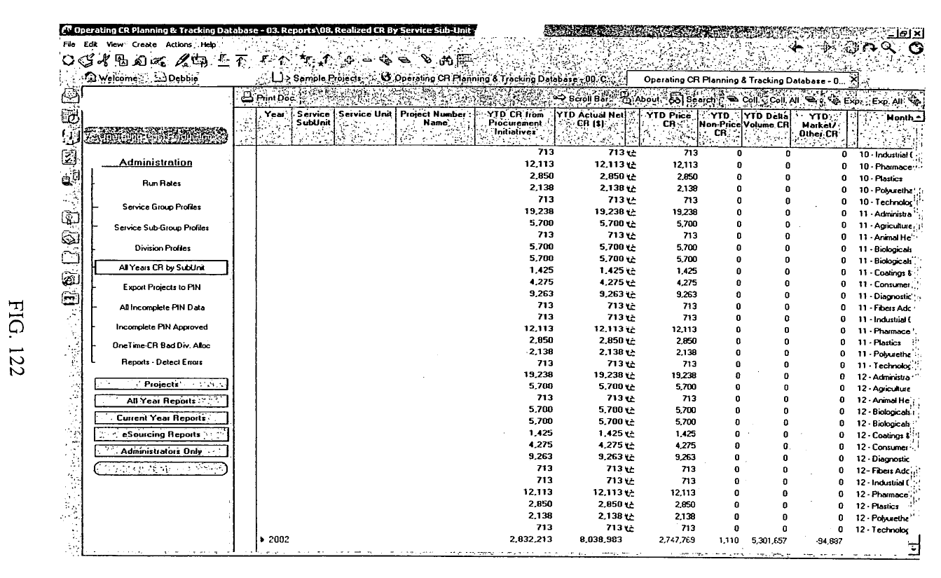

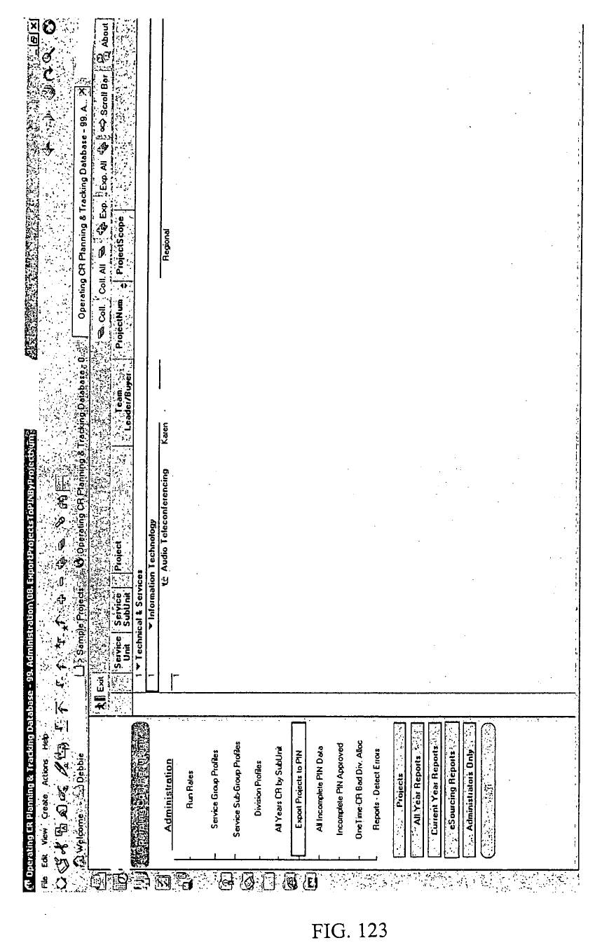

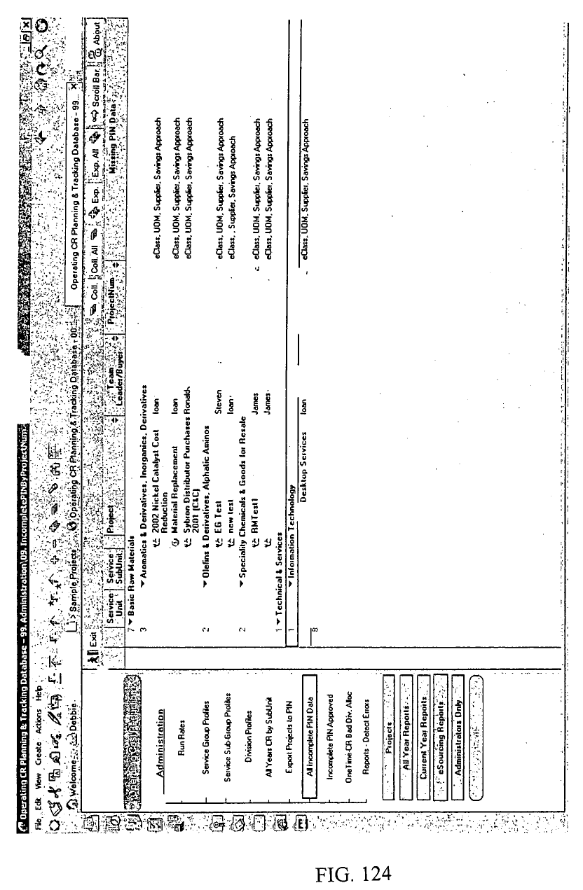

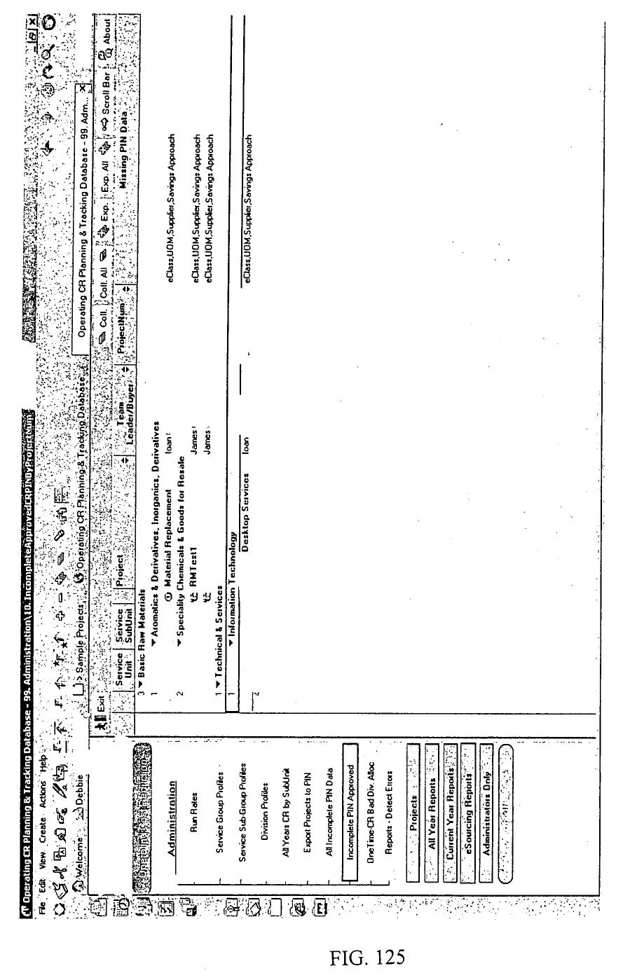

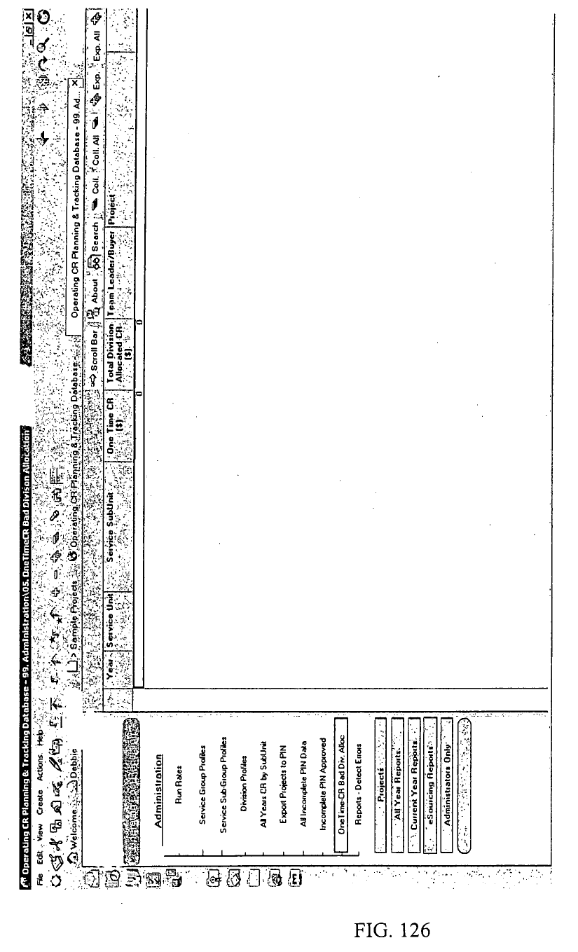

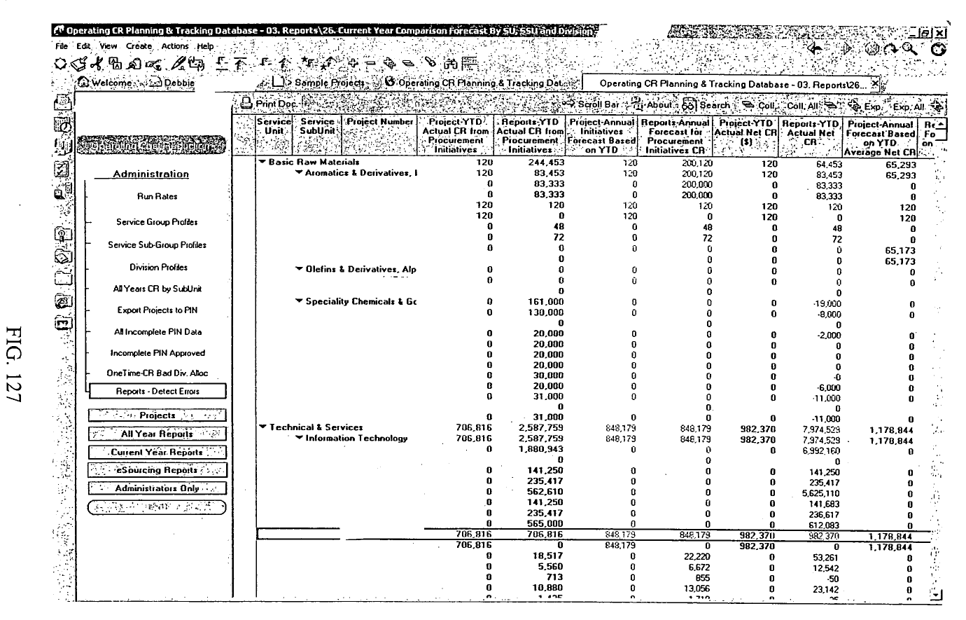

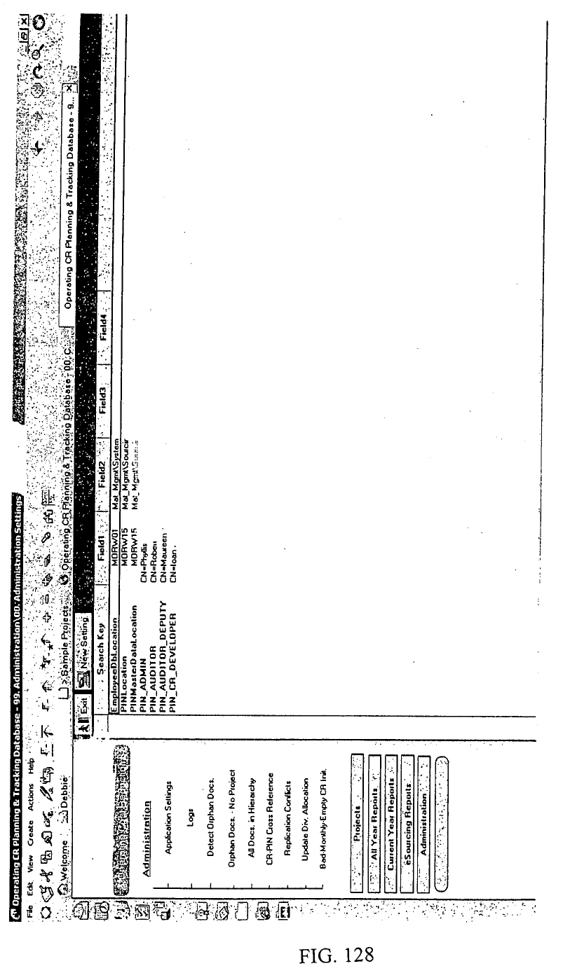

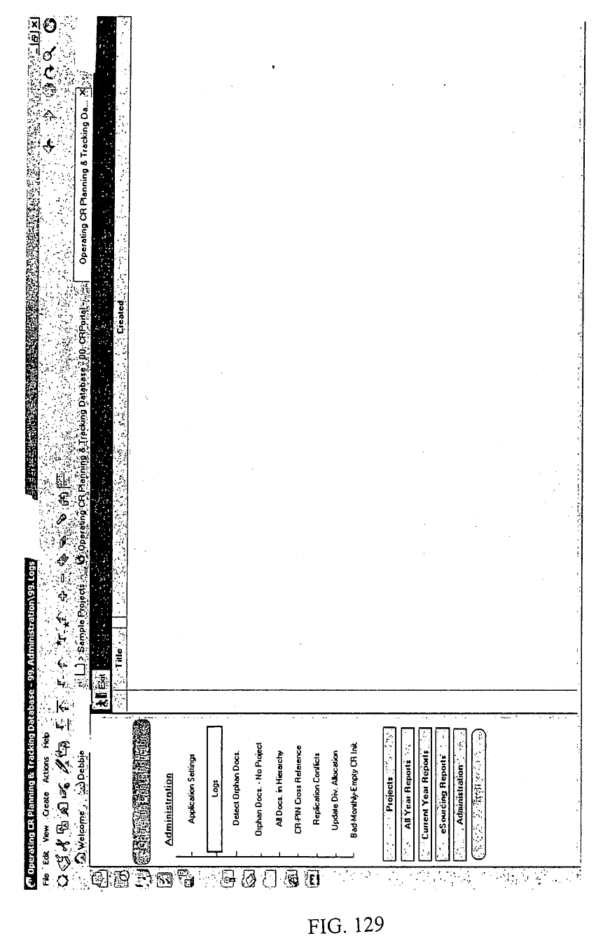

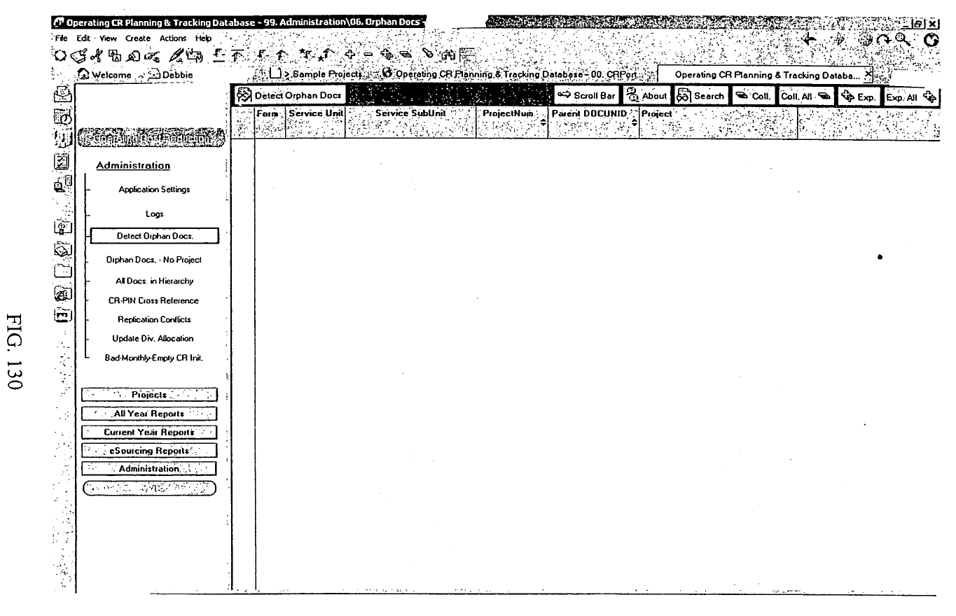

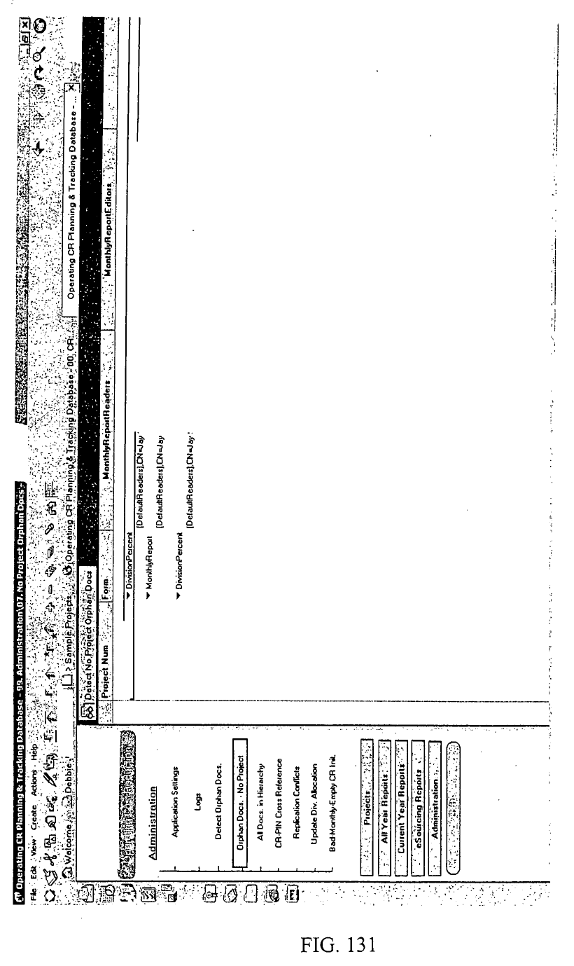

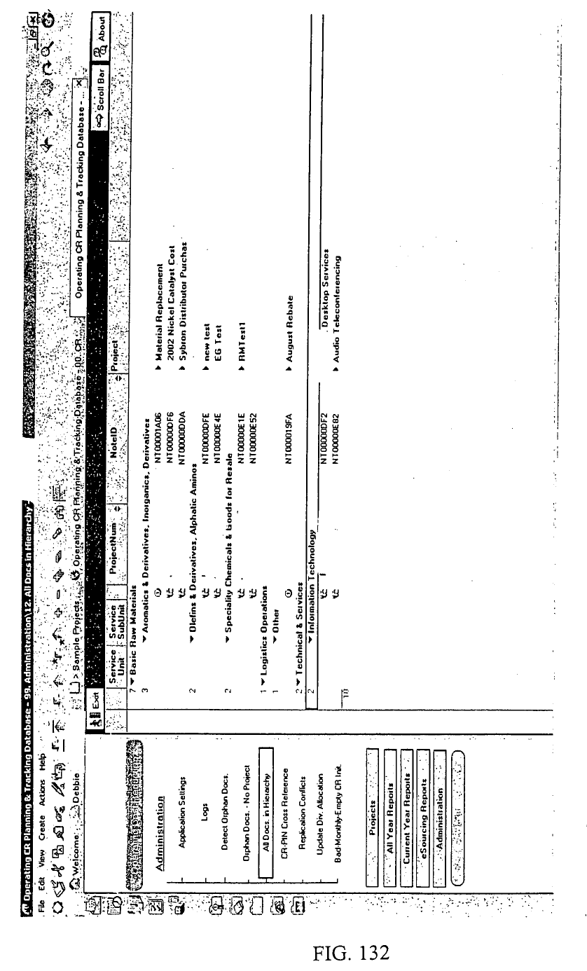

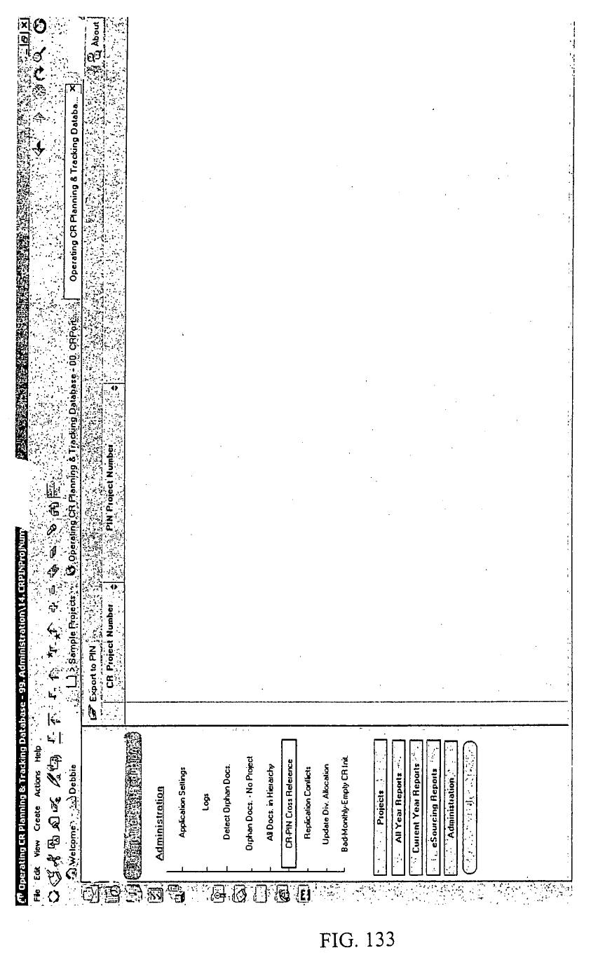

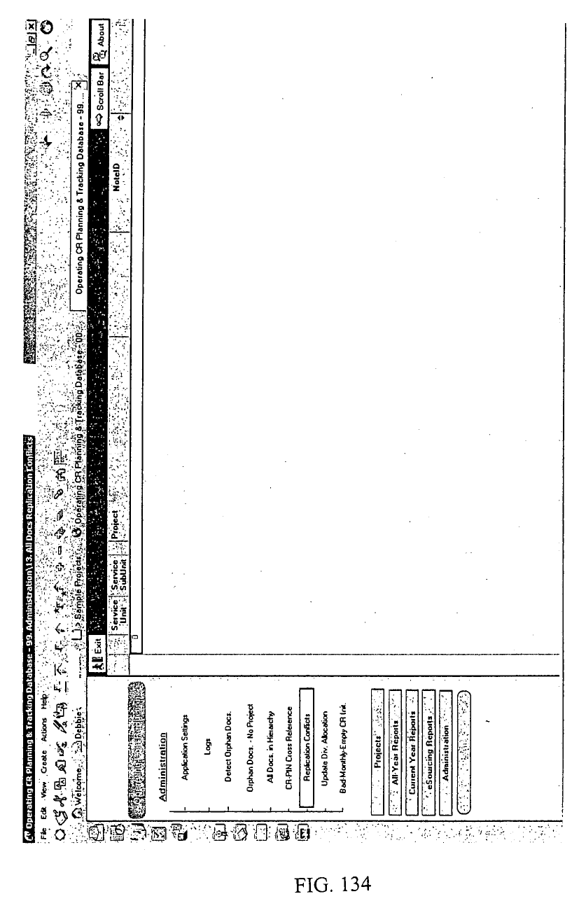

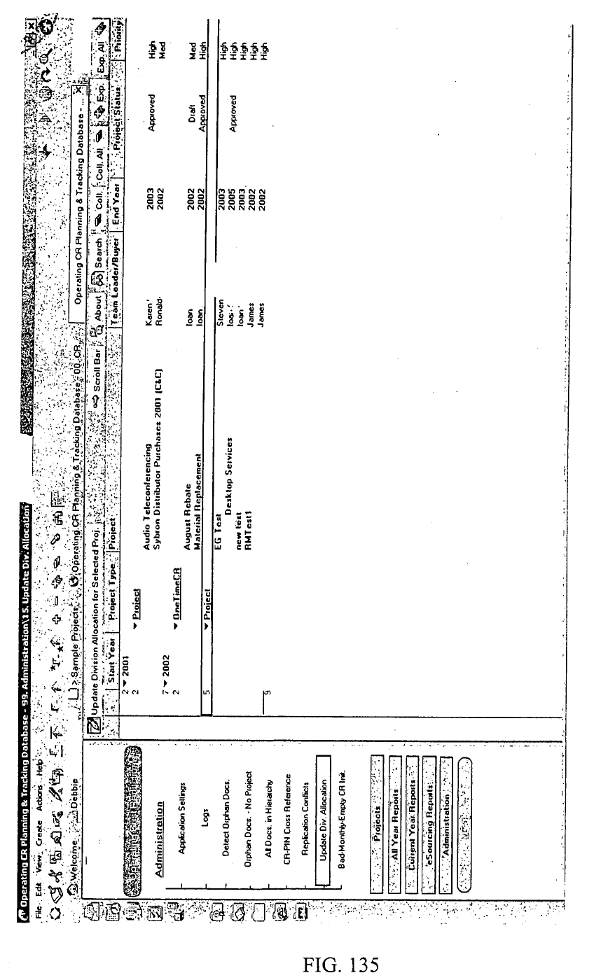

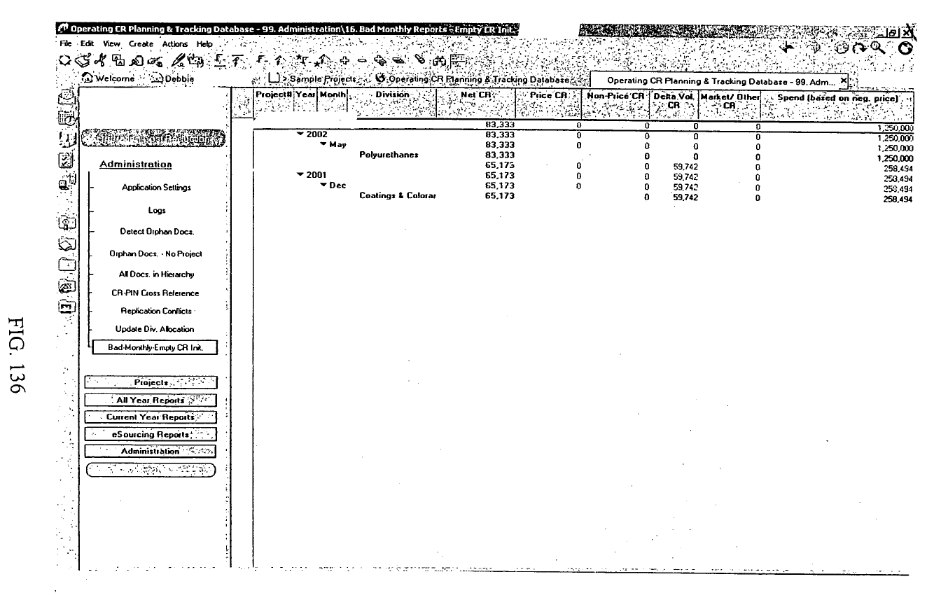

An example of the method according to the present invention is presented below, demonstrating the functionality and benefits resulting from the computer-implemented method of the present invention. The screen shots of this example embodiment are illustrated in FIGS. 3-136.

As seen in FIG. 3, the user is allowed to select from three cost reduction initiatives, including operating cost reduction, capital cost reduction and asset recovery. In this example, the user selects operating cost reduction and is brought to a project screen. (See FIG. 4). From this screen, the user can select “approved” or “unapproved” projects. These approved and unapproved projects are sorted, and, in this example, the unapproved projects are sorted by service unit, title, priority, buyer, sourcing or project type. Similarly, the approved projects are sorted by service unit, sub-unit, status, team leader, project identification, project title, contract start year and contract end year.

As seen in FIG. 4, this example includes three projects “not approved” and sorted by service unit, in this case basic raw materials and logistics operations. There are three unapproved projects in basic raw materials and one unapproved project in logistics operations.

As seen in the toolbar, the projects may be labeled as an ongoing cost reduction or a one-time cost reduction; the projects may be scrolled through; information about the projects can be listed; the projects can be searched and the various levels can be collapsed or expanded.

As seen in FIG. 5, if the basic raw materials unapproved projects are selected or expanded, the service sub-units are listed, in this case aromatics & derivatives, inorganics, derivatives and olefins & derivatives, alphatic aminos. Underneath each service sub-unit is an identification of whether the project is an ongoing cost reduction initiative or a one-time cost reduction initiative, together with the project title, team leader and/or buyer and sourcing status. The sourcing status indicates recurrent status of the project. Similarly, the logistics operations service unit, having one project thereunder, has been expanded.

In this example, the user selects the project labeled “2002 Nickel Catalyst Cost Reduction,” which moves the user to the screen displayed in FIG. 6. This project-specific screen provides a variety of input and modification functionality. The project status is draft and the project description is indicated underneath the title. This screen is broken down into a series of tabs, and the first tab is project team information. The project team information includes project type, priority, scope of contract, internal project number, sourcing process status, procurement category, sourcing process used, resourcing link, project team and access rights, NAFTA service unit, NAFTA service sub-unit, sponsor, team leader/buyer, procurement team members, non-procurement team members, employees with read-all access and primary stakeholders.

As seen in FIG. 7, the project type can be a bid project or a non-bid project. As shown in the pop-up definitional box in FIG. 8, a bid project is defined as a cost reduction project that follows the typical bidding process with specified project milestones, and a non-bid project is defined as a cost reduction project that is typically not bid and does not follow traditional bidding process. FIG. 9 demonstrates that the priority can be set for high, medium or low. As seen in FIG. 10, the scope of contract deals with the geographic, as opposed to the temporal, scope of the negotiated contract. The scope of contract can be defined as local, regional or global. The internal project number is a specified and unique identification for the project.

As seen in FIG. 11, the sourcing process status indicates at what stage the project is in and includes at least whether the data is in a collection stage, the negotiation is in progress, implementation has started, the contract is being managed or the project is completed.

The procurement category can be direct (raw) materials, indirect materials, logistics or services. (See FIG. 12). Further, the sourcing process used can be traditional, comprehensive e-sourcing service or desktop e-negotiation service. (See FIG. 13). If the project team and access rights section is selected, a comprehensive list of the user or corporate employees and certain employee information is displayed, or linked to another database. This allows the user to view information regarding the various procurement team members or others involved in the project. (See FIG. 14).

The NAFTA service unit allows the users to select the various service units of the user or corporate entity. In this example, a pop-up box allows the user to select from various service units, including agriculture, basic raw materials, biological products, Canada, diagnostics, etc. (See FIG. 15). Similarly, as seen in FIG. 16, the service sub-unit can be selected, and, in this case, includes aromatics and derivatives, inorganics, derivatives, C4 sales and supply, energy and industrial gases, olefins and derivatives, alphatic aminos, specialty chemicals and goods for resale.

The cost reduction project can identify a sponsor, and this sponsor can be selected through various links to other databases currently available through the knowledge management data warehouse 30. For example, as seen in FIG. 17, a person's address book can be linked to and names selected for a sponsor. These names can be added, opened for information, removed, and otherwise organized. This similar linking and selection ability occurs when selecting the team leader/buyer, the procurement team members, the non-procurement team members and the primary stakeholders.

A key aspect of the present invention is illustrated in FIG. 18. This aspect occurs under the data collection tab. Simply, the user clicks on the attachments button and is linked to the knowledge management data warehouse 30 and the various data fields 32 residing on documents contained in the knowledge management data warehouse 30. For example, the user can attach scope-of-work documents, specifications, contracts, bid results, spending documents, supply or usage reports, etc. Further, these documents can be in the form of files, documents, spreadsheets, slides, text, snapshots, screen shots, media files, pictures, etc. The user must only define the appropriate documents and attach them in the data collection tab, which provides this information and these data fields 32 to the control mechanism 26.

As seen in FIG. 19, the project schedule and diary tab include scheduled and actual completion dates for various stages. This tab is used to develop an overall project plan and as the project progresses, actual dates should be entered and project plan documents attached. In this example, the scheduled and actual dates can be completed for the project start date, date of collection, suppliers identified, kick-off meeting, suppliers qualified, internal request for quote review, issued request for quote, bids received/bid event, day and time, post bid analysis, award decision, contract start date, contract end date, implementation start date, implementation end date, cost reduction start date and comments/attachments. The scheduled and actual dates (or times) can be entered via a drop-down menu that pulls up a calendar. (See FIG. 20). In a preferred embodiment, the contract start and end dates, as well as the cost reduction start date, can only be modified through a pop-up box. This allows the system 10 to track these dates once a project has been approved. Once a project has been approved by a manager, the changes to these important dates are logged in a History section at the bottom of this tab.

As seen in FIG. 21, the cost reduction analysis is used to provide the critical baseline reference data fields 16, negotiated procurement transaction data fields 20, and actual procurement transaction data fields 24. Under the cost reduction analysis tab, the user can enter potential cost reduction, negotiated cost reduction and realized cost reduction. As specifically seen in FIG. 21, in this example, the potential cost reduction allows the user to capture initial project estimates, based on stakeholder meetings, market knowledge and/or best guesses. This refers to the baseline reference data fields 16 and the baseline reference data set 14. In this example, the user may enter annual identified spending amounts, annual potential cost reduction percentage, annual estimated cost reduction, and this cost reduction may be apportioned between different divisions. Further, the justification for a certain calculation may also be placed next to that calculation. The annual identified spend amount represents the best estimate of the historic spend amount or budget figure. (See FIG. 22). It is also envisioned that the fields in the potential cost reduction tab can be changed or edited by selecting an appropriate button on the screen. Once a project has been approved, this potential data cannot be changed. In addition, the division allocation cannot be changed once the project has been approved. This system also has additional automation features, such that when a buyer changes the annual amounts after the division allocation has been entered, the new amounts are re-allocated according to the division apportioned percentages. This eliminates the need to manually re-allocate the new annual cost reduction.

FIG. 23 represents the negotiated cost reduction selections or entries available under the negotiated cost reduction tab. This section is used to capture negotiated dollar amounts. As with the potential cost reduction, the negotiated cost reduction allows the calculation justifications and apportioning functionality to be assigned to various modifiable quantities. In this tab, these quantities include an annual baseline amount, a value of initial acceptable annual bid, a result of value added negotiations, annual negotiated cost reduction percentage and annual negotiated cost reduction amount. The cost reduction is apportioned between divisions by percentage and projected annual cost reduction per division. (See FIG. 23). Also, in this tab, the user may use a set unit price, and this unit data may also be modified. The base unit price, the negotiated cost reduction/unit price and the project monthly volume are all displayed and modifiable. In addition, the cost reduction can be apportioned to various divisions, and these division percentages can be added, edited or deleted. Further, the cost reduction history can be tracked. If the user decides to not use the unit price, the annual amounts can be set using an “edit annual amounts” button. The division cost reduction allocation is now dynamic, as it is in the potential cost reduction tab. This means that, if the division allocation has been entered already, and the buyer changes the annual amounts or the unit data, the division cost reduction allocation is re-allocated according to the division apportioned percentage. Once a project is approved, the data on the negotiated tab may still be modified, but an audit log will be created at the bottom of this tab, as discussed above. The annual baseline amount represents the dollar amount of the business issued on a request for proposal or a bid event. (See FIG. 24).

As seen in FIG. 25, the realized cost reduction tab allows the user to view concrete project dollars, based on actual monthly reports. This realized cost reduction section delineates between the year, month, division, net cost reduction, price cost reduction, non-price cost reduction, delta volume cost reduction, market/other cost reduction and spend amount based on negotiated price. A user can add a monthly report or delete a monthly report from the system 10, which creates monthly reports for the current month and upcoming months as long as the contract is active. For past months however, the buyer may manually create monthly reports by using the “add monthly report” button found in this tab. (See FIG. 25). The project comments tab (see FIG. 26) allows the user to add project review comments and instructions.

Returning to the main projects screen, under the unapproved projects by service unit, the user now moves into the logistics operations service unit to enter or evaluate a one-time cost reduction initiative. (See FIG. 27). As seen in FIG. 28, the same project information is required. (See FIGS. 29-37). As seen in FIG. 38, the user has added a file or document, including data fields 32 from the knowledge management data warehouse 30 under the data collection tab. The system 10 also includes an approval mechanism for audit purposes. A new project should be submitted for approval by the buyer before it can collect any cost reduction amounts. The required fields should be filled in before submitting a project for approval, and once the buyer has all the potential and negotiated data entered into the project database, the user can then submit the project to a manager for approval by selecting the “submit for approval” button. The buyer can select a manager from a directory of employees, and the system 10 will then send an e-mail to the selected manager. When the manager receives the e-mail, a link embedded in the e-mail will allow the manager to directly open the project and review it. If the manager does not agree with the data, or more information is needed, he or she can click on the “need more information” button at the top of a form, and the system 10 will display a pop-up box allowing the manager to enter his or her comments to the buyer. An e-mail will then be sent to the buyer including a link to the project. At this point, the buyer can correct the data or add more supporting documentation, as requested by the manager, and then submit the project approval again. Again, the manager will receive an e-mail linked to the project, and- he or she can approve the project. Of course, if the manager is again not satisfied with the corrections made by the buyer, he or she can send the project back to the buyer by clicking the “need more information” button again. All of this activity, between the buyer and his or her manager, is logged at the bottom of the form in the “project history” section. This approval mechanism can also be used in connection with both ongoing cost reduction projects, as well as one-time cost reduction projects.

For this one-time cost reduction initiative, under the cost reduction analysis tab, various different amounts are able to be added and/or edited. In this example, the fields include a one-time negotiated cost reduction item, the year, the cost avoidance amount and various other comments. Again, the various divisions can be apportioned the overall cost reduction either by percentage or one-time allocation. The division percentages can be edited or deleted, and in the present example, the Administration and Finance Division has been apportioned twenty percent of the cost reduction, while the Coatings and Colorants Division has been apportioned eighty percent of the cost reduction. (See FIG. 39).

As seen in FIG. 40, the one-time negotiated cost reduction item, year and cost avoidance amounts can be edited via a pop-up box that allows for user input via the input mechanism 36. Similarly, the division apportionment section provides a pop-up box for adding or modifying the division and the percent it should be apportioned of the overall cost reduction or cost avoidance. (See FIG. 41). As seen in FIG. 42, another pop-up box is provided for editing the division percentages, including the percent, one-time cost reduction or potential annual cost reduction or avoidance. Another pop-up box is used to delete the percentages. (See FIG. 43).

As seen in FIG. 44, again, project comments or instructions can be added under the appropriate project review comments tab. If the add comment box is selected, a pop-up box allows the user to input, via the input mechanism 36, comments into this section. (See FIG. 45). FIG. 46 shows a link system for allowing the present method, system and apparatus 10 to link to and communicate with another master system or control system. In addition, as can be seen in the toolbar above the screen, which is equally applicable to many of the other screens in the system, the user may exit, save, attach a file, print a document, notify a team leader or submit the project for approval.

FIG. 47 shows the projects sorted by title; FIG. 48 shows the unapproved projects sorted by priority; and FIG. 49 shows these unapproved projects sorted by priority and expanded as selections. FIG. 50 shows the unapproved projects sorted by the team leader/buyer; FIG. 51 shows the unapproved projects sorted by sourcing process; and FIG. 52 shows the unapproved projects sorted by project type.

FIG. 53 shows the approved projects sorted by service units and FIG. 54 shows the selection of the NAFTA desktop services project. As seen in the project team information tab, most of the fields for an approved project are similar to the fields as discussed hereinabove in connection with an unapproved project. However, as this is a services division, the service contact name and contact phone is also included. FIG. 55 shows the definitions of a bid project and a non-bid project. As seen in FIG. 56, under the data collection tab, the user has attached twelve files, including spreadsheets, presentations, word processing documents and compressed files.

FIGS. 57 and 58 demonstrate the project schedule and diary as discussed above, and FIG. 59 shows the potential cost reduction tab under cost reduction analysis. As seen at the bottom of FIG. 59, this project has history entries showing actions on the project. FIG. 60 demonstrates the negotiated cost reduction tab with the following modifiable entries: annual baseline amount, value of initial acceptable annual bid, result of value-added negotiations, annual negotiated cost reduction percentage and annual negotiated cost reduction amount. Similarly, the apportionment functionality is also provided. Still further, the negotiated cost reduction history has various entries, day and time stamped, showing actions on the project.

As seen in FIG. 61, for raw material purchases, a unit price can be used. FIG. 62 shows the realized cost reduction tab with the cost reduction analysis broken down on a monthly basis. As discussed above, the net cost reduction is broken down into various cost reduction categories for further analysis. The apportioned division percentages can be viewed in a pop-up box. (See FIG. 63). As seen in FIG. 64, the monthly reports can be added or deleted via a pop-up box.

FIGS. 65-75 illustrate a monthly division cost reduction report generated by the control mechanism 26 and displayed on the display mechanism 28. As seen in FIG. 65, this cost reduction report is for the technical and services unit, specifically information technology and, more specifically, the administration and finance division having a division ratio of fifteen percent. The procurement category is services and the negotiated cost reduction percentage is 90.4 percent. This report also illustrates the projected monthly price cost reduction, the monthly non-price cost reduction and the monthly total cost reduction from the various initiatives. Further, this report illustrates the monthly delta volume cost reduction, which is the spend amount based on the negotiated price minus the projected spend based on the cost reduction percentage. The report also illustrates the monthly market/other cost reduction and the monthly net cost reduction for that division. Also illustrated are the monthly cost avoidance and the comments/attachments and history for this project.

The monthly non-price cost reduction is used if in one month you can negotiate a one-time rebate. The projected spend calculations, the actual spend calculations and the delta volume cost reduction are all calculated and a pop-up box displays how these calculations are conducted. Importantly, the delta volume cost reduction demonstrates the difference between the actual cost reduction and the projected cost reduction.

The negotiated cost reduction percent, monthly non-price cost reduction, monthly delta volume spend value and market influence can all be edited on this screen. Further, a pop-up box is available for defining the various fields, as well as defining how some of the calculations are performed. (See FIG. 68). The monthly net cost reduction is the monthly total cost reduction from various initiatives plus the monthly delta volume cost reduction plus the monthly market/other cost reduction amount.

Various months can be selected and the report for this month viewed, as seen in FIG. 71. The various pop-up edit boxes for the editable fields are illustrated in FIGS. 72-75. As with the previous projects, the project allows for project comments. (See FIG. 76). FIG. 77 shows the approved projects sorted by sub-unit; FIG. 78 shows the approved projects sorted by status; FIG. 79 shows the approved projects sorted by team leader; FIG. 80 shows the approved projects sorted by project number; FIG. 81 shows the approved projects sorted by project title; FIG. 82 shows the approved projects sorted by contract start year; and FIG. 83 shows the approved projects sorted by contract end year.

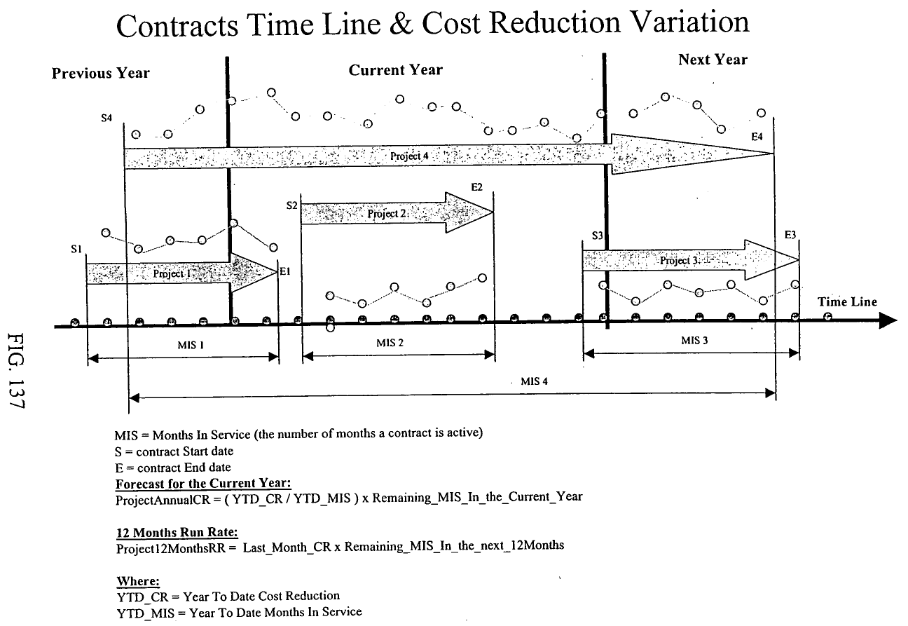

As seen in FIG. 84, if the user selects the all-year report button, the user may then view the reports for a current year. These reports include a year-to-date forecast cost reduction by service, a year-to-date forecast cost reduction by division, a year-to-date forecast cost reduction by buyer, a pipeline by service unit, a pipeline by service unit and division, a pipeline by division, unit and sub-unit and a 12-month run rate report. (See FIG. 84). A one-time cost reduction project may show up in the pipeline reports, as long as it is in a “draft” or “submitted for approval” state. Once the project has been approved, it will be removed from the pipeline reports and will show up in the realized cost reduction reports. This allows the user to capture future one-time cost reduction projects. FIG. 137 demonstrates a contract's timeline in cost reduction variation, for example projects. In this figure, MIS=Months In Service (the number of months the contract is active); S=contract Start date; and E=contract End date. In order to calculate the forecast for the current year, the following formula is used: Project Annual Cost Reduction=(YTD_CR/YTD_MIS)×Remaining_MIS_In_the_Current_by year. The 12-months run rate is calculated as follows: Project 12-Month Run Rate=Last_Month_CR×Remaining_MIS_In_the_next_{—}12-Months. In these formulas, YTD_CR is the year-to-date cost reduction, and YTD_MIS is the year-to-date months in service. As further seen in FIG. 84, under the year-to-date forecast cost reduction by service, the following fields are shown: service unit, service sub-unit, year-to-date actual cost reduction from procurement initiatives, annual forecast from procurement initiatives cost reduction, year-to-date annual net cost reduction, annual forecast based on year-to-date average net cost reduction, project number and project name.

FIG. 85 shows the year-to-date forecast cost reduction by division, and includes the division, service unit, service sub-unit, project number and name, year-to-date actual cost reduction from procurement initiatives, annual initiatives forecast based on year-to-date actual net cost reduction, annual forecast based on year-to-date average net cost reduction and month and division name. FIG. 86 demonstrates the year-to-date forecast cost reduction by buyer. FIGS. 87-89 show the various pipeline reports, together with their potential annual cost reduction amounts. FIG. 90 illustrates the 12-month run rate report, and includes the service unit, the service sub-unit, the 12-month initiative run rate based on last month's procurement initiatives cost reduction, 12-month net cost reduction run rate based on last month's actual net cost reduction, project number and project name.

FIGS. 91-109 illustrate the various multiple years reports available on the system. These multiple years reports include reports such as realized cost reduction by service unit, realized cost reduction by unit, sub-unit and division, realized cost reduction by unit and division, realized cost reduction by division and sub-unit, realized cost reduction by scope, ongoing/one-time cost reduction by service unit, ongoing/one-time cost reduction by division, cost avoidance by service unit and cost avoidance by division. These reports include various fields including year, service unit, sub-unit, project number and name, year-to-date cost reduction from procurement initiatives, year-to-date actual net cost reduction, year-to-date price cost reduction, year-to-date non-price cost reduction, year-to-date delta volume cost reduction, year-to-date market/other cost reduction, month, division and other appropriate data fields. Again, it is these reports that demonstrate the comparative results after appropriately corresponding various reference data fields 16, negotiated procurement transaction data fields 20, and actual procurement transaction data fields 24.

FIGS. 110-112 illustrate the available electronic-sourcing reports, including electronic sourcing completed, electronic sourcing pipeline by service unit and electronic sourcing pipeline by date. These reports include various fields, such as service unit, service sub-unit, month, bid event day, project, annual baseline amount, value-added negotiated amount, annual percent cost reduction, annual cost reduction amount, sourcing process and other various fields.

FIGS. 113-136 illustrate the various functions available to an administrator of the system. For example, the administrator can: view run rates by service unit and sub-unit; create, modify and delete service group profiles and service sub-group profiles; create, modify and delete division profiles; view documents pertaining to reports for all years cost reductions by sub-unit; export projects to a different master database, such as a main corporate database through a communications link; view incomplete employee and project data, as well as approval data; view one-time cost reduction bad division allocation or detected report errors for various reports; change application settings, search keys, fields, logs of various events, titles and creation dates; detect orphan documents, whether assigned to a project or not; view all documents in a certain hierarchy and cross reference these documents to other databases through communication links; view replication conflicts; update division allocation information; and view bad or empty monthly cost reduction initiatives.

### EXAMPLE 2

Monthly reports should be updated periodically, such as on a monthly basis, to avoid attributing the cost savings to the Delta Volume (ΔV) category. If you update one monthly report for multiple months, the Delta Volume (ΔV) will receive cost reduction credit, as opposed to the user or division. An example of this process follows:

For a project with an Annual Projected Volume (AnnualPV) of 12,000,000 lbs, and a baseline price per unit (BPU) of 1.3 $/lb, with a Negotiated Cost Reduction per Unit (NCRU) of 0.1 $/lb:

Annual Base Line Amount=BPU×AnnualPV=1.3 $/lb×12,000,000 lb=$15,600,000.00.

Negotiated Price per Unit (NPU)=BPU−NCRU=(1.3−0.1) $/lb=1.2 $/lb (the Negotiated Unit Price)

Annual Negotiated Spend=NPU×AnnualPV=1.2 $/lb×12,000,000 lb=$14,400,000.00.

The system 10 will then calculate the Negotiated Cost Reduction Percentage (NCR %) as NCR %=NCRU/BPU %=$0.1/$1.3%=7.6923 %.

In the Monthly Reports section, the system 10 will calculate the projected monthly spend (PS) as follows: PS=Division %×(Annual Negotiated Spend)/12. If the project allocated 100% to a single division: PS=100%×$14,400,000.00/12=$1,2000,000.00.

Overall, the present method, system and apparatus 10 provide for enhanced procurement transaction analysis and provides increased cost reduction initiative benefits and functionality. As a system, the present invention can be deployed on various platforms and operating systems, and may use base-level system functionality of any database management program. Further, the control mechanism 26 should be enabled with appropriate software to control, manage, receive, calculate and perform all other basic steps of the presently claimed method and system. The present method, system and apparatus 10 is not merely a contract or project management system, instead allowing a user to determine net cost reduction based upon a baseline reference data field 16, a negotiated procurement transaction data field 18 and an actual procurement transaction data field 24. Therefore, the user is not simply ensuring that the terms and conditions of a project are met, but is instead analyzing the negotiation process through actual performance based upon variable reference data. This allows the user to understand where increased cost reduction or a cost reduction initiative can be initiated.

The present method, system and apparatus 10 represents a fundamental shift in strategic procurement and cost reduction analysis, and is considered an integration of the contract process in an automated environment. Further, the present invention is equally applicable to multi-party contracts, internal transfers, multi-level organizations, service and good transfers, various procurement strategies and a variety of other procurement transaction processes. This, in turn, allows a user of the present invention to determine cost reduction in connection with various transactions not only in view of required or actual performance, but in view of other reference data sets, such as market identifiers, variable contract terms, other transactions, similar or identical party reference data, etc. In using such reference data sets, sub sets and fields, the present invention allows for accurate analysis and knowledge building in the area of cost reduction analysis, procurement transaction analysis, corporate economic analysis and fundamental purchasing decisions.

This invention has been described with reference to the preferred embodiments. Obvious modifications and alterations will occur to others upon reading and understanding the preceding detailed description. It is intended that the invention be construed as including all such modifications and alterations.

We claim:

1. A method for determining cost reduction in a procurement transaction, comprising the steps of:
(a) providing a baseline reference data set including at least one reference data field;
(b) providing a negotiated procurement transaction data set including at least one negotiated procurement transaction data field;
(c) providing an actual procurement transaction data set including at least one actual procurement transaction data field;
(d) determining a cost reduction value for the procurement transaction based upon at least one baseline reference data field, at least one negotiated procurement transaction data field and at least one actual procurement transaction data field; and
(e) providing the results of the determination performed in step (d).

2. The method of claim 1, wherein the at least one reference data field is at least one of an average market price, an average online bid price, an old contract price, a supplier price, a previously quoted price, an advertised price, a price figure, a volume, a specified volume and a reference volume.

3. The method of claim 1, wherein the at least one negotiated procurement transaction data field is at least one of an initial quote price, an initial negotiated price and a variable negotiated price.

4. The method of claim 3, wherein the variable negotiated price is variable based upon one of a negotiated formula, a predetermined formula, a condition and an allocation.

5. The method of claim 3, wherein the variable negotiated price is a term of a negotiated procurement transaction.

6. The method of claim 3, wherein the variable negotiated price is variable based upon a market condition, a rebate, a bonus, timing data, shipping data, material cost data, service cost data, inflation and projection data.

7. The method of claim 1, wherein the at least one actual procurement transaction data field is an actual price, a volume, a specified volume and an actual volume.

8. The method of claim 1, wherein at least one of the at least one reference data field, the at least one negotiated procurement transaction data field and the actual procurement transaction data field is a procurement transaction data field.

9. The method of claim 8, wherein the procurement transaction data field is at least one of risk transfer data, liability data, inspection data, performance data, response time data, fill rate data, quality data, warranty data, shipping data, supplier qualification data, minority supplier data, policy data, regulatory data, compliance data, payment terms, a procurement transaction price value, a procurement transaction quantity value, a procurement transaction time period, first party data, second party data, buyer data, seller data, a procurement transaction identifier, a procurement transaction volume value, a market identifier, past first party performance data, past second party performance data, past buyer performance data, past seller performance data, past second party pricing, past seller pricing, past negotiated procurement transaction terms, alternative procurement transaction terms, alternative procurement transaction second party performance data, alternative procurement transaction seller performance data, alternative procurement transaction second party pricing, alternative procurement transaction seller pricing, past negotiated procurement transaction terms, current comparable procurement transaction terms data, current comparable procurement transaction second party performance data, current comparable procurement transaction seller performance data, current comparable procurement transaction second party pricing, current comparable procurement transaction seller pricing, procurement strategy data, negotiator data, market estimate data, negotiated procurement transaction term data, reference procurement transaction term data and actual procurement transaction performance data.

10. The method of claim 1, wherein the cost reduction value is a Net Cost Reduction (NCR) value determined by the following relationship:
NCR=Initiative Cost Reduction (ICR)+Market Cost Reduction (MCR)+Delta Volume Cost Reduction (ΔVCR).

11. The method of claim 10, wherein the Initiative Cost Reduction (ICR) value is determined by the following relationship:
ICR=Negotiated Volume (NV)×Negotiated Cost Reduction per Unit (NCRU).

12. The method of claim 11, wherein the Negotiated Cost Reduction per Unit (NCRU) value is determined by the following relationship:
NCRU=Baseline Price per Unit (BPU)−Negotiated Price per Unit (NPU).

13. The method of claim 10, wherein the Market Cost Reduction (MCR) value is determined by the following relationship:
MCR=(Negotiated Price per Unit (NPU)−Actual Price per Unit (APU))×Actual Volume (ΔV).

14. The method of claim 10, wherein the Delta Volume Cost Reduction (ΔVCR) value is determined by the following relationship:
ΔVCR=Negotiated Cost Reduction per Unit (NCRU)×Delta Volume (ΔV).

15. The method of claim 14, wherein the Delta Volume (ΔV) value is determined by the following relationship:
ΔV=Negotiated Volume (NV)−Actual Volume (ΔV).

16. The method of claim 14, wherein the in the Net Cost Reduction per Unit (NCRU) value is determined by the following relationship:
NCRU=Baseline Price per Unit (BPU)−Negotiated Price per Unit (NPU).

17. The method of claim 1, wherein the negotiated procurement transaction data set is derived from at least one negotiated procurement transaction between a first party and a second party.

18. The method of claim 17, wherein the first party is a buyer and the second party is one of a seller and a supplier.

19. The method of claim 17, wherein the at least one negotiated procurement transaction is for one of a product and a service.

20. The method of claim 17, wherein the at least one negotiated procurement transaction data field is a term of the at least one negotiated procurement transaction.

21. The method of claim 17, wherein the actual procurement transaction data set is derived from at least one of a first party's and a second party's actual performance in connection with at least one term of the negotiated procurement transaction.

22. The method of claim 1, further comprising the step of negotiating a procurement transaction between a first party and a second party, wherein the negotiated procurement transaction data set is derived from data associated with negotiated procurement transaction.

23. The method of claim 1, further comprising the step of providing a knowledge management data warehouse.

24. The method of claim 23, wherein the knowledge management data warehouse is a database containing a plurality of discrete data fields and is in the form of a computer-readable database.

25. The method of claim 23, wherein the knowledge management data warehouse is a compilation of a plurality of parsable and computer-readable documents, each of the plurality of documents having at least one discrete data field associated therewith.

26. The method of claim 25, wherein the plurality of documents is resident on various discrete computing systems in a networked relationship.

27. The method of claim 26, wherein the knowledge management data warehouse is one of viewable, parsable, searchable, readable, modifiable and recordable over a computer network.

28. The method of claim 23, wherein the knowledge management data warehouse is resident on a communications network.

27. The method of claim 23, wherein the knowledge management data warehouse includes data corresponding to at least one of the at least one reference data field, the at least one negotiated procurement transaction data field and the at least one actual procurement transaction data field.

28. The method of claim 23, further comprising the step of defining a knowledge management data warehouse data subset having data therein.

29. The method of claim 28, wherein at least one of the user reference data set, the negotiated procurement transaction data set and the actual procurement transaction data subset is selected from the data in the knowledge management data warehouse data subset.

30. The method of claim 28, wherein the knowledge management data warehouse subset is updated on one of a real-time and periodic basis.

31. The method of claim 1, further comprising the step of developing a procurement strategy for use in connection with negotiating the procurement transaction.

32. The method of claim 31, wherein the procurement strategy is at least one of cost reduction, negotiation strategy, strategic process, online auction, personnel, sealed bid, reverse auction, multi-phase iterative process and process improvement.

33. The method of claim 1, further comprising the step of defining a procurement analysis project.

34. The method of claim 33, wherein the procurement analysis project is directed to at least one of a specified commodity area, service area, cost reduction initiative, second party, supplier, seller and capital project.

35. The method of claim 33, wherein the procurement analysis project is directed to at least one of an operating cost reduction analysis, a capital cost reduction analysis and an asset recovery analysis.

36. The method of claim 1, wherein the results provided in step (e) are in the form of a report.

37. The method of claim 36, wherein the report is in the form of a chart, a graph, text, visual display and graphic depiction.

38. The method of claim 1, wherein prior to step (a), the method further comprises the step of providing a project management data set including at least one project management data field.

39. The method of claim 38, wherein the project management data field is one of request for proposal data, bid data, cost breakdown and projection data, specification and requirement data, event and response data, evaluation data, related agreements and assumption data, strategic development data, supplier qualification data, other data that is created prior to a negotiated procurement transaction and data referring to what the parties expect to negotiate.

40. The method of claim 1, further comprising the step of forecasting at least one of an Initiative Cost Reduction (ICR) value, a Market Cost Reduction (MCR) value and a Delta Volume Cost Reduction (ΔVCR) value for a subsequent transaction based at least partially upon the results of the determination performed in step (e).

41. The method of claim 40, further comprising the step of forecasting a Net Cost Reduction (NCR) value for a subsequent transaction based upon the forecast Initiative Cost Reduction (ICR) value, Market Cost Reduction (MCR) value and Delta Volume Cost Reduction (ΔVCR) value.

42. The method of claim 1, further comprising the step of forecasting a cost reduction value for a subsequent transaction based upon the results of the determination in step (e).

43. An apparatus capable of performing the method of claim 1.

44. An apparatus for determining cost reduction in a procurement transaction, comprising:
means for providing a baseline reference data set including at least one reference data field;
means for providing a negotiated procurement transaction data set including at least one negotiated procurement transaction data field;
means for providing an actual procurement transaction data set including at least one actual procurement transaction data field;
means for determining a cost reduction value for the procurement transaction based upon at least one baseline reference data field, at least one negotiated procurement transaction data field and at least one actual procurement transaction data field; and
means for providing the results of the determination.

45. An apparatus for determining cost reduction in a procurement transaction, comprising:
at least one storage mechanism containing:
(i) a baseline reference data set including at least one reference data field;
(ii) a negotiated procurement transaction data set including at least one negotiated procurement transaction data field; and
(iii) an actual procurement transaction data set including at least one actual procurement transaction data field;
at least one control mechanism in communication with the at least one storage mechanism and configured to determine a cost reduction value for the procurement transaction based upon at least one baseline reference data field, at least one negotiated procurement transaction data field and at least one actual procurement transaction data field; and
a display mechanism in communication with the at least one control mechanism and configured to visually display the results of the determination.

46. The apparatus of claim 45, further comprising a knowledge management data warehouse.

47. The apparatus of claim 46, wherein the knowledge management data warehouse is a database containing a plurality of discrete data fields and is in the form of a computer-readable database.

48. The apparatus of claim 46, wherein the knowledge management data warehouse is a compilation of a plurality of parsable and computer-readable documents, each of the plurality of documents having at least one discrete data field associated therewith.

49. The apparatus of claim 48, wherein the plurality of documents are resident on various discrete computing systems that are in a networked relationship.

50. The apparatus of claim 46, wherein the knowledge management data warehouse is one of viewable, parsable, searchable, readable, modifiable and recordable over a computer network.

51. The apparatus of claim 46, wherein the knowledge management data warehouse is resident on a communications network.

52. The apparatus of claim 46, further comprising a knowledge management data warehouse data subset having data therein.

53. The apparatus of claim 52, wherein at least one of the user reference data set, the negotiated procurement transaction data set and the actual procurement transaction data subset is selected from the data in the knowledge management data warehouse data subset.

54. The apparatus of claim 45, further comprising an input mechanism in communication with the at least one control mechanism and configured to input at least one of the negotiated procurement transaction data field, the reference data field and the actual procurement transaction data field.

55. The apparatus of claim 45, wherein the results are communicated from the control mechanism to the display mechanism, and the display mechanism displays the results in the form of a report.

56. The apparatus of claim 45, wherein the at least one storage mechanism contains a project management data set including at least one project management data field.

57. A method for determining cost reduction in a procurement transaction, comprising the steps of:
providing a project management data set including at least one project management data field;
providing a baseline reference data set including at least one reference data field;
providing a negotiated procurement transaction data set including at least one negotiated procurement transaction data field;
providing an actual procurement transaction data set including at least one actual procurement transaction data field;
determining a cost reduction value for the procurement transaction based upon at least one baseline reference data field, at least one negotiated procurement transaction data field and at least one actual procurement transaction data field; and
providing the results of the determination.

58. A method for determining cost reduction in a procurement transaction, comprising the steps of:
providing a baseline reference data set including at least one reference data field;
providing a negotiated procurement transaction data set including at least one negotiated procurement transaction data field;
providing an actual procurement transaction data set including at least one actual procurement transaction data field;
determining a cost reduction value for the procurement transaction based upon at least one baseline reference data field, at least one negotiated procurement transaction data field and at least one actual procurement transaction data field;
providing the results of the determination; and
forecasting a cost reduction value for a subsequent transaction based upon the results of the determination.

59. A method for determining cost reduction in a procurement transaction, comprising the steps of:
providing a project management data set including at least one project management data field;
providing a baseline reference data set including at least one reference data field;
providing a negotiated procurement transaction data set including at least one negotiated procurement transaction data field;
providing an actual procurement transaction data set including at least one actual procurement transaction data field;
determining a cost reduction value for the procurement transaction based upon at least one baseline reference data field, at least one negotiated procurement transaction data field and at least one actual procurement transaction data field;
providing the results of the determination; and
forecasting a cost reduction value for a subsequent transaction based upon the results of the determination.
